(19) United States
(12) Patent Application Publication
(10) Pub. No.: US 2026/0153860 A1
(43) Pub. Date: Jun. 4, 2026

(54) SYSTEM AND METHOD FOR CLASSIFYING PHARMACEUTICAL PRODUCTS BASED ON PREDEFINED QUALITY PARAMETERS USING ARTIFICIAL INTELLIGENCEPrivate view

(71) Applicant: SignAiture LLC, Palo Alto, CA (US)

(72) Inventors: Annas Farra, REDWOOD CITY, CA (US); Zifu Wang, Palo Alto, CA (US)

(73) Assignee: SignAiture LLC, Palo Alto, CA (US)

(21) Appl. No.: 19/268,107

(22) Filed: Jul. 14, 2025

Related U.S. Application Data
(60) Provisional application No. 63/726,384, filed on Nov. 29, 2024.

(51) Int. Cl. G05B 19/418

(52) U.S. Cl. CPC G05B 19/41875; G05B 2219/37431

(57) ABSTRACT

The present disclosure relates to systems and methods for real-time analysis and classification of tangible products based on predefined quality parameters using artificial intelligence (AI). It incorporates one or more sensors to monitor various product properties such as molecular composition, moisture content, and structural integrity. Sensor data is processed by a server, which identifies relevant characteristics like spectral peaks and dielectric constants, then generates a comprehensive aggregate signature using feature-level fusion techniques. An Al model, trained on tangible datasets, analyzes the fused data to detect deviations in quality, such as foreign particles, improper moisture, or structural defects. The system provides real-time feedback for corrective action, allowing adjustments in production parameters or sorting of defective products. In some embodiments, a handheld version of the system enables manufacturers to perform in process checks and immediately address quality issues during production.

### REFERENCE TO RELATED APPLICATIONS

This application claims priority from U.S. provisional application Ser. No. 63/726,384, filed Nov. 29, 2024, which is incorporated by reference. Further, this application claims priority from U.S. provisional application Ser. No. 63/726,671, filed Dec. 2, 2024, which is also incorporated by reference.

### BACKGROUND OF THE INVENTION

The present disclosure generally relates to inline analysis and classification of tangible products using artificial intelligence and predefined quality parameters. More particularly, the present disclosure focuses on systems and methods that employ multiple sensors, such as radio frequency antennas, temperature sensors, near-infrared (NIR) sensors, Raman spectroscopy sensors, and image sensors, to monitor critical quality attributes (CQAs) in real time. Through feature-level fusion of data gleaned from these sensors, products traversing a production path may be evaluated on parameters including dielectric properties, moisture content, and the presence of contaminants. This results in instant feedback during the production cycle, thereby enabling automated corrective actions or product rejection where necessary.

### Description of the Related Art

Existing tangible quality control approaches often rely on offline or end-of-line testing methods, which only detect non-compliant products after a significant delay and require manual intervention. Consequently, deviations from desired specifications—such as moisture content exceeding acceptable thresholds, inadequate mixing ratios, or foreign particle contamination—may persist unnoticed for multiple production cycles. These conventional methods are typically incapable of adapting the production process in real time, resulting in higher waste, longer downtime, and increased operational costs.

### SUMMARY OF THE INVENTION

In some aspects, the techniques described herein relate to a system for inline analysis and classification of tangible products using artificial intelligence and predefined quality parameters, the system comprising: a plurality of sensors arranged along a production path, each of the plurality of sensors configured to obtain real-time data indicative of at least an electromagnetic property, molecular composition, moisture content, presence of foreign particles, or structural integrity of the tangible products; a server communicatively coupled to the plurality of sensors, the server having a memory storing computer-executable instructions; and one or more processors configured to execute the computer-executable instructions to cause the system to: receive sensor data from the plurality of sensors in response to a tangible product traversing the production path; perform feature extraction by identifying at least two or more of: a dielectric property, an electromagnetic property, a temperature, a NIR absorption spectrum or Raman effect, a spectral peak or molecular signature within the sensor data; generate an aggregate signature via feature-level fusion of the extracted features; and initiate, upon detecting a non-compliant product, an inline corrective action or a rejection signal in substantially real time to prevent the non-compliant product from proceeding further in production; wherein the inline classification evaluates at least one or more of physical state, volume, mix-ratio, uniformity, contaminants, dielectric constants, or moisture content, thereby providing instant feedback for in-process quality control during a production cycle.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a computing hardware architecture diagram, according to various examples.

FIG. 2 illustrates a system architecture of a user device, according to various examples.

FIG. 3 illustrates a system for receiving, processing, classifying and recording pharmaceutical product data in real-time for inline quality control.

FIG. 4 illustrates a structured data processing system configured to handle sensor data for analyzing and classifying pharmaceutical products, according to various examples.

FIG. 5 illustrates a system for analyzing and classifying pharmaceutical products based on predefined quality parameters using artificial intelligence according to various embodiments.

FIG. 6 illustrates an example of a flow diagram showing how real-time sensor data is acquired, normalized, and then evaluated against stored calibration parameters.

FIG. 7 illustrates an architecture for network-based or cloud-assisted classification, according to various examples.

FIG. 8 illustrates an example of an inline pharmaceutical quality control system, according to various examples.

FIG. 9 illustrates a distributed classification framework for real-time product inspection and classification, according to various examples.

FIGS. 10A-B illustrate a method for analyzing and classifying pharmaceutical products based on predefined quality parameters using artificial intelligence according to various embodiments.

FIG. 11 illustrates a portable device for analyzing and classifying pharmaceutical products based on predefined quality parameters using artificial intelligence, as further supported by the system architecture shown in FIG. 5 according to various embodiments.

FIG. 12 illustrates a general computer architecture that may be appropriately configured to implement components disclosed in accordance with various embodiments.

FIG. 13 illustrates a layered orchestration and presentation architecture for coordinating multi-sensor data, AI-based analysis, and user interfaces across one or more processing layers, according to various examples.

FIG. 14 illustrates an example of a model of organic or small-molecule material inspection, according to one or more examples.

FIG. 15 illustrates a schematic representation of a pharmaceutical classification system detecting variations in pharmaceutical product quality.

FIGS. 16A-C illustrate examples of electromagnetic signatures shifting from a baseline reference in response to changes in product dimensions, mix ratios, and moisture levels.

FIG. 17 illustrates an inline analysis module that merges and separates multiple sensor signals for real-time product inspection and classification, according to various examples.

### DETAILED DESCRIPTION

Systems and techniques described herein may be used to overcome the limitations of traditional methods for monitoring pharmaceutical products, which often rely on time-consuming, end-of-line testing or purely manual inspections. Such approaches cannot provide immediate, actionable feedback to production line operators, leading to increased waste and delayed defect detection.

To address these issues, the present disclosure provides a system for inline analysis and classification of pharmaceutical products that integrates radio frequency, temperature, optical, or other sensor data to detect deviations in product quality. Through advanced algorithms and a server capable of rapid processing, the system may maintain continuous oversight of production and triggers an immediate response upon identifying out-of-spec products. This may ensure that fewer defects proceed through the line, helping preserve product integrity and reducing waste.

An example technique may include arranging a plurality of sensors—such as a radio frequency antenna, a temperature sensor, and an image sensor—along a production path to capture real-time data reflecting electromagnetic properties, molecular composition, moisture content, foreign particles, or structural integrity. A server, equipped with a memory for storing computer-executable instructions, receives this sensor data as each pharmaceutical product traverses the path. It then performs feature extraction by identifying any dielectric property, electromagnetic property, temperature reading, NIR absorption feature or Raman effect, spectral peak, or molecular signature within the data. The extracted features may be combined into an aggregate signature through feature-level fusion, and if that fused signature indicates a non-compliant product, the system may immediately initiate an inline corrective action or a rejection signal, preventing the flawed item from proceeding further.

Consider a production scenario in which tablets move rapidly on a conveyor, passing sequentially under several different sensors. As each tablet travels along the conveyor, a radio frequency antenna may measure its dielectric properties to detect potential irregularities in moisture content or composition, while an image sensor may capture visual data to identify possible surface defects or anomalies in shape and size. A server may receive this continuous stream of sensor outputs, seamlessly merging key features—such as signal strength, temperature deviations, and pixel-based metrics—into a single aggregate signature. Whenever the system's algorithms determine that a tablet fails to meet any predefined parameter (e.g., excessive moisture or noticeable surface cracks), the server may immediately trigger an ejector mechanism. This mechanism may mechanically divert the defective item away from the normal production flow, ensuring that only tablets which meet the stringent quality requirements continue along the line. By detecting and isolating these issues instantly, the process may maintain high throughput while minimizing both waste and the risk of defective products reaching downstream stages in production or distribution.

The following description provides examples of systems and methods for inline analysis and classification of pharmaceutical products using multi-sensor data and algorithms to enable real-time quality control. The disclosed embodiments are illustrative and not limiting of the scope, applicability, or examples set forth in the claims. Modifications may be made in the function and arrangement of elements without departing from the scope of the disclosure. Various examples may omit, substitute, or add procedures or components as appropriate. For example, the methods described may be performed in an order different from that presented, and steps may be added, omitted, or combined. Features described with respect to some examples may be combined in other examples. An apparatus may be implemented or a method practiced using any number of aspects set forth herein. The scope of the disclosure is intended to cover such apparatuses or methods practiced using other structures, functionalities, or combinations thereof, in addition to or other than those set forth herein. It should be understood that any aspect of the disclosure may be embodied by one or more elements of a claim. The term “exemplary” is used herein to mean “serving as an example, example, or illustration,” and does not indicate preference or superiority.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number include the plural or singular number respectively. The words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but may mean a singular element.

The illustrative embodiments are described with respect to certain types of machines. The illustrative embodiments are described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts may be selected within the scope of the illustrative embodiments.

The illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. The illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. A particular illustrative embodiment may have some, all, or none of the advantages listed above.

The illustrative embodiments are described with respect to certain types of machines. The illustrative embodiments are described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts may be selected within the scope of the illustrative embodiments.

The illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. The illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. A particular illustrative embodiment may have some, all, or none of the advantages listed above.

Various processes described herein may be implemented by appropriately programmed general purpose computers, special purpose computers, and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more scripts, or in other forms. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hard-wired circuitry or custom hardware may be used in place of, or in combination with, some or all of the software instructions that may implement the processes. Algorithms other than those described may be used.

Programs and data may be stored in various media appropriate to the purpose, or a combination of heterogeneous media that may be read and/or written by a computer, a processor or a like device. The media may include non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on an Intel® or AMD® processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices.

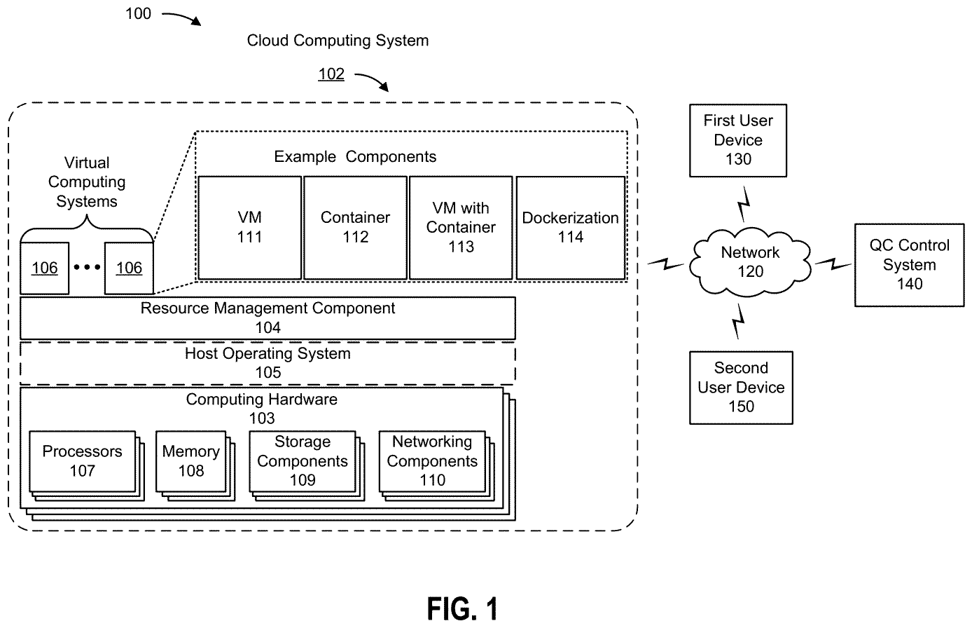

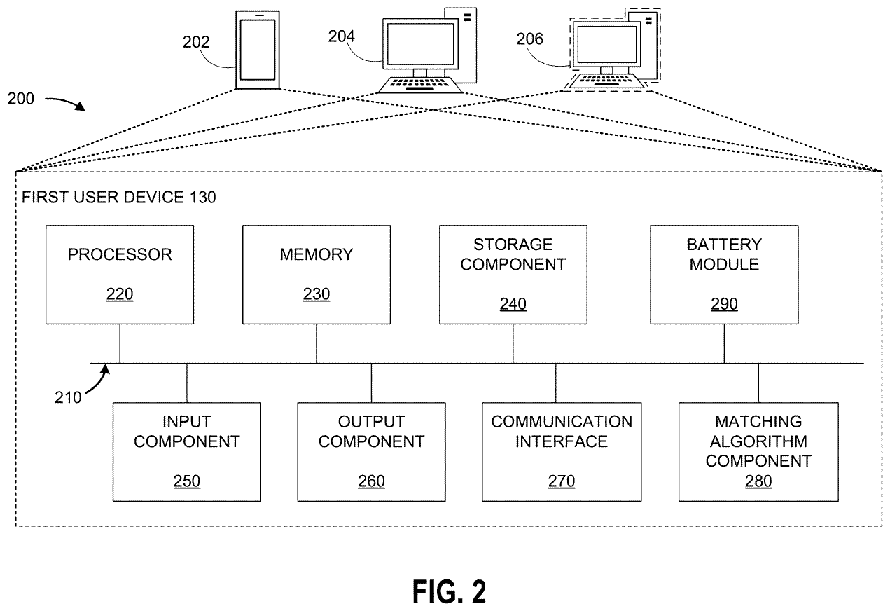

With reference to the figures and in particular, with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 is a diagram of an example environment 100 in which systems and/or methods described herein may be implemented. As shown in FIG. 1, the environment 100 may execute within a cloud computing system 102. The cloud computing system 102 may include one or more elements 103-113, as described in more detail below. As further shown in FIG. 1, the environment 100 may include a network 120, a network devices 130, and/or a QC Control System 140. Devices and/or elements of the environment 100 may interconnect via wired connections and/or wireless connections. It is important to note that network devices 130, as described herein, is a user device which may be used by the first user and/or the second user. In the later case, when it is used by the second user, user device 130 may be called a second user device 130. For purposes of convenience in reading this description, the embodiment of the user device 130 as a first user device will be described, but it should be understood as interchangeably termed “second user device” at least for the purposes of the disclosures of FIG. 1 and FIG. 2.

The cloud computing system 102 includes computing hardware 103, a resource management component 104, a host operating system (OS) 105, and/or one or more virtual computing systems 106. The resource management component 104 may perform virtualization (e.g., abstraction) of the computing hardware 103 to create the one or more virtual computing systems 106. Using virtualization, the resource management component 104 enables a single computing device (e.g., a computer, a server, and/or the like) to operate like multiple computing devices, such as by creating multiple isolated virtual computing systems 106 from the computing hardware 103 of the single computing device. In this way, the computing hardware 103 may operate more efficiently, with lower power consumption, higher reliability, higher availability, higher utilization, greater flexibility, and lower cost than using separate computing devices.

The computing hardware 103 includes hardware and corresponding resources from one or more computing devices. For example, the computing hardware 103 may include hardware from a single computing device (e.g., a single server) or from multiple computing devices (e.g., multiple servers), such as multiple computing devices in one or more data centers. As shown, the computing hardware 103 may include one or more processors 107, one or more memories 108, one or more storage components 109, and/or one or more networking components 110. Examples of a processor, a memory, a storage component, and a networking component (e.g., a communication component) are described elsewhere herein.

The resource management component 104 includes a virtualization application (e.g., executing on hardware, such as the computing hardware 103) capable of virtualizing the computing hardware 103 to start, stop, and/or manage the one or more virtual computing systems 106. For example, the resource management component 104 may include a hypervisor (e.g., a bare-metal or Type 1 hypervisor, a hosted or Type 2 hypervisor, and/or the like) or a virtual machine monitor, such as when the virtual computing systems 106 are virtual machines 111. Additionally, or alternatively, the resource management component 104 may include a container manager, such as when the virtual computing systems 106 are containers 112. In some implementations, the resource management component 104 executes within and/or in coordination with a host operating system 105.

A virtual computing system 106 includes a virtual environment that enables cloud-based execution of operations and/or processes described herein using computing hardware 103. As shown, the virtual computing system 106 may include a virtual machine 111, a container 112, a hybrid environment 113 that includes a virtual machine and a container, an environment which includes Docker-like filesystems or other possible Dockerization 114 with a VM or other computing hardware allocation, and/or the like. A virtual computing system 106 may execute one or more applications using a file system that includes binary files, software libraries, and/or other resources required to execute applications on a guest operating system (e.g., within the virtual computing system 106) or the host operating system 105.

The network 120 includes one or more wired and/or wireless networks. For example, the network 120 may include a cellular network, a public land mobile network (PLMN), a local area network (LAN), a wide area network (WAN), a satellite network, a private network, the Internet, and/or the like, and/or a combination of these or other types of networks. The network 120 enables communication among the devices of the environment 100.

Network devices 130 may be possessed by a first user and includes one or more devices capable of receiving, generating, storing, processing, and/or providing information, as described elsewhere herein. Network devices 130 may include a communication device and/or a computing device. For example, network devices 130 may include a wireless communication device, a mobile phone, a user equipment (UE), a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The QC Control System 140 may support real-time data collection, analysis, and communication among various sensors arranged along a pharmaceutical production path. For example, the QC Control System 140 may include one or more hardware and software modules (e.g., servers, computing nodes, data processors) capable of receiving input from radio frequency antennas, temperature sensors, image sensors, near-infrared (NIR) sensors, or Raman sensors. The QC Control System 140 may coordinate and process the incoming sensor data through feature extraction and aggregate signature generation, enabling immediate classification of products and, if necessary, triggering automated corrective actions or rejection signals. The network devices 130 may transfer traffic between the QC Control System 140 (e.g., using a cellular RAT), one or more QC Control Systems (e.g., using a wireless interface or a backhaul interface, such as a wired backhaul interface), and/or a core network. The network devices 130 may provide one or more cells that cover geographic areas.

The user device 150 may be possessed by a second user and includes one or more devices capable of receiving, generating, storing, processing, and/or providing information, as described elsewhere herein. User device 150 may include a communication device and/or a computing device, and may be connected to, or embedded anywhere within, a vehicle or other equipment known to be utilized in the transportation industry. For example, user device 150 may include a wireless communication device, a mobile phone, a vehicle computer system, a mobile printer, a calculator, a user equipment, a laptop computer, a tablet computer, a desktop computer, a set-top box, a wearable communication device (e.g., a smart wristwatch, a pair of smart eyeglasses, a head mounted display, or a virtual reality headset), or a similar type of device.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

FIG. 2 is a diagram of components of network devices 130, according to an example of the present disclosure. Network devices 130 may include a bus 210, a processor 220, a memory 230, a storage component 240, an input component 250, an output component 260, a communication interface 270, a battery module 290 and a matching algorithm component 280.

Bus 210 includes a component that permits communication among the components of Network devices 130. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 220 includes one or more processors capable of being programmed to perform a function. Memory 230 may include one or more memories such as a random access memory (RAM), a read only memory (ROM), and/or another type of dynamic or static storage device (e.g., a flash memory, a magnetic memory, and/or an optical memory) that stores information and/or instructions for use by processor 220. In some embodiments, a non-transitory computer-readable medium stores instructions that, when executed by a processor, cause the processor to perform various functions.

Storage component 240 stores information and/or software related to the operation and use of Network devices 130. For example, storage component 240 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits network devices 130 to receive information, such as via user input (e.g., a touch screen display, a keyboard, a keypad, a mouse, a button, a switch, and/or a microphone). Additionally, or alternatively, input component 250 may include a sensor for sensing information (e.g., a GPS component, an accelerometer, a gyroscope, and/or an actuator). Output component 260 includes a component that may provide output information from network devices 130 (e.g., a display, a speaker, a user interface, and/or one or more light-emitting diodes (LEDs)). Output component 260 may include a display providing a GUI, such as an interface. Input component 250 and output component 260 may be combined into a single component, such as a touch responsive display, known as a touchscreen.

Communication interface 270 includes a transceiver-like component (e.g., a transceiver and/or a separate receiver and transmitter) that enables network devices 130 to communicate with other devices, such as via a wired connection, a wireless connection, or a combination of wired and wireless connections. Communication interface 270 may permit network devices 130 to receive information from another device and/or provide information to another device. Communication interface 270 may include one or more RFFEs (radio frequency front ends) with antennae circuitry and RF (radio frequency) filters which may be variable power and/or purpose adapted for various communication frequencies, standards, links, and distances. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 210 to supply power to processor 220, memory 230, and internal components of network devices 130. Battery module 290 may supply power during field measurements by network devices 130.

The matching algorithm component 280 may assist in forming simulations without a leader by automatically assembling participants into randomized or balanced groups. It may be used to allocate artificial players (bots) as benchmarks, ensuring a competitive and educational environment. By leveraging real-time market data, the matching algorithm may dynamically update simulation rankings, track aggregated distribution weighting performance, and validate rule compliance, making the simulation experience seamless and accurate for all users.

Network devices 130 may perform one or more processes described herein. Network devices 130 may perform these processes by processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, network devices 130 may include additional components, fewer components, different components, or differently arranged components than those shown in FIG. 2, 200. Additionally, or alternatively, a set of components (e.g., one or more components) of network devices 130 may perform one or more functions described as being performed by another set of components of network devices 130.

FIG. 2 is a diagram of components of network devices 130, according to an example of the present disclosure. Network devices 130 may include a bus 210, a processor 220, a memory 230, a storage component 240, an input component 250, an output component 260, a communication interface 270, and battery module 290.

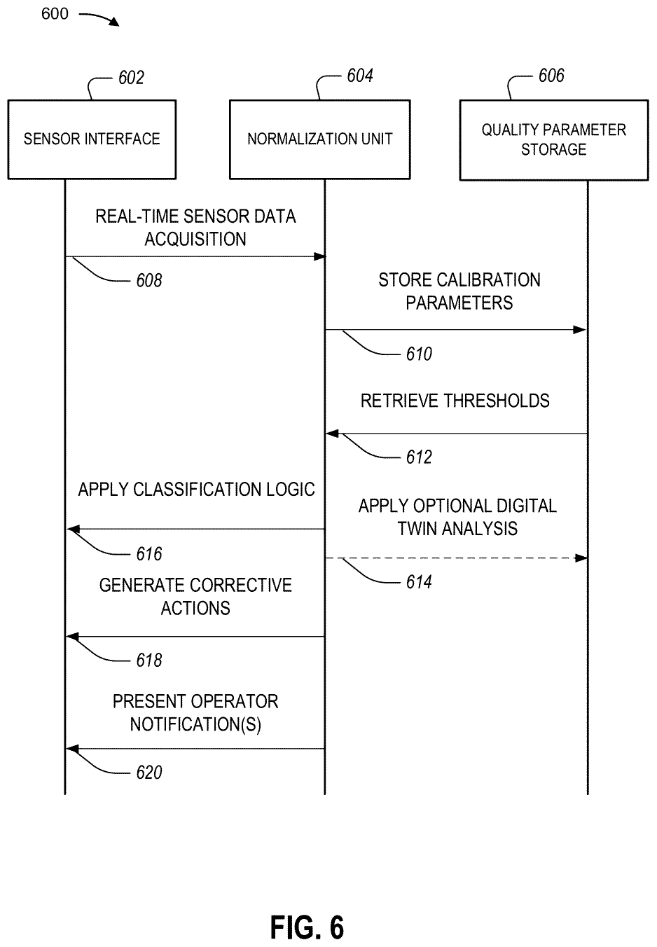

Bus 210 includes a component that permits communication among the components of Network devices 130. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 220 includes one or more processors capable of being programmed to perform a function. According to an example, processor 220 is processor 220 of FIG. 6. Memory 230 may include one or more memories such as a random-access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of Network devices 130. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits network devices 130 to receive information, such as via user input (e.g., a touch screen display, a keyboard, a keypad, a mouse, a button, a switch, and/or a microphone). Additionally, or alternatively, input component 250 may include a sensor for sensing information (e.g., a GPS component, an accelerometer, a gyroscope, and/or an actuator). Output component 260 includes a component that may provide output information from network devices 130 (e.g., a display, a speaker, a user interface, and/or one or more light-emitting diodes (LEDs)). Output component 260 may include a display providing a GUI, such as an interface. Input component 250 and output component 260 may be combined into a single component, such as a touch responsive display, known as a touchscreen.

Communication interface 270 includes a transceiver-like component (e.g., a transceiver and/or a separate receiver and transmitter) that enables network devices 130 to communicate with other devices, such as via a wired connection, a wireless connection, or a combination of wired and wireless connections. Communication interface 270 may include one or more short range communication interface modules and medium/long range communication interface modules, and may permit network devices 130 to receive information from another device and/or provide information to another device. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 210 to supply power to processor 220, memory 230, and internal components of network devices 130. Battery module 290 permits Network devices 130 to be a portable integrated device for conducting field measurements of propagation delay in a RAN.

Network devices 130 may perform one or more processes described herein. Network devices 130 may perform these processes by processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 220 to perform one or more processes described herein. Additionally, or alternatively, hardwired circuitry may be used in place of or in combination with software instructions to perform one or more processes described herein. Example embodiments user device 150 may include a mobile device/user equipment (UE) 202, a personal computer 204, or a virtual computing system 206 which may include various implementations such as those of 106. Thus, implementations described herein are not limited to any specific combination of hardware circuitry and software.

The number and arrangement of components shown in FIG. 2 are provided as an example. In practice, network devices 130 may include additional components, fewer components, different components, or differently arranged components than those shown in FIG. 2. Additionally, or alternatively, a set of components (e.g., one or more components) of network devices 130 may perform one or more functions described as being performed by another set of components of network devices 130.

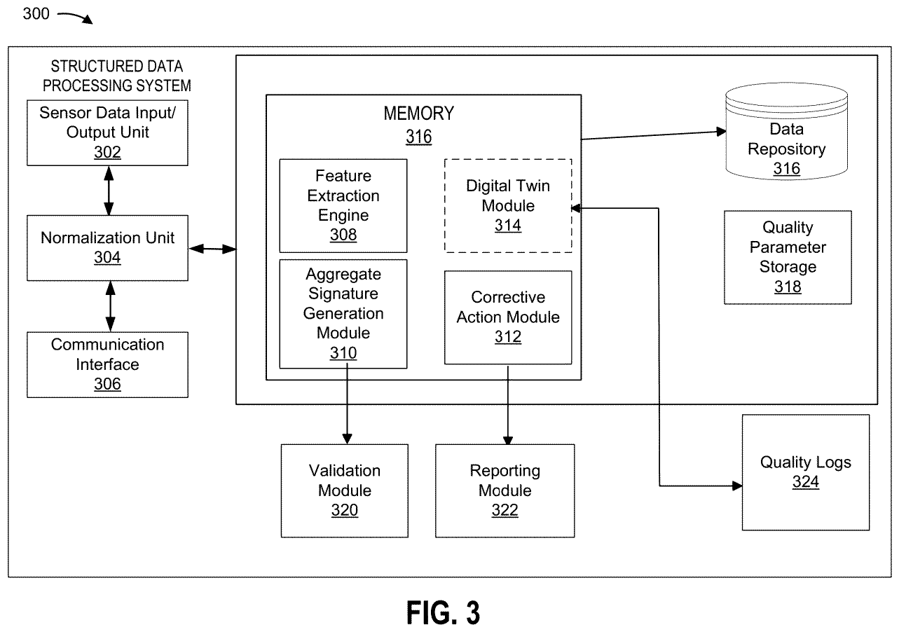

FIG. 3 illustrates a system for receiving, processing, classifying and recording pharmaceutical product data in real-time for inline quality control.

Referring to FIG. 3, which may illustrate a structured data processing system labeled as 300, various aspects may be provided for inline analysis and classification of pharmaceutical products using artificial intelligence and predefined quality parameters. In certain aspects, the system 300 may follow a structure in which a plurality of sensors arranged along a production path detect at least an electromagnetic property, molecular composition, or moisture content. In some implementations, these sensors may include a radio frequency antenna for detecting a dielectric property, a temperature sensor for reading process temperature, and an image sensor for capturing visual characteristics such as surface integrity or foreign particle presence. In some embodiments, these sensors may be configured to generate real-time data that flows into the system 300 for subsequent feature extraction, signature generation, and classification analysis.

In many aspects, a sensor data input/output unit 302 may serve as a pipeline for receiving or forwarding raw signals from the plurality of sensors. In some examples, the sensor data input/output unit 302 may interface with an inline conveyor system that physically transports the pharmaceutical products through the production path. For example, signals indicative of electromagnetic properties may arise from a radio frequency antenna measuring dielectric constants, while optical readings may come from an image sensor. In certain aspects, the sensor data input/output unit 302 may buffer these signals temporarily, enabling the system to orchestrate real-time classification when the product traverses the production path. In other aspects, the sensor data input/output unit 302 may manage initial communications to and from the server or one or more processors that collectively run artificial intelligence routines.

In various aspects, a normalization unit 304 may be downstream of the sensor data input/output unit 302, whereby multiple signals from different sensors are scaled or filtered to maintain consistent data ranges. In an example scenario, if a first sensor reports data in high-voltage analog form while another sensor provides digital bits that represent image pixels, the normalization unit 304 may unify these different data representations into a standard numeric format. In some embodiments, the normalization unit 304 may also adjust baseline offsets to account for environmental conditions such as ambient temperature or humidity that may otherwise shift sensor readings. This approach ensures thorough feature extraction, given that extracting stable features typically calls for uniform input data. In some aspects, the normalization unit 304 may also run auto-calibration routines if a sensor drifts beyond an acceptable range, thereby implementing an auto-adjustment measure when drift conditions are detected.

In many aspects, the system 300 may include a communication interface 306 that manages data exchange between the structured data processing system and external devices or servers. In certain aspects, the communication interface 306 may send sensor data to a remote server or a central classification module. In other aspects, the communication interface 306 may receive updated threshold parameters from a quality parameter storage or from an AI training module. By maintaining a flexible data link, the communication interface 306 may support dynamic updates to classification thresholds, enabling refinement of computational models based on historical outcomes. In some implementations, the communication interface 306 may exchange signals that trigger an inline corrective action if recurring anomalies are detected.

In certain aspects, the system 300 may incorporate a feature extraction engine 308 that operates on normalized data. The feature extraction engine 308 may identify one or more relevant characteristics, including dielectric property, molecular signature, or NIR absorption spectrum. In some embodiments, the feature extraction engine 308 may parse out spectral peaks, moisture-level indicators, or temperature deviations from the unified dataset. Because at least two or more extracted features—such as an electromagnetic property and a temperature—are employed, this engine 308 may analyze multiple sensor streams concurrently.

In some aspects, the feature extraction engine 308 may apply advanced signal processing algorithms that highlight short-term transients or long-term variations, aiding in classification tasks. The extracted features may then be routed forward for further combination or analysis.

In many aspects, an aggregate signature generation module 310 may receive the extracted features from the feature extraction engine 308. In some embodiments, the aggregate signature generation module 310 may generate a combined signature via feature-level fusion. For example, if the feature extraction engine 308 delivers a dielectric constant measurement, a spectral peak from an NIR sensor, and an optical image-based uniformity score, then the aggregate signature generation module 310 may unify these measurements into a single data structure that characterizes the pharmaceutical product's compliance or deviation. By adopting an ensemble or weighted scheme, the aggregate signature generation module 310 may effectively merge disparate sensor readings into a robust signature for advanced classification. In other aspects, the module may store partial signatures for real-time streaming analysis.

In certain aspects, a corrective action module 312 may exist to address products flagged as non-compliant. The corrective action module 312 can issue an inline corrective action or a rejection signal if measured data goes out of range. For example, the corrective action module 312 may instruct a mechanical diverter or pneumatic ejector to remove the product from the path if the classification indicates that moisture content or uniformity is beyond acceptable thresholds. In some aspects, the corrective action module 312 may also coordinate changes to a conveyor speed or a mixing ratio to restore compliance for subsequent items. In many implementations, the corrective action module 312 may rely on reference data stored in a server's memory to determine if certain triggers have been met, thus providing real-time transitions from detection to correction.

In many aspects, the system 300 may optionally include a digital twin module 314, which may simulate expected signals or manufacturing conditions. The digital twin module 314 may refine classification accuracy based on historical classification outcomes. For example, if the server or memory may incorporate newly labeled data or historical logs, the digital twin module 314 may replicate environmental factors or product-specific variables to predict how future items will measure. In certain embodiments, a mismatch between the digital twin module 314 prediction and the actual sensor data might prompt the system to adjust parameters or reconfigure threshold limits. In some aspects, the digital twin module 314 may share data with the aggregate signature generation module 310 to refine the fused signature used for classification. Alternatively, the digital twin module 314 may work with a training module to update an AI model if repeated deviations are found in an environment.

In certain aspects, data repository 316 may store operating instructions executed by one or more processors to perform various system processes. The data repository 316, which may or may not be physically distinct from other storages, may hold software routines for feature extraction, classification, or inline corrective actions. In some implementations, data repository 316 may also include a training module that enables retraining of an AI model with newly labeled data.

Should the system detect repeated anomalies, data repository 316 may incorporate updates to the classification thresholds or advanced modules that refine detection of foreign particles or contaminants. In many examples, data repository 316 may hold a baseline reference for each sensor type, including temperature sensor calibrations or image sensor brightness calibrations.

In many aspects, data repository 316 may be ambiguously labeled the same as data repository 316, yet it may represent a separate resource for logging large-scale data sets. In some embodiments, data repository 316 may store historical sensor input, classification results, or extended logs that allow the system to compare real-time aggregates with older runs. This historical data may help the server or one or more processors refine classification accuracy over time.

In certain aspects, the data repository 316 may be cloud-based, enabling remote AI/ML modules to access large volumes of labeled product states. The data repository 316 may further incorporate quality logs or an event-based structure that triggers alerts when non-compliant classifications occur above a certain frequency.

In certain aspects, quality parameter storage 318 may be used to hold thresholds or ranges for permissible product states, such as moisture content limits, uniformity constants, or maximum dielectric deviation. In an example scenario, if the product demands a certain mix ratio for active pharmaceutical ingredients, quality parameter storage 318 may store an upper or lower boundary for that ratio, so that the system may identify a discrepancy as soon as sensor data indicates the ratio is out of range. This integration demonstrates that the system may rely on predefined quality parameters to classify incoming products. In some implementations, the storage might be updated dynamically as repeated classification outcomes refine permissible bounds.

In some aspects, the disclosed system may operate using locally stored pre-set parameters rather than relying on AI-based cloud checks or dynamic threshold adjustments. For example, an on-site controller or memory may include a configuration file that specifies acceptable moisture content levels, temperature limits, or other relevant constraints for each product batch. In many scenarios, these pre-set parameters may be manually refreshed at predetermined intervals based on historical data or regulatory standards, thus eliminating the need for continuous cloud-based model updates. In certain implementations, a local software module may compare each incoming sensor reading—such as dielectric properties or structural signatures—against these fixed thresholds without invoking any remote inference steps. By doing so, the system may allow offline or low-latency operation in production environments where network connectivity is limited or security policies disfavor external data exchange. In some embodiments, the system may still record classification results or flagged anomalies in a local data repository, so that subsequent audits or partial re-calibrations can be conducted without depending on external computing resources.

In some implementations, the storage might be updated dynamically as repeated classification outcomes refine permissible bounds. For example, if the aggregate signature from module 310 suggests potential contamination, but the confidence score is marginal, the validation module 320 may prompt a secondary check before finalizing classification. In some embodiments, the validation module 320 may run cross-check routines or query a training module to see if newly labeled data modifies the threshold. In many aspects, a validation module 320 may verify classification outputs against stored thresholds, possibly computing a confidence score for each classification. If confidence remains low, the validation module 320 may instruct the system to slow the conveyor or request higher-resolution sensor data, effectively handling borderline classifications.

In several aspects, a reporting module 322 may produce summaries or alerts tied to the classification findings. The reporting module 322 may generate electronic notifications whenever repeated anomalies surpass a certain frequency.

In an example approach, if multiple items in a row exhibit foreign particles or moisture content beyond the threshold, the reporting module 322 may generate an instant notification for the operator console, prompting an inline corrective action. Depending on the complexity of the system, the reporting module 322 may also compile daily or weekly logs that reflect the overall compliance rate, helping managers decide if a process step needs adjustment.

In certain aspects, quality logs 324 may maintain a continuous record of classification outcomes, threshold variations, or triggered corrective actions. These logs 324 may serve as an auditable trail to demonstrate compliance with pharmaceutical regulations and process consistency. In some embodiments, if the system uses a handheld extension, the logs might record localized sensor data as well. Over time, multiple logs may feed back into data repository 316 or the data repository 316 for advanced analytics. If repeated pattern mismatches appear, the system might reconfigure the classification logic or retrain the AI with a training module, thus ensuring future misclassifications are minimized.

In many aspects, the system 300 may handle an operational flow that begins with sensor data input at 302, normalization at 304, and potential communications via 306. The flow may proceed to the feature extraction engine 308, followed by the aggregate signature generation module 310, culminating in some form of classification or corrective action triggered by the corrective action module 312. Where needed, the digital twin module 314 may be consulted to verify or simulate environmental conditions. Data repository 316 and data repository 316 may persist data or store updated classification instructions. Quality parameter storage 318 may supply or modify acceptable thresholds, while the validation module 320 confirms the classification's confidence level. If classification results reveal out-of-bound measurements or repeated anomalies, the reporting module 322 may notify an operator, and the quality logs 324 may store the relevant outcomes. In such a scenario, a mechanical diverter may be actuated to remove defective products from the path, or a mixing ratio may be modified to realign the process.

In some embodiments, the system 300 may further incorporate a Raman spectroscopy sensor, feeding captured spectral data to the feature extraction engine 308. The system may thereby detect molecular vibrations that refine the aggregate signature's compositional accuracy. In other aspects, advanced machine learning algorithms, including decision tree classifiers, support vector machines, or neural networks, may run within the system to combine multiple sensor readings.

If the system includes a handheld extension, that extension may gather localized data points from the production path, subsequently integrating them with mainline data. If the classification includes a confidence score, the validation module 320 may handle borderline results by prompting a second check. The data repository 316 might store a training module that uses prior batch data or allows sensor calibrations to be adjusted upon detected drift. If repeated anomalies appear above a certain threshold, an alert mechanism within reporting module 322 may notify operators. Finally, if a deficiency is detected in any dimension (e.g., excessive moisture or foreign particle presence), the system may apply inline corrective action where needed.

In other embodiments, the system 300 may incorporate a method to classify products in real time, receiving sensor data, extracting features, and generating an aggregate signature per parameter sets. If a measurement outside an updated threshold arises, the system 300 may refine the permissible ranges or incorporate real-time Raman spectral data for improved classification accuracy. The classification process may also tie to notifications if repeated anomalies are detected.

In certain scenarios, a non-transitory computer-readable medium may store instructions for receiving sensor data, fusing the extracted features, classifying items, and removing non-compliant products from the line. This approach ensures that a processor can respond to repeated sensor deviations or incorporate updated spectral data as needed. The result is a robust system in which all modules (e.g., feature extraction engine 308, aggregate signature generation module 310, corrective action module 312, digital twin module 314, data repository 316, validation module 320, reporting module 322, and quality logs 324) may collectively fulfill the requirements of inline pharmaceutical product classification.

The system 300 may provide an overarching structured data processing framework that collects sensor data, normalizes it, extracts relevant features, generates aggregate signatures, applies classification logic, and, in some aspects, triggers immediate inline corrective actions. One or more processors and a server with instructions stored in memory may enable both real-time classification and longer-term adaptive learning to maintain compliance with predefined quality parameters. This disclosed arrangement may detect foreign particles, measure or compare dielectric constants, track moisture content, and ensure uniformity or correct mix ratio. By capturing each step in the data flow and acknowledging multiple sensor inputs, FIG. 3 may demonstrate how the system provides inline analysis and classification of pharmaceutical products using artificial intelligence with a broad set of optional enhancements.

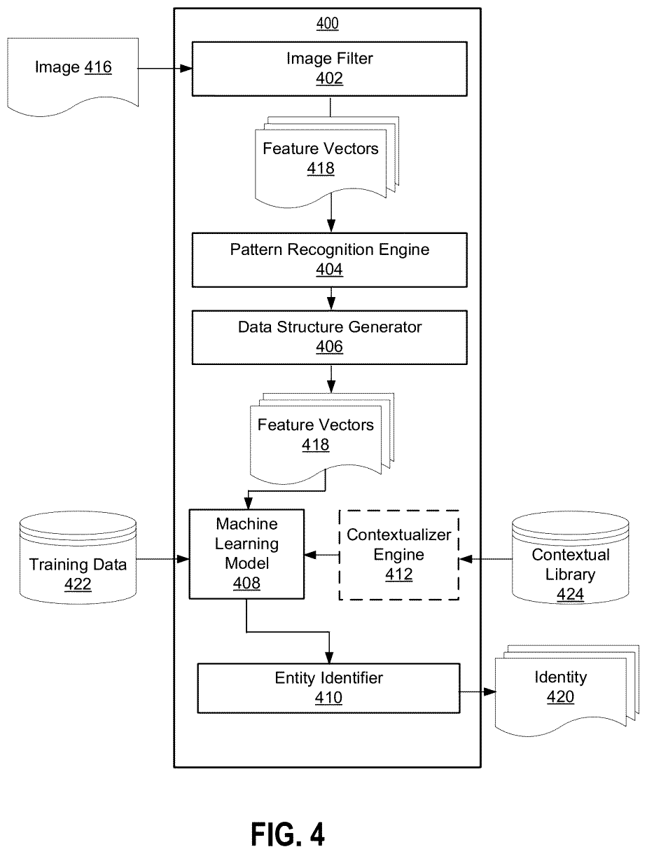

FIG. 4 illustrates a structured data processing system configured to handle sensor data for analyzing and classifying pharmaceutical products, according to various examples.

In some aspects, FIG. 4 may illustrate a portion of a system 400 that may be used for inline analysis and classification of pharmaceutical products based on predefined quality parameters using artificial intelligence. In various aspects, this system 400 may be integrated with a plurality of sensors positioned along a production path, including at least a radio frequency antenna, a temperature sensor, or an image sensor, each sensor configured to obtain real-time data indicative of dielectric properties, electromagnetic properties, molecular composition, moisture content, foreign particles, or structural integrity. In many aspects, an image 416 may represent data captured by the image sensor. The system 400 may be hosted on a server that includes a memory storing computer-executable instructions, where one or more processors may execute those instructions to cause the system to receive such sensor data when a pharmaceutical product traverses the production path. In some aspects, the inline classification of pharmaceutical products may evaluate physical state, volume, mix ratio, uniformity, contaminants, dielectric constants, or moisture content. The server may then provide instant feedback for in-process quality control by either generating an inline corrective action or, upon detecting non-compliance, issuing a rejection signal to prevent further processing of non-compliant products.

In several aspects, the image data from image 416 may be routed into an image filter 402, which may perform a variety of filtering operations to prepare a set of feature vectors 418. These feature vectors 418 may include, for example, brightness attributes, edge detections, shape descriptors, or other extracted aspects derived from the raw image. In certain aspects, in addition to or instead of optical imagery, signals from a radio frequency antenna or temperature sensor may be similarly preprocessed. The plurality of sensors may collectively detect one or more spectral peaks correlating to the molecular signatures of the pharmaceutical product, or a near-infrared (NIR) absorption spectrum used to identify moisture content or compositional integrity. In some implementations, the image filter 402 may employ convolutional filters that may enhance relevant shapes or textural patterns indicative of foreign particles. The foreign particles may also be detected in response to RF-derived data. In many aspects, the system 400 may also incorporate instructions enabling an auto-calibration stage or an adaptive threshold check that addresses different sensor outputs, thereby providing dynamic updating of parameters in response to historical classification outcomes. The server may store these threshold values or calibration factors in memory for repeated use, and the overall classification logic may rely on the updated thresholds to improve accuracy.

In various aspects, once the feature vectors 418 are obtained from the image filter 402, they may pass to a pattern recognition engine 404, which may leverage one or more software frameworks supporting advanced machine learning algorithms. This pattern recognition engine 404 may perform additional feature extraction or further refine the already extracted attributes. For example, the pattern recognition engine 404 may identify morphological shapes, cluster them, and label preliminary patterns that might indicate product uniformity or the presence of contaminants. In some aspects, the feature identification here may include any dielectric property or electromagnetic property gleaned from additional sensor feeds, such that the engine 404 may unify data from multiple sensor modalities. In many aspects, the system 400 may highlight how the pattern recognition engine 404 interacts with the underlying server processes that are configured to generate an aggregate signature for each pharmaceutical product. This aggregate signature may encapsulate at least two or more of: a temperature reading, a dielectric property, a spectral peak in the NIR band, or a molecular signature from Raman spectroscopy. In some embodiments, the pattern recognition engine 404 may also incorporate real-time Raman data, especially if a Raman spectroscopy sensor is communicatively coupled to the server, thereby allowing the detection of molecular vibrations indicative of composition. The system 400 may thus flexibly integrate signals across these different domains to create a robust basis for time-sensitive classification.

In some aspects, data flow downstream of the pattern recognition engine 404 may proceed to a data structure generator 406, which may reorganize or encode extracted or refined features into a suitable format for subsequent machine-learning or classification steps. The data structure generator 406 may transform these features into multi-dimensional arrays, serializable JSON objects, or any suitable representation used by advanced analytics frameworks, ensuring that the core aspects of the data—like brightness histograms, spectral peaks, or temperature readings—are preserved in an easily accessible structure. In several aspects, this generator 406 may produce consistent data types that may then be fused to form an aggregate signature. Feature-level fusion may combine outputs from at least two or more extracted features, the data structure generator 406 may allow for flexible insertion of additional sensor-based properties, including real-time updates for dielectric constants or NIR absorption. The generator 406 may also attach metadata tags, such as timestamps or batch identifiers, to ensure that the subsequent classification steps may cross-reference these signatures and quickly pinpoint anomalies.

In other aspects, the system 400 may include a machine learning model 408 that receives the transformed feature vectors 418 and performs final or intermediate classification steps. The machine learning model 408 may be implemented as an ensemble that includes a decision tree classifier, a support vector machine, or a neural network, provisioning an ensemble-based feature-level fusion. In some implementations, the machine learning model 408 may rely on externally supplied training data 422 that, over time, helps the model refine or update classification thresholds relating to moisture content, mix ratios, or detection of foreign particles. If historical classification results show repeated anomalies at a certain frequency, the system 400 may dynamically revise at least one computational model parameter, reflecting a dynamic refinement of classification accuracy. The server's memory may store these retraining modules, and the machine learning model 408 may engage with them, for example, on a scheduled basis or upon detecting a drift in sensor patterns, to better handle new or evolving process conditions.

In several aspects, the system 400 may incorporate an optional contextualizer engine 412, which may further enrich the classification logic by referencing a contextual library 424. The contextualizer engine 412 may link recognized patterns or feature vectors to product categories, known anomalies, or domain-specific knowledge. For example, if an elevated moisture reading is detected in conjunction with a certain spectral peak, the contextualizer engine 412 may consult stored data about chemical decomposition rates or known foreign contaminants that exhibit similar patterns. This additional context may guide more accurate classification outcomes and reduce false positives. In some implementations, the contextualizer engine 412 may also compute a confidence score for each classification, supporting possibly triggering a secondary validation process when the computed confidence is below a threshold. The contextual engine 412 may supplement the logic that decides whether to finalize a pass/fail or to escalate the item for further checks. In many aspects, references to a library of domain-specific knowledge, stored in the contextual library 424, may enable advanced correlation analyses, so that the system 400 may quickly adapt to new materials or formulations encountered on the production path.

In many aspects, the system 400 may generate, upon completion of classification, an identity or label for each product via an entity identifier 410. The entity identifier 410 may store the classification outcomes in an identity 420 record, which may include an index of products that passed or failed the compliance checks. The identity 420 may also track the cause of failure, for example, a mismatch in electromagnetic properties or a measured moisture level that exceeded thresholds. In some aspects, if repeated non-compliant occurrences are identified over a specified frequency, the system 400 may use instructions stored in the memory to transmit an electronic alert or an operator console notification, consistent with an alert mechanism for repeated non-compliance events. If a product is flagged as non-compliant, the system 400 may proceed to initiate an inline corrective action, such as adjusting process parameters or sending a rejection signal to a mechanical diverter. This ensures products that deviate from the predefined quality parameters do not proceed in production. By assigning each product an entity identity, the system 400 may maintain detailed logs for subsequent trend analyses, historical searches, or for providing real-time feedback to operators managing the production line.

In certain aspects, the image filter 402, the pattern recognition engine 404, the data structure generator 406, the machine learning model 408, the entity identifier 410, and the contextualizer engine 412 may be distributed across different hardware modules within the server architecture. Alternatively, they may coexist in a single hardware location. The one or more processors that perform these tasks may cause the system to enact feature extraction by identifying a temperature, a spectral peak, or a molecular signature, and to generate an aggregate signature. The system 400 may accomplish real-time classification by leveraging a high-throughput pipeline that processes each pharmaceutical product as it moves along the production path, ensuring an immediate decision regarding compliance. In other aspects, the system 400 may store intermediate states in memory, allowing secondary modules or external servers to reevaluate the data. By combining textural or visual features from image 416 with other sensor-derived properties, the system 400 may achieve integrated classification outcomes. In many aspects, this approach meets the requirement of evaluating multiple physical characteristics, such as the physical state of a tablet's exterior, the volume or uniformity of powders, or the presence of contaminants, thereby facilitating in-process quality control. By leveraging advanced pattern recognition, the system 400 may highlight anomalies in substantially real time and direct immediate eject or correction directives to the production machinery.

In some aspects, the machine learning model 408 may further incorporate metadata from the contextual library 424 or from external specialized datasets, thereby refining or personalizing classification thresholds for different types of pharmaceutical products. The aggregated signature for each item may reflect a combination of electromagnetic property readings, NIR absorption levels, or partial Raman spectral data, and the contextualizer engine 412 may interpret these in light of the system's stored knowledge. If the mismatch between expected and measured dielectric properties surpasses a certain tolerance, the system 400 may generate an inline corrective action that increases or decreases the mixing ratio of specific ingredients. Alternatively, if the mismatch arises repeatedly, the system 400 may send an electronic alert to an operator console, thus ensuring repeated non-compliance above a set frequency triggers an alert mechanism. The system 400 may also rely on the training data 422 to adapt the machine learning model 408 dynamically, thereby improving classification precision over time. This closed-loop calibration ensures that if the sensor drifts or if new forms of contamination appear, the system 400 may remain robust by updating the relevant classification routines swiftly.

In other aspects, the entity identifier 410 may attach product-specific identifiers to the outputs of the machine learning model 408, enabling a seamless link between product identity and real-time classification results. This association may facilitate additional downstream tasks, such as generating compliance certificates for products that pass every threshold or performing root cause analysis once any product fails classification. The identity 420 logs might also store unique details about temperature readings that exceeded a certain range, or foreign particles spotted by the pattern recognition engine 404 within the feature vectors 418. Because the system 400 may run the entire classification sequence in near real time, it may also signal a downstream mechanical diverter if a product is flagged as non-compliant. That diverter may physically remove or eject the sample from the production line, providing rejection signals for non-compliant items. If the system 400 is integrated with upstream or downstream modules, it may further refine the environment conditions, like adjusting temperature or humidity, whenever repeated deviations suggest a broader process calibration issue. This synergy of rapid classification, data structure generation, adaptive threshold checks, contextual referencing, and real-time product labeling underscores the system's capacity to manage inline analysis for a variety of pharmaceutical manufacturing scenarios, each requiring compliance with different quality parameters.

In several aspects, the structure shown in FIG. 4 may represent one potential configuration of software and data-processing blocks in the server environment, and the same or alternate hardware may be scaled to handle higher production volume by running parallel image filters or concurrent pattern recognition threads. The system 400 may also incorporate compressive sensing or advanced sampling techniques when dealing with high-speed pharmaceutical lines, ensuring sufficient data for classification is captured. Each block—such as the image filter 402 or the entity identifier 410—may be selectively enabled or omitted depending on cost constraints, product types, or specific regulatory needs. The memory storing computer-executable instructions may support each of these functionalities, and the one or more processors may coordinate tasks, such as receiving image or sensor signals, pre-filtering data, extracting features, generating signatures, classifying, and initiating real-time corrective actions. By maintaining a modular structure, the system 400 may be reconfigured or updated with new sensors, such as additional environmental sensors for temperature or humidity, without extensive redesign. This flexible architecture encourages recalibration or dynamic model training, while fulfilling the an objective to evaluate physical state, volume, mix-ratio, uniformity, contaminants, dielectric constants, or moisture content in a manner that provides immediate operational feedback.

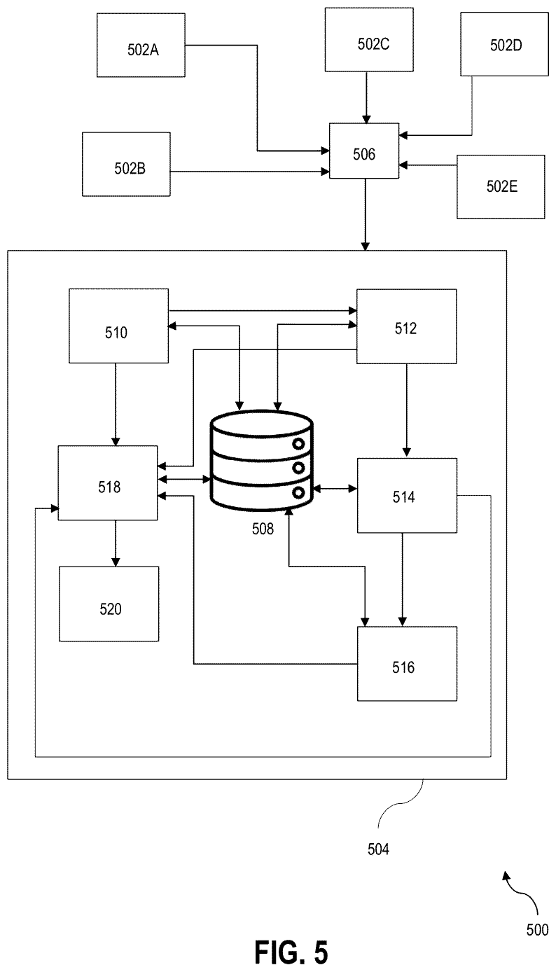

FIG. 5 illustrates a system for analyzing and classifying pharmaceutical products based on predefined quality parameters using artificial intelligence according to various embodiments.

The system 500 includes one or more sensors 102A-E, a server 504, and a communication network 506. The one or more sensors 502A-E are configured to obtain properties of pharmaceutical products in a production unit. The one or more sensors 502A-E may include a near-infrared (NIR) sensor 502A, a Raman spectroscopy sensor 502B, a radio frequency (RF) antenna 502C, a temperature sensor 502D and an image sensor 502E like camera. Some embodiments of temperature probes, or RF-and-temperature probes, may be handheld or may be as shown in 502D. For each type of sensor, one or more individual sensors may be utilized, ensuring adaptable and scalable monitoring configurations. This modular approach allows the system 500 to provide tailored monitoring capabilities, supporting varied and precise quality assessments as needed for different pharmaceutical applications. The one or more sensors 502A-E are communicatively connected to the server 504 through the network 506. The system 500 includes the server 504 that includes a plurality of modules stored in a database 508. The plurality of modules of the server 504 includes a data receiving module 510 configured to receive sensor data from the one or more sensors 502A-E. The data receiving module 510 of the server 504 continuously receives high-frequency data from the one or more sensors 502A-E.

The server 504 hosts a series of specialized modules designed to enable robust, real-time quality control. The data pre-processing module 512 removes noise and harmonizes the sensor data, preparing it for deeper analysis. Next, the feature extraction module 514 identifies relevant characteristics from the sensor data, such as spectral peaks, dielectric constants, molecular signatures, and moisture levels. Frequency-dependent dielectric responses may be among the characteristics identified as well. These features are then integrated in the aggregate signature generation module 516, which uses feature-level fusion techniques to combine the relevant characteristics into a comprehensive aggregate signature. An AI model 518, trained on a diverse dataset of pharmaceutical products labeled with known quality parameters and defects, analyzes this comprehensive aggregate signature. It classifies the product based on predefined quality criteria, including content composition, physical state, volume, uniformity, moisture content, contaminants, and foreign particles. The model detects and flags any deviations from quality standards, such as anomalies in composition, moisture levels, structural integrity, or the presence of foreign matter. These deviations may signal issues like manufacturing errors, contamination, or material inconsistencies. The server 504, potentially cloud-based, stores data on both compliant and non-compliant products, enabling continuous refinement of the AI model. This adaptive learning process enhances the model's ability to detect even minor deviations over time, providing increasingly robust in-process quality control. The plurality of modules of the server 504 includes a feedback module 520 configured to generate real-time feedback once a deviation or defect is detected. The real-time feedback allows for immediate corrective action, ensuring that defective products are identified before they proceed further down the production line.

In some embodiments, the one or more sensors 502A-E are positioned along the production path of a production unit. The feedback may be communicated to the production control system. In some embodiments, the system 500 may automatically adjust key production parameters to prevent further defects. For example, if a moisture level deviation is detected, the system 500 may alter drying times or environmental conditions to correct the moisture content in subsequent products. Similarly, if foreign particles are detected, the system may halt production and activate cleaning protocols. In some embodiments, the system 500 is integrated with a rejection mechanism, such as a pneumatic or mechanical device, which automatically sorts out and removes defective products based on the real-time analysis. This ensures that only products meeting the predefined quality standards proceed to packaging or further processing.

In some embodiments, the system 500 may be provided as a handheld or mobile device that enables manufacturers to perform in-process checks, allowing real-time adjustments during production. For example, a handheld device may analyze the products as it is being processed to detect deviations such as improper moisture content or the presence of foreign particles, giving immediate feedback to operators for corrective actions.

As a portable device, the system 500 enables on-the-spot analysis and classification of pharmaceutical products, directly within the production setting. This compact, handheld design integrates the one or more sensors 502A-E and the AI capabilities, allowing operators to perform real-time quality checks without needing fixed or large-scale equipment.

FIG. 6 illustrates an example of a flow diagram showing how real-time sensor data is acquired, normalized, and then evaluated against stored calibration parameters.

In some aspects, FIG. 6 may illustrate a portion of a system 600 that may facilitate inline analysis and classification of pharmaceutical products based on predefined quality parameters using artificial intelligence. In various aspects, the system 600 may include a sensor interface 602, which may be arranged along a production path to receive data from a plurality of sensors, such as a radio frequency antenna, a temperature sensor, and an image sensor. These sensors may acquire real-time data indicative of an electromagnetic property, molecular composition, moisture content, presence of foreign particles, or structural integrity for each product traversing the production line. In several aspects, the sensor interface 602 may convert incoming analog signals to digital format or bundle data transmissions for subsequent processing, and this interface may communicate directly or indirectly with a server that holds a memory storing computer-executable instructions.

In other aspects, the system 600 may incorporate a normalization unit 604 to perform initial calibration or data scaling of these sensor readings. The normalization unit 604 may standardize measurement values across a variety of incoming signals, including radio-frequency data, temperature differentials, or spectral peaks from near-infrared absorption sensors. By applying appropriate mathematical transformations or offset adjustments, the normalization unit 604 may reduce variability caused by sensor drift or extraneous noise. In many aspects, the normalization process may help ensure that subsequent feature extraction steps consider consistent value ranges. The normalization unit 604 may store intermediate results in the server memory so that one or more processors may execute instructions to generate an aggregate signature used to classify each pharmaceutical item.

In some aspects, the system 600 may further include a quality parameter storage 606, which may retain threshold values, calibration parameters, or additional configuration details used to decide when a product is non-compliant. The quality parameter storage 606 may, for example, define acceptable ranges for dielectric properties, moisture content levels, or expected electromagnetic signals correlating with a known molecular composition. The one or more processors executing instructions from the server may reference the quality parameter storage 606 to compare real-time sensor data with these thresholds. In certain aspects, the system 600 may dynamically update at least one parameter in quality parameter storage 606 if historical classification outcomes indicate that new thresholds would improve overall accuracy. This approach may incorporate a feedback loop that refines the classification model in real time, consistent with the notion of adjusting the system in response to repeated classification results.

In various aspects, FIG. 6 may depict a real-time sensor data acquisition 608 step carried out via the sensor interface 602, referring to continuous ingestion of signals from each sensor positioned along the production path. This real-time aspect may be crucial for inline classification, because the system 600 may need to evaluate each pharmaceutical product as it passes beneath the array of sensors, measuring one or more of temperature, dielectric constant, or foreign-particle presence. If the system identifies a mismatch between measured data and thresholds stored in the quality parameter storage 606, the one or more processors may invoke feature extraction that identifies, for example, a spectral peak, a temperature deviation, or a molecular signature. In some aspects, the system may incorporate near-infrared absorption spectrum signals, Raman effect data, and electromagnetic property readings, in line with the possibility of having multiple sensor modalities.

In some implementations, the system 600 may invoke a store calibration parameters step 610 operation to keep track of sensor-specific or environment-specific baselines. This operation may store the sensor calibration offsets, gain values, or reference signals, so that any shift beyond an acceptable operational tolerance range triggers an internal maintenance alert or auto-correction routine. For example, if the radio frequency antenna requires a daily self-check, the store calibration parameters step 610 may ensure updated calibration details are securely placed in the quality parameter storage 606, thus allowing immediate retrieval whenever the normalization unit 604 processes real-time data. In certain aspects, if repeated anomalies are detected during calibration, the system 600 may transmit an alert or schedule a maintenance override.

In other aspects, FIG. 6 may illustrate that the system 600 performs a retrieve thresholds step 612, which allows the normalization unit 604 or the classification logic to acquire the relevant permissible ranges for evaluating moisture or dielectric constants. In many aspects, these thresholds may be updated automatically or may be set by an operator console, depending on a production batch or the type of pharmaceutical product being processed. The retrieve thresholds step 612 operation may ensure that any inline classification references the most recent version of permissible values, dynamically updating at least one parameter in response to historical classification outcomes. The retrieved thresholds may then be used by the instructions stored in the server memory to compute whether a product is compliant or non-compliant.

In several aspects, the system 600 may optionally include an apply optional digital twin analysis 614 process. This step may run a simulated environment that predicts shifts in temperature, humidity, or other environmental conditions, comparing them to real-time sensor data. The digital twin analysis 614 may generate a set of expected readings for the product under nominal conditions, thus allowing the system to spot irregularities with higher confidence. For example, if the digital twin forecast indicates a certain dielectric signature for a well-mixed product, but the real sensor data deviates significantly, the system 600 may infer a potential foreign contaminant or a moisture spike. In some aspects, the one or more processors executing instructions from the server may refine the classification model with each iteration of the digital twin analysis 614, possibly adjusting threshold values stored in the quality parameter storage 606. This approach aligns with advanced detection of material composition and subsequent corrective actions in near real time.

In many aspects, the system 600 may then apply classification logic 616, which may include performing feature extraction using at least two or more of dielectric properties, electromagnetic properties, temperature, NIR absorption spectra, Raman effects, or spectral peaks to generate an aggregate signature for each product. This classification logic 616 may be supported by an ensemble of machine learning algorithms running on the server, combining outputs from decision trees, support vector machines, and neural networks. The classification logic 616 may cross-reference the thresholds retrieved from the step 612 to determine if any sensor reading exceeds a permissible limit. In some aspects, the system 600 may compute a confidence score for each classification, and if that score is below a predefined threshold, the system may trigger a secondary validation process or transmit a request for additional sensors to re-scan the product. Optionally, this classification logic 616 may incorporate instructions to handle real-time Raman spectral data or other specialized sensor inputs, consistent with mentions of real-time Raman spectral data to detect molecular vibrations of composition.

In other aspects, FIG. 6 may show a generate corrective actions 618 phase, where the system 600 may initiate an inline corrective action in substantially real time if a product is found to be non-compliant. This corrective action may include adjusting a conveyor speed, modifying the local environment temperature or humidity, changing a process mixing time, or triggering a mechanical diverter to remove the questionable product from the production path. The system 600 may also store logs of these corrective actions for subsequent analysis, ensuring that each anomaly may be traced back to its sensor-based cause. If repeated anomalies occur within a specified window, the system 600 may further transmit an electronic alert to an operator console or update the classification model to refine detection thresholds.

In several aspects, the system 600 may continue with a present operator notification(s) 620 step, depicting how the server may display or communicate the classification outcomes and any generated corrective measures. The operator may receive a visual dashboard prompt or an automated message highlighting each product's compliance status and the specific sensor data that influenced that determination. In some aspects, these operator notifications may reflect repeated non-compliances or may indicate a discrepancy between expected and measured dielectric properties, clarifying precisely which threshold triggered the alert. If the real-time sensor data acquisition 608 consistently yields abnormal measurements, the system 600 may further highlight the need for new calibration parameters or additional maintenance steps. By presenting operator notifications, the system ensures that human supervisors remain cognizant of real-time classification trends, providing in-process quality control feedback.

In many aspects, the sensor interface 602, normalization unit 604, quality parameter storage 606, real-time sensor data acquisition 608, store calibration parameters step 610, retrieve thresholds step 612, apply optional digital twin analysis 614, apply classification logic 616, generate corrective actions 618, and present operator notification(s) 620 may all be integrated within one server or distributed among multiple computing devices. The memory storing computer-executable instructions may coordinate these steps such that, for each pharmaceutical product, the system 600 obtains sensor data, extracts relevant features, evaluates them against predefined thresholds, and responds with an inline corrective mechanism if necessary. By using an ensemble-based approach for classification, the system may handle multiple data streams, from radio frequency sensors to temperature or NIR imaging, all fused into an aggregate signature. In some aspects, any mismatch between measured sensor data and the thresholds stored in the quality parameter storage 606 may prompt an immediate rejection signal, leading to near real-time removal of that product from further production. This integrative design may protect overall quality and consistency in pharmaceutical manufacturing lines.

In certain aspects, the system 600 may incorporate or reference a handheld extension that gathers localized sensor readings at specific intervals, after which the data may be normalized using the normalization unit 604. If that localized data indicates an anomaly, the system 600 may retrieve thresholds step 612 from the quality parameter storage 606 and decide if the item is considered non-compliant. The optional digital twin analysis 614 may further confirm or reject the anomaly by simulating expected sensor outputs. By thus combining local handheld data with the inline sensor interface 602, the server may refine or override classification decisions, especially if the confidence score in the ensemble-based classification is borderline. This flexible structure ensures that advanced or specialized checks are integrated directly into the same classification workflow, preserving continuity between high-throughput production scanning and spot checks done by human operators.

In several implementations, the classification logic 616 may rely on a training module stored in memory, which may retrain the system on new labeled data over time. The quality parameter storage 606 may be updated accordingly, ensuring that the retrieved thresholds step 612 stay relevant, even if product formulations evolve or if sensor performance changes. As part of these updates, the generate corrective actions 618 step may further refine how frequently the system triggers an alert or modifies process parameters. In some aspects, repeating anomalies above a set frequency may prompt an operator notification 620 culminating in a higher-level alarm or an automated adjustment to maintain compliance. Through this chain of steps, the system 600 may effectively ensure that each pharmaceutical product is subjected to a well-calibrated set of measurements, that these measurements are transformed or normalized in consistent ways, and that classification outcomes tie directly into a robust feedback loop for in-process quality control.

In many aspects, the structure depicted in FIG. 6 may represent a logical flow. The sensor interface 602 serves as the entry point for real-time sensor data acquisition 608, the normalization unit 604 handles data conditioning, the quality parameter storage 606 maintains relevant thresholds and calibration parameters (for example, storing those parameters in step 610 and retrieving them in step 612), an optional digital twin analysis 614 may refine detection before the classification logic 616 is applied, followed by the generate corrective actions 618 stage if non-compliance is found, and finally the present operator notification(s) 620 step. This progression may run continuously, item by item, along a conveyor or production line. By enabling each sub-procedure to be repeated and updated over time, the system 600 may address newly emerging anomalies, sensor drifts, or evolving production demands.

In some aspects, each of these labeled modules or steps may be implemented using distinct hardware, or they may be combined on a single computing board. The sensor interface 602 might incorporate high-speed analog-to-digital converters, the normalization unit 604 might be realized in a digital signal processor (DSP), and the classification logic may operate on a graphical processing unit (GPU). The memory storing instructions may be subdivided among multiple servers, and the quality parameter storage 606 might be a secure database accessible over an internal network. Such a design ensures open-ended flexibility while maintaining a consistent architecture for applying feature-level fusion, generating aggregate signatures, and instantly triggering corrective actions or rejections. As a result, the system 600 may strongly emphasize in-process identification of non-compliant pharmaceutical products and immediate inline adjustments or rejection signals, enhancing overall manufacturing reliability.

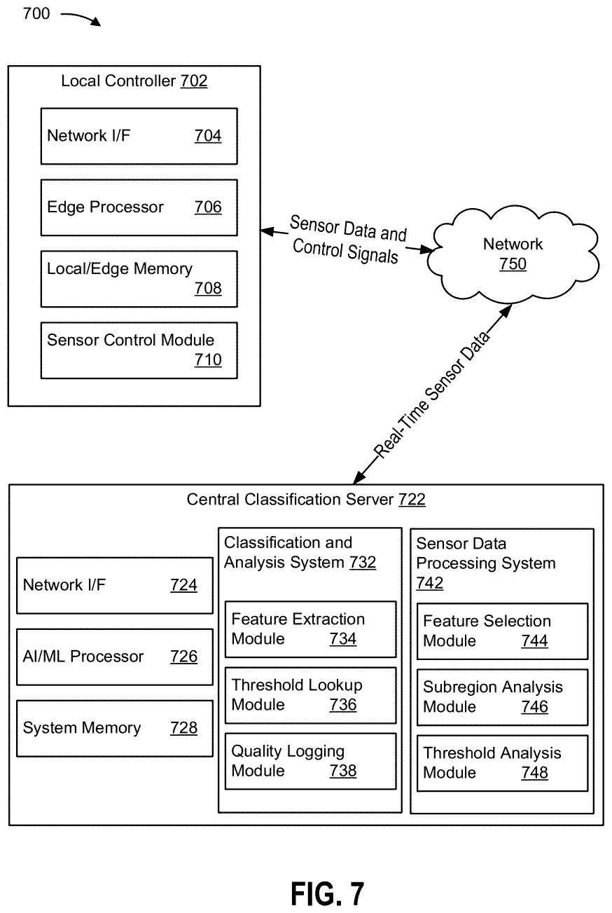

FIG. 7 illustrates an architecture for network-based or cloud-assisted classification, according to various examples.

In some aspects, FIG. 7 may illustrate a portion of a system 700 that may be configured to perform inline analysis and classification of pharmaceutical products using artificial intelligence and predefined quality parameters. In various aspects, the system 700 may include a local controller 702 that may be positioned near a production line, receiving sensor data related to each pharmaceutical product as it moves along a path. The local controller 702 may gather electromagnetic property readings, temperature measurements, and images from a plurality of sensors. In several aspects, these sensor sets may include at least a radio frequency antenna, a temperature sensor, and an image sensor, each configured to capture real-time data reflecting dielectric properties, moisture content, molecular composition, and foreign particles. The local controller 702 may then forward processed or partially processed data, along with any immediate control signals, to a higher-level computing environment for further classification and inline corrective actions.

In some aspects, the local controller 702 may incorporate a network I/F 704, which may provide one or more network protocols to transmit data to and from a central classification server or other remote analytics systems. The network I/F 704 may send sensor signals, partial feature vectors, or alerts over a wired or wireless network link, ensuring minimal latency for real-time classification decisions. In many aspects, this local network interface may support encryption or authentication layers so that sensitive sensor data remains secure, particularly if the local controller 702 is situated within a regulated pharmaceutical environment.

In certain aspects, the local controller 702 may further include an edge processor 706, which may execute computer-executable instructions to handle initial filtering, aggregation, or partial feature extraction on raw sensor signals. The edge processor 706 may rely on localized memory and computational frameworks to conduct tasks, for example, normalizing radio-frequency data or detecting preliminary anomalies in an image-based dataset. In some aspects, the edge processor 706 may incorporate hardware accelerators, such as GPUs or FPGAs, to handle high-throughput computations in real time. If a product's sensor reading reveals a deviation beyond a permissible threshold, the edge processor 706 may immediately flag the product for further review or trigger an inline corrective action if the discrepancy meets certain criteria, such as a measured moisture level exceeding a threshold.

In many aspects, the local controller 702 may include a local/edge memory 708, which may store relevant configuration parameters or intermediate data from the sensors. The local/edge memory 708 may hold calibration offsets, time-stamped logs of sensor readings, or partial classification states that are useful for inline decision-making. In some implementations, the system may incorporate an auto-calibration routine referenced in the memory, ensuring that each sensor's offsets or gains are updated if a drift is detected. The local/edge memory 708 may also cache network messages from a central classification server to quickly update threshold parameters if historical classification outcomes call for dynamic tuning. This memory may be volatile RAM, a flash-based module, or a more persistent storage device, depending on manufacturer preferences or cost constraints.

In other aspects, the local controller 702 may further comprise a sensor control module 710, which may manage activation signals, synchronization pulses, or power states for the plurality of sensors. By directing the sensor control module 710 to operate each radio frequency antenna, temperature sensor, or image sensor at specific intervals, the system may reduce noise and align the scanning process with the production line's speed. The sensor control module 710 may also handle sensor-specific tasks, like adjusting the frequency band for an electromagnetic transceiver or controlling shutter speeds for an image sensor. If the sensor drift surpasses an acceptable operational tolerance range, the sensor control module 710 may flag a maintenance alert and optionally check for foreign contaminants or NIR absorption anomalies, consistent with the wide range of sensor data sought by the system's classification routines.

In some aspects, the system 700 may employ a secure channel to link the local controller 702 with a network 750, which may facilitate real-time sensor data and control signals between on-premises hardware and remote computing resources. The network 750 may also manage data exchange between the local controller and a remote or central classification server, ensuring throughput is sufficient to handle the volume of sensor readings. If repeated anomalies occur, the system may use the network 750 to push updated classification thresholds or calibration parameters back to the local controller 702. This arrangement may help incorporate new knowledge gleaned from historical classification outcomes, refining overall accuracy in near real time.

In many aspects, the system 700 may further involve a central classification server 722, which may function as a primary or secondary layer of analysis for inline classification. The central classification server 722 may operate a large-scale computational infrastructure to process incoming sensor readings, unify multiple sensor modalities into an aggregate signature, and decide whether a product is compliant or non-compliant. The central classification server 722 may store instructions in memory that cause it to evaluate at least two or more extracted features (for example, electromagnetic property readings, temperature signals, or NIR spectral peaks), fusing them into a single classification result. If the server detects that a measured parameter is outside a predefined range, it may issue a rejection signal to ensure any non-compliant product is diverted from the production path.

In other aspects, the central classification server 722 may include a network I/F 724, which may communicate with the local controller 702 and receive sensor data or partial classification outputs. In some implementations, the network I/F 724 may also enable the server to interface with external databases, additional or alternative sensors placed along the production line, or operator consoles. The central classification server 722 may rely on specialized frameworks to handle advanced machine learning tasks or modeling algorithms, ensuring that classification remains robust as conditions shift.

In several aspects, the central classification server 722 may incorporate an AI/ML processor 726 that may run ensemble-based classification algorithms. The AI/ML processor 726 may, for example, combine outputs from a decision tree classifier, a support vector machine, and a neural network to arrive at a final decision regarding each product's compliance. This arrangement may allow the system 700 to detect subtler anomalies, such as a small discrepancy in dielectric constants or a subtle foreign particle, consistent with the scope of analyzing volume, mix-ratio, and contaminants. In various embodiments, the AI/ML processor 726 may interpret real-time Raman spectral data if a Raman sensor is coupled to the system, thereby adding molecular vibration information into the aggregate signature.

In some aspects, the central classification server 722 may also have system memory 728, which may store software modules, model weights, threshold tables for classification decisions, and logs of historical sensor readings. The memory 728 may include instructions to dynamically update at least one parameter of the server's computational model whenever repeated classification outcomes indicate drift or new baseline conditions. If repeated anomalies occur within a short time, the system memory 728 may trigger instructions that cause automated notifications or inline corrective steps, aligning with the notion of providing real-time feedback.

In various aspects, the central classification server 722 may be divided into a classification and analysis system 732 and a sensor data processing system 742, with each area containing distinct modules that collectively handle data ingestion, feature extraction, threshold comparison, and final classification. The classification and analysis system 732 may include a feature extraction module 734 that processes raw or partially normalized sensor data to compute shapes, intensities, or other parameters. This module 734 may identify spectral peaks or electromagnetic properties relevant to each pharmaceutical product. In many aspects, the feature extraction module 734 may store extracted data in system memory 728 for subsequent usage by the threshold lookup module 736.

In some aspects, the threshold lookup module 736 may retrieve permissible ranges or baseline signatures from the memory. By comparing the extracted sensor features to these known baselines, the threshold lookup module 736 may determine whether a discrepancy exists that justifies a classification of non-compliant. If so, the system may instruct the server or local controller to initiate an inline corrective action, such as adjusting a conveyor speed, changing a process temperature, or issuing a rejection signal. The module 736 may also be capable of referencing stored historical data to adapt thresholds in real time, consistent with implementing dynamic updates based on previous classification outcomes.

In other aspects, the classification and analysis system 732 may further include a quality logging module 738, which may record pass/fail outcomes, the extracted feature sets, or confidence scores assigned by the machine learning ensemble. The quality logging module 738 may store the logs in system memory 728 or an external database, establishing a paper trail of each product's classification. If repeated non-compliant classifications occur, the quality logging module 738 may optionally initiate an electronic notification to an operator console, fulfilling requirements for alerting operators when anomalies exceed a certain frequency. By referencing these logs, plant managers or automated processes may refine production parameters to maintain consistent compliance with the static or dynamically evolving thresholds.

In many aspects, the sensor data processing system 742 of the central classification server 722 may include a feature selection module 744 that helps isolate the most predictive or relevant measurements from the sensor data. The feature selection module 744 may parse the data provided by the feature extraction module 734 and remove redundant or noise-prone features, leading to faster or more accurate classification. If the system discovers that certain temperature readings are highly correlated with anomalies, the feature selection module 744 may prioritize them in subsequent classification cycles. This process may also be integrated with sub-steps that check if updated sensor calibrations are necessary.

In certain aspects, the sensor data processing system 742 may incorporate a subregion analysis module 746, which may target localized sections of an image, or localized frequency bands of an RF signature, for finer-grained detection of foreign particles or micro-structural changes. The subregion analysis module 746 may detect small hotspots of contamination or temperature differentials, referencing the threshold lookup module 736 to see if those localized changes surpass permissible bounds. Any anomaly that suggests the product is outside parameters—such as a foreign object or a mismatch in molecular composition—may prompt the generation of a classification label indicating potential non-compliance.

In other aspects, the sensor data processing system 742 may further include a threshold analysis module 748, which may refine the comparison logic used to decide if a bridging product might be borderline compliant versus truly non-compliant. By weighting or smoothing overlapping data from multiple sensors, the threshold analysis module 748 may reduce false positives or false negatives, ensuring the system does not remove acceptable products. If the threshold analysis module 748 determines that the classification's confidence score is below a certain threshold, a secondary validation process may be triggered. This conditional approach supports that one or more processors may compute a confidence score and possibly require re-checks before finalizing the classification.

In some aspects, sensor data and control signals from the local controller 702 travel through the network 750 in near real time to reach the central classification server 722. Conversely, the server may broadcast updated parameters back to the local controller if repeated or unusual measurement deviations arise, reflecting the capability to dynamically adjust the system in response to historical classification outcomes. The local controller may then rely on edge processor 706 and sensor control module 710 to enforce newly set thresholds or scanning frequencies, ensuring that any anomalies are identified even sooner in the next iteration of product scans. In many aspects, this tight integration between local and remote resources allows the system to operate robustly in scenarios with variable production speeds.

In certain aspects, the system 700 may be implemented using distributed hardware, so that the local controller 702 handles time-critical tasks, such as queueing immediate rejection signals to remove a defective product from the line, while the central classification server 722 performs deeper ensemble-based analysis for uncertain cases or repeated anomalies. If the subregion analysis module 746 detects a pattern of recurring contamination, the threshold analysis module 748 may update the relevant threshold in near real time, and the local/edge memory 708 may store that new threshold. The sensor control module 710 may subsequently apply a narrower or expanded scanning region, increasing the detection rate of foreign particles. This arrangement ensures comprehensive capabilities of: real-time data acquisition, feature extraction, threshold comparison, aggregated classification, immediate corrective or rejection signals, and any updates needed for dynamic recalibration. Such a synergy may help preserve product quality through minimal manual intervention while achieving high accuracy in classification.

In many aspects, an operator console connected to the central classification server 722 or the local controller 702 may receive real-time alerts if repeated anomalies occur, consistent with an alert mechanism that transmits notifications above a certain frequency of non-compliance. The AI/ML processor 726, in conjunction with the feature extraction module 734 and threshold lookup module 736, may label products as non-compliant if they exhibit temperature readings outside a predefined range, if the measured moisture content surpasses a threshold, or if a foreign object is detected in the electromagnetic or optical data. Consequently, the system 700 may sustain an ongoing cycle of classification checks, inline corrective actions, maintenance alerts, and dynamic threshold updates, ensuring robust and immediate quality control that is not limited to a single sensor type.

In other aspects, if a handheld extension is introduced on the production path to scan localized data at a micro-level, the sensor data and control signals from that extension may pass through the local controller 702 as well. The central classification server 722 may then integrate those localized measurements with the global data to refine classification, especially in borderline scenarios. By delegating partial tasks to the local edge processor 706 and advanced tasks to the AI/ML processor 726, the system 700 may scale to handle very large production volumes while preserving near real-time feedback. This modular configuration also allows different subsets of sensors, references, or corrections to be introduced if new product types demand fresh calibration or different threshold logic.

In several aspects, the references to the classification and analysis system 732, sensor data processing system 742, local controller 702, and network 750 may collectively represent how the entire system 700 is integrated to detect, classify, and correct for non-compliance. Whether a product's heavy moisture content triggers a discrepancy or a small foreign particulate is identified by subregion analysis, the system may instantly alert the user or physically reject the product. By logging each classification in the quality logging module 738, the system may also develop a historical record, enabling future modeling improvements or verifying compliance with regulatory audits. Through all these components, FIG. 7 may reflect a scalable, flexible approach to inline classification that addresses the physical properties, molecular composition, contaminant presence, and other aspects enumerated in the broader scope of technology.

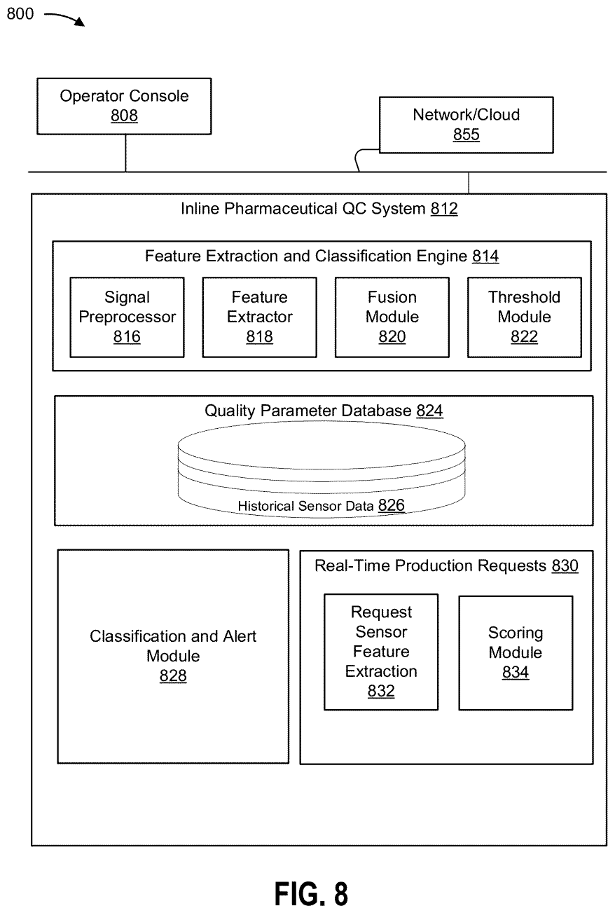

FIG. 8 illustrates an example of an inline pharmaceutical quality control system, according to various examples.

In some aspects, FIG. 8 may illustrate a portion of a system 800 that may facilitate inline analysis and classification of pharmaceutical products using artificial intelligence and predefined quality parameters. In various aspects, system 800 may include an operator console 808 that may communicate with an inline pharmaceutical QC system 812. The operator console 808 may display real-time alerts or classification outcomes, and it may also permit authorized users to modify permissible thresholds or process parameters, for example, conveyor speed or mixing ratio. In some aspects, these communication exchanges may be carried out through a network/cloud 855, which may support wired or wireless data transmissions between remote sites, local computing devices, or cloud-based analytics platforms.

In many aspects, the inline pharmaceutical QC system 812 may be responsible for capturing and analyzing sensor data from a plurality of sensors arranged along a production path, each configured to obtain real-time data indicative of at least one electromagnetic property, molecular composition, moisture content, presence of foreign particles, or structural integrity of the products. In certain aspects, these sensors may include, at a minimum, a radio frequency antenna, a temperature sensor, and an image sensor. If the system 812 detects anomalies in the measured parameters—for example, if a damping in the electromagnetic signal suggests the presence of contaminants—the system may initiate an inline corrective action or a rejection signal to divert non-compliant items from further processing.

In some aspects, the inline pharmaceutical QC system 812 may be subdivided into multiple functional modules that collectively perform feature extraction, classification, threshold checking, data fusion (data-level or feature-level fusion), and alert generation. A feature extraction and classification engine 814 may reside within system 812, implementing advanced methods to handle data measured by, or transmitted from, the sensor array. This engine 814 may be configured to evaluate a variety of product characteristics such as volume, mix ratio, uniformity, dielectric constants, or moisture content. If the system identifies a product as non-compliant, the engine 814 may act in substantially real time to prevent the item from proceeding further.

In certain aspects, the feature extraction and classification engine 814 may include a signal preprocessor 816, which may be responsible for preliminary filtering, noise reduction, calibration offset correction, or other transformations that refine the raw sensor inputs. The signal preprocessor 816 may receive data such as radio frequency amplitude, temperature readings, or near-infrared absorption spectra, ensuring these readings are aligned and normalized before advanced feature extraction routines are applied. In many aspects, the signal preprocessor 816 may store partial or intermediate results in local memory, enabling quick lookups or repeated operations if multiple down-line modules require synchronized data. The signal preprocessor 816 may also optionally remove out-of-band frequencies or enhance edges in an image sensor feed.

In several aspects, a feature extractor 818 may follow the signal preprocessor 816, receiving refined data sets for more specialized analysis. For example, the feature extractor 818 may identify subtle morphological features in images that indicate micro-cracks or foreign materials within a pharmaceutical product. In other scenarios, the feature extractor 818 may compute electromagnetic phase shifts that may hint at moisture content or dielectric changes. If a Raman spectroscopy sensor is integrated with system 812, the feature extractor 818 may parse real-time Raman data to detect molecular vibrations indicative of product composition or contaminants. By combining or tagging these extracted features with standard references—for example, a known library of target spectral peaks—the feature extractor 818 may enable subsequent classification to occur swiftly and accurately.

In some aspects, a fusion module 820 may receive multiple features from the feature extractor 818 and integrate them into an aggregate signature for each scanned product. This fusion module 820 may implement an ensemble-based approach, merging data from multiple sensors or algorithms. For example, one subset of sensors may focus on temperature or moisture, while another subset may concentrate on electromagnetic or near-infrared signals. The fusion module 820 may be realized in software or hardware and may rely on known machine-learning frameworks, possibly layering decision trees, support vector machines, or neural networks on top of one another to combine classifier outputs. The fusion module 820 may also incorporate modular or persistent data structures, enabling reusability of certain parameter sets across multiple batch runs. In many aspects, if the fused models reveal that certain signals exceed a threshold, the system 812 may proceed to issue warnings or rejections accordingly.

In several aspects, a threshold module 822 may reference permissible ranges for variables such as dielectric property, spectral peak magnitude, or temperature deviation. The threshold module 822 may retrieve these ranges from stored tables in memory, or from a dynamically loaded library that references ongoing historical results. If the threshold module 822 detects that a measured parameter, such as moisture content or electromagnetic reflection, falls outside an acceptable range, the system 812 may classify the product as non-compliant. The threshold module 822 may optionally incorporate logic for auto-updates, gradually refining thresholds once certain patterns of deviation persist in multiple production cycles. Such dynamic updates may ensure that the system 812 remains robust even when environmental conditions or product formulations vary.

In other aspects, the inline pharmaceutical QC system 812 may also contain a quality parameter database 824, used for storing a wide range of calibration or operational data. The quality parameter database 824 may hold baseline values for uniformity, mix ratio, or dielectric constants associated with each product type. It may also record permissible tolerance ranges that define, for example, how much the temperature reading may fluctuate before the system marks a product for inline corrective actions. In many aspects, the quality parameter database 824 may store instructions that specify recalibration intervals or self-check triggers for sensors that might drift over time. As the system accumulates classification results, it may deposit them into the database 824. The system may then rely on these accumulated records to refine the classification model further if repeated anomalies appear.

In some implementations, the quality parameter database 824 may retain historical sensor data 826, which may be used for retrospective analyses, model retraining, or root-cause investigations. If an entire batch demonstrates a consistent but minor deviation in measured dielectric properties, the classification engine 814 may retrieve data from historical sensor data 826, note that the measured shift is correlated with a known benign factor, and potentially update the threshold module 822 to reduce false alarms. This feedback loop may evolve the system 812 over time, refining classification accuracy through historical classification outcomes.

In some aspects, a classification and alert module 828 may also be included within the inline pharmaceutical QC system 812. This classification and alert module 828 may receive results from the fusion module 820 and the threshold module 822, generating final pass/fail or compliance/non-compliance verdicts for each pharmaceutical item. If the classification and alert module 828 finds that a product is non-compliant, it may trigger an inline corrective action, such as adjusting a process temperature or initiating a mechanical diverter or pneumatic ejector to physically remove the product from the line. The classification and alert module 828 may also log repeated non-compliance occurrences. In many aspects, if the frequency of anomalies surpasses a certain threshold, the operator console 808 may receive an immediate electronic alert, prompting humans to investigate potential contamination issues, sensor malfunctions, or other production line disruptions.

In other aspects, the inline pharmaceutical QC system 812 may handle real-time production requests 830, allowing external systems or operators to request certain scanning modes, retrieve newly extracted features, or generate specialized analytical scores. For example, the system may respond to a request to run an extra pass of near-infrared scanning if a batch is particularly moisture-sensitive. The real-time production requests 830 may also interact with additional sub-modules that orchestrate the scanning sequence or gather combined sensor data. By dynamically scheduling these tasks, the system 812 may handle high throughput or large volumes of pharmaceutical items without experiencing bottlenecks.

In several aspects, the real-time production requests 830 may include a request sensor feature extraction 832 step that prompts the feature extraction and classification engine 814 to capture data from the plurality of sensors, each positioned to measure distinct aspects of a product. For example, an operator might request a more detailed spectral analysis for a high-value, specialized compound. The request sensor feature extraction 832 command may cause the signal preprocessor 816 to run additional smoothing algorithms or calibrate the sensors more frequently. These newly extracted features may then be fed into the fusion module 820 to generate an updated, comprehensive signature for the product under scrutiny.

In certain aspects, the real-time production requests 830 may incorporate a scoring module 834, which may produce a confidence score or multi-dimensional evaluation metric for each classification. The scoring module 834 may weigh separate sensor categories (e.g., temperature data, electromagnetic data, or near-infrared absorption) and produce an overall compliance probability. If the system finds that the confidence score is below a predefined threshold, operator console 808 may be notified, prompting additional checks or a secondary validation process. In this manner, the system provides confidence score computation and re-verification if the confidence is insufficiently high. The scoring module 834 may also invoke a re-scan using a different sensor arrangement or rely on stored baseline references to confirm whether borderline products indeed violate any critical quality attributes.

In many aspects, the operator console 808 may serve as a user interface for the entire system 800, letting operators inspect logs, classification outcomes, or partial sensor feeds. If repeated issues appear, the console may highlight them, possibly referencing repeated foreign particle detections or persistent temperature deviations. Should a shift in electromagnetic readings recur often, the system 812 may send a proactive alert, encouraging maintenance or sensor recalibration. Because the inline pharmaceutical QC system 812 includes the feature extraction and classification engine 814 along with modules for threshold checks, classification, and alert dissemination, an operator may quickly isolate the production stage that is contributing to the anomalies.

In some implementations, the inline pharmaceutical QC system 812 may link to external or cloud-based computing platforms through the network/cloud 855 for advanced analytics. The system 812 may upload logs from the quality parameter database 824, enabling big-data analysis or model retraining in a remote environment. This synergy promotes ongoing improvements in classification accuracy, and provides that the system may refine or retrain its computational model in response to historical classification outcomes. If additional sensor data is integrated (for example, a newly installed Raman spectroscopy sensor), the system 812 may incorporate the new stream into the feature extractor 818, expanding the coverage of molecular vibrations or compositional changes that might occur in certain types of pharmaceutical tablets or liquid-filled capsules.

In various aspects, the inline pharmaceutical QC system 812 may also incorporate a handheld extension as part of the real-time production requests 830, so an operator may physically scan localized points, feeding those data streams into the signal preprocessor 816 and subsequently the fusion module 820. If a calibration offset is detected due to an environment's humidity shift, the threshold module 822 may automatically adjust moisture-based or dielectric-based thresholds, thus preserving consistent classification outcomes. Any discovered anomalies may be flagged by classification and alert module 828, ensuring that the system's reaction is swift enough to remove or correct product issues in near real time.

In many aspects, the synergy of the signal preprocessor 816, the feature extractor 818, the fusion module 820, and the threshold module 822 within the feature extraction and classification engine 814 may allow the inline pharmaceutical QC system 812 to implement robust ensemble classification. By referencing the quality parameter database 824 and retrieving historical sensor data 826, the system 812 may handle dynamic production conditions, adjusting model thresholds or local scanning processes with minimal downtime. If repeated anomalies arise, the classification and alert module 828 may target potentially out-of-spec raw materials or faulty lines. The operator console 808 may then present real-time feedback or direct the system to re-scan items in question, instruct the user to alter a mixing ratio, or even revert to saved baseline values in the threshold module 822.

In certain aspects, the inline pharmaceutical QC system 812 may be implemented as a set of containerized microservices or modular hardware components, ensuring high availability. The operator console 808 may be located physically on-site or connected remotely through the network/cloud 855, managing multiple manufacturing lines simultaneously. By exchanging near real-time sensor readings, classification results, and updated thresholds, the system 812 may maintain all essential steps, including receiving sensor data, extracting relevant features, generating aggregated signatures, and initiating any necessary inline corrective or rejection response. If an anomaly triggers repeated non-compliances exceeding a predetermined frequency, the classification and alert module 828 may escalate the event to a higher-level control interface, providing capabilities for transmitting notifications in response to persistent failures.

In other aspects, each module in system 800 may seamlessly integrate to handle a broad range of measured parameters. The signal preprocessor 816 may incorporate optional expansions for advanced noise filtering, while the feature extractor 818 might parse Raman diffusion profiles or near-infrared absorption peaks. The fusion module 820 may unify partial classifications into a single pass/fail metric or produce an additional confidence interval. The threshold module 822 may consult the historical sensor data 826 stored in the quality parameter database 824, verifying that the current environment or batch meets established compliance standards. Simultaneously, real-time production requests 830, including request sensor feature extraction 832 and the scoring module 834, may coordinate an immediate or repeated check for borderline items.

In several aspects, the classification and alert module 828 may finalize the compliance decision, referencing results from the threshold module 822 and issuing an electronic alert if the aggregator or ensemble indicates a discrepancy between measured properties and expected baseline values. If the discrepancy is severe, a mechanical diverter or pneumatic ejector may be engaged to prevent the item from moving on, providing covering an inline classification approach that provides immediate feedback. Ultimately, FIG. 8 depicts how the operator console 808, the inline pharmaceutical QC system 812, and the network/cloud 855 cooperate to ensure that every product on a high-speed manufacturing line is evaluated for key quality parameters, enabling fast, data-driven corrective actions whenever anomalies are detected.

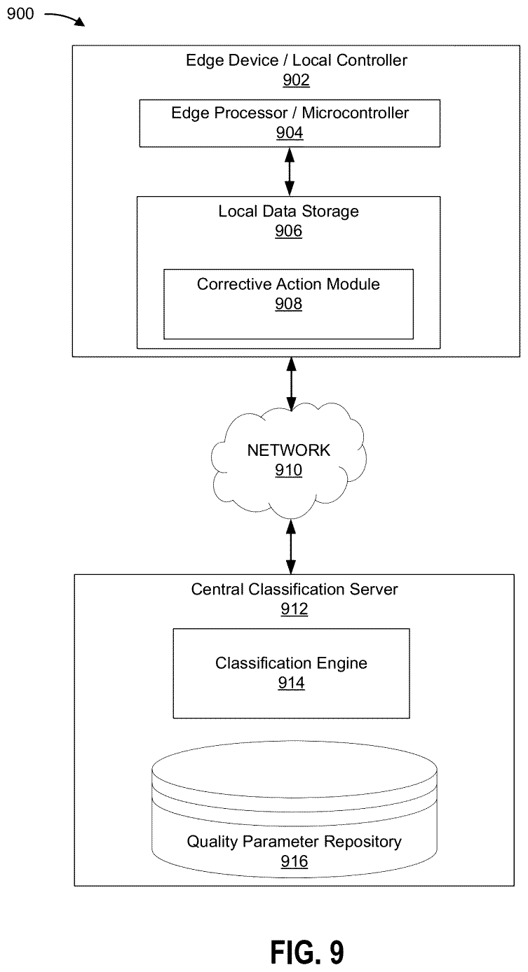

FIG. 9 illustrates a distributed classification framework for real-time product inspection and classification, according to various examples.

In some aspects, FIG. 9 may illustrate a portion of a system 900 that may enable inline analysis and classification of pharmaceutical products based on predefined quality parameters using artificial intelligence. In various aspects, the system 900 may include an edge device/local controller 902, which may coordinate real-time interactions with a plurality of sensors arranged along a production path. These sensors may include at least a radio frequency antenna, a temperature sensor, and an image sensor, each configured to obtain data reflecting one or more of electromagnetic properties, molecular composition, moisture content, presence of foreign particles, or structural integrity of pharmaceutical items. In certain aspects, the edge device/local controller 902 may be physically located proximate to the production line, permitting quick or low-latency responses when anomalies are detected.

In many aspects, the edge device/local controller 902 may incorporate an edge processor/microcontroller 904, which may manage incoming real-time signals from the various sensors. The edge processor/microcontroller 904 may store and execute computer-executable instructions, such as routines for performing partial feature extraction, data filtering, or local threshold checks. In some aspects, the edge processor/microcontroller 904 may rely on specialized hardware acceleration components, like digital signal processors or low-power neural network inference chips, so that partial classification or basic anomaly detection may be performed on-site. This arrangement may reduce round-trip latency, particularly if production lines run at high speed. In certain aspects, the edge processor/microcontroller 904 may respond when sensor readings indicate that a measured moisture level or temperature deviates from an acceptable range, potentially logging an alert or triggering an immediate corrective step.

In several aspects, the edge device/local controller 902 may include a local data storage 906, which may keep sensor readings, short-term logs, calibration files, or partial inferences to be forwarded upstream. The local data storage 906 may also hold one or more sets of threshold values that have been retrieved from a central classification server, enabling the local controller to evaluate products in near real-time. If historical production data suggests a shift in product composition, the system may dynamically update the threshold files stored in 906, providing updates to at least one parameter based on prior classification outcomes. In some aspects, the local data storage 906 may also contain a library of possible triggers for inline corrective actions, so that the system may quickly dispatch instructions if it detects a nondestructive test that signals a foreign particle or a mismatch in dielectric properties.

In some aspects, the edge device/local controller 902 may further include a corrective action module 908, which may manage direct inline interventions on the production line. The corrective action module 908 may command a mechanical diverter, a pneumatic ejector, or a conveyor speed adjuster to respond swiftly when the edge processor/microcontroller 904 or a remote classification engine flags a product as non-compliant. In certain aspects, the corrective action module 908 may coordinate with other actuator hardware, including environmental controllers that modify temperature or humidity around the production area. If repeated anomalies arise, the corrective action module 908 may escalate a maintenance alarm or log an event indicating that an entire batch might need re-inspection. In many aspects, the corrective action module 908 may also link with a handheld extension, enabling local modifications when handheld scans reveal localized sensor data that diverges from normal ranges.

In various aspects, the system 900 may also include a network 910, permitting data transfer between the edge device/local controller 902 and a central classification server 912. The network 910 may be implemented using wired Ethernet connections, wireless LAN, or wide-area protocols. In some aspects, the network 910 may incorporate encryption or authentication to ensure that sensor data and control commands remain secure. By transmitting sensor data in real time to the central classification server 912, the system supports a more advanced classification approach, as the server may run ensemble-based machine learning algorithms that rely on multiple feature extraction pipelines. In some implementations, the network 910 may handle high-bandwidth image streams from the image sensor, or it may carry smaller data packets capturing temperature, electromagnetic, or NIR absorption readings.

In certain aspects, the central classification server 912 may store a memory of computer-executable instructions and may house additional processors configured to evaluate or re-evaluate the data received from the edge device/local controller 902. The server 912 may host more computationally intensive software frameworks, for example, advanced neural networks or decision-tree ensembles. Depending on the use case, the central service may parse real-time Raman spectral data or handle partial data from the edge device. In many aspects, the central classification server 912 may be physically located at a remote data center or a cloud-based infrastructure, but it may still operate within sufficient time constraints for inline classification. If the classification server 912 identifies anomalies, it may issue instructions that cause the edge device/local controller 902 to initiate or modify an inline corrective action in near real time.

In several aspects, the central classification server 912 may contain a classification engine 914, which may unify signals from multiple sensor types, applying feature-level fusion leveraging a combination of dielectric properties, electromagnetic properties, NIR absorption spectra, or molecular signatures. The classification engine 914 may rely on machine learning techniques to compute a confidence score for each classified product. If the confidence score is below a threshold, the classification engine 914 may request additional sensor scans or it may trigger a re-evaluation routine. In some aspects, the classification engine 914 may be configured to incorporate training modules that adapt model parameters over time. For example, if historical classification outcomes reveal a gradual shift in the average dielectric property, the classification engine 914 may prompt the system to adjust relevant thresholds to reduce false positives or false negatives.

In other aspects, the system 900 may incorporate a quality parameter repository 916 within or alongside the central classification server 912, which may store permissible ranges for physical state, volume, moisture content, mix ratios, or uniformity. The quality parameter repository 916 may also keep references to known spectral peaks or known temperature ranges for each pharmaceutical product line. If new product batches or new sensor arrays are introduced, the repository 916 may be updated to reflect the appropriate nominal values. In many aspects, the classification engine 914 may regularly consult entries in the quality parameter repository 916 to decide whether a measured sensor reading indicates compliance or non-compliance. If repeated foreign particles are detected or if measured moisture levels exceed a threshold, the classification engine 914 may label the product as non-compliant and instruct the edge device/local controller 902 to initiate a rejection signal.

In some implementations, the quality parameter repository 916 may hold historical calibration data or multiple sets of thresholds that differ by time of day or production conditions. The classification engine 914 may then selectively reference those thresholds, aligning with dynamic updating of parameters in response to historical classification outcomes. If the server 912 detects that a portion of the sensor array has drifted, it may push new parameter sets or calibration files to the local data storage 906, ensuring that subsequent classification steps remain accurate. The repository 916 may also log user-specified tolerance changes or environment-based triggers, such as a temperature reading outside a predefined range. This integrated design helps unify locally computed signals with centrally managed classification logic.

In many aspects, the system 900 may operate by first capturing sensor data at the edge device/local controller 902, where the edge processor/microcontroller 904 may run partial checks or minimal transformations on the data. The local data storage 906 may buffer or store these readings, so if the network 910 is temporarily congested, the system may preserve sensor logs for subsequent classification. Meanwhile, the central classification server 912 may continuously receive or periodically poll for aggregated signals, passing them to the classification engine 914 for feature extraction, threshold checks, and final pass/fail labeling. If the classification engine 914 identifies a mismatch with the quality parameter repository 916—such as a discovered foreign particle or an electromagnetic property not matching normal baselines—the server 912 may return an instruction to the local controller 902. In some aspects, the corrective action module 908 then immediately instructs a mechanical system to remove that particular product from the line, in substantially real time.

In certain aspects, the system 900 may incorporate the presence of a handheld extension for localized scanning or a Raman spectroscopy sensor for real-time detection of molecular vibrations. The edge processor/microcontroller 904 may handle partial data from the handheld device, merging it with inline sensor measurements. If repeated anomalies accumulate above a predetermined frequency, an alert mechanism at the server level may automatically dispatch electronic notifications to an operator console. In some implementations, the local data storage 906 may also create a file logging each anomaly, referencing the known triggers from the quality parameter repository 916 to explain the cause or recommend a corrective process step.

In various aspects, the system 900 may rely on communication protocols across the network 910 that ensure minimal latency. The classification engine 914 may then map each sensor reading to a confidence score using ensemble-based methods, combining decision tree outputs, support vector machine predictions, and potentially neural network probabilities. If the confidence score remains borderline, the server may instruct the local device to gather additional sensor readings or request a deeper spectral analysis. By selectively merging local computations performed by the edge processor/microcontroller 904 with the more comprehensive classification logic at the central classification server 912, the system may achieve efficient load balancing. This approach helps ensure near real-time classification without overloading the central server or ignoring the potential for local autonomy at the edge device.

In some aspects, the system 900 may handle updates to quality parameters if historical data, stored at the classification engine 914 or within the quality parameter repository 916, suggests a shift in the manufacturing environment. If, for example, the average moisture content for a certain batch runs slightly higher than normal, the classification engine 914 may interpret these values differently, to avoid unnecessary rejections. The server 912 may then push revised parameter sets or threshold levels to the local data storage 906, so that subsequent classification decisions become more adjusted to the evolving process conditions. If a sensor drifts beyond an acceptable operational tolerance range, the system may automatically log a maintenance alert, possibly instructing the user to recalibrate or replace that sensor. This entire pipeline ensures the system may detect or correct non-compliant products in a timely manner.

In many aspects, the arrangement shown in FIG. 9 may be modular. The edge device/local controller 902 may be physically integrated into a production machine or it may be a standalone box that encloses the edge processor/microcontroller 904, local data storage 906, and the corrective action module 908. The network 910 may be a local manufacturing site network or a secure cloud connection spanning multiple factories. The central classification server 912 may be an on-premises server farm or a remote cloud instance capable of large-scale data analytics. The classification engine 914 may be reprogrammed through software updates, and the quality parameter repository 916 may grow or change as new product lines or additional sensor types are introduced. This flexibility covers potential future expansions, such as integrating NIR sensors or advanced temperature imaging arrays and otherwise incorporate multiple sensor data inputs beyond the minimal set.

In several aspects, the system 900 may exemplify the general requirement of real-time or near real-time classification. Products may be scanned individually as they traverse the production path, generating electromagnetic signals, temperature readings, or optical images. The edge device/local controller 902 may pre-process or store these signals locally, while the network 910 ensures swift data transfer to the central classification server 912. The classification engine 914 references the quality parameter repository 916 to confirm whether each product remains within acceptable bounds for physical state, volume, mix ratio, uniformity, contaminants, dielectric constants, or moisture content. When a discrepancy emerges, the edge device's corrective action module 908 may promptly divert the item, adjusting the production line's speed or temperature if needed. By referencing optional feedback loops that incorporate repeated classification results, the system may refine thresholds or re-train machine learning models stored on the classification server. This synergy among local and remote intelligence ensures robust in-process quality control for pharmaceutical manufacturing lines that demand high accuracy and minimal downtime.

In certain aspects, if the confidence score from the classification engine 914 is too low, the system may open a secondary validation process, prompting an operator or a specialized sensor to re-check the product. This step may prevent unnecessary discards, especially if the data is borderline or if the product is high-value. Meanwhile, the local data storage 906 may keep a persistent log for every product passing by, so historical analyses on the central server may reveal trends or emerging anomalies. If repeated foreign particle detections occur, the classification engine 914 may push an alert to the local device or to maintenance staff, providing an alert mechanism for repeated non-compliance. Because each subcomponent is described by function, an artisan may replicate or customize these modules in hardware, software, or a hybrid arrangement, supporting additional production lines, new sensor types, or different classification approaches.

In many aspects, system 900 may seamlessly expand to handle advanced tasks such as storing newly labeled data in the local data storage 906 or the quality parameter repository 916. The classification engine 914 may then incorporate these datasets into training modules that refine neural network weights, threshold lookups, or ensemble rules. This iterative approach provides dynamic updating of the system's computational model, ensuring classification accuracy remains high as manufacturing or environmental conditions shift. Adjusting a manufacturing process parameter may be done based on the classification output of the computational model, and may include automatically modifying at least one control signal to upstream processing equipment to compensate for a detected production drift. If the server's processor indicates that certain sensor data remains inconsistent with known baselines, it may instruct the local device's corrective action module 908 to systematically slow the conveyor or alter the process temperature to restore compliance. As a result, the system may continuously integrate real-time feedback, enabling near-instantaneous corrections that sustain product quality and compliance with regulatory needs.

In other aspects, the arrangement in FIG. 9 acknowledges local autonomy, which enables the edge processor/microcontroller 904 to handle urgent tasks even if the network 910 encounters a brief outage. The local data storage 906 may buffer newly acquired time-stamped measurements until communication is restored, limiting data loss. Meanwhile, the corrective action module 908 may still respond to critical triggers that the local device has been pre-programmed to handle. Once the network is back online, the central classification server 912 and the classification engine 914 may process the accumulated data in batch mode, referencing updated thresholds from the quality parameter repository 916. This robust design maintains continuous in-process quality control, bridging minor disruptions that might otherwise hamper consistent classification performance. In some cases, chemical pellets, mineral ore fragments, pharmaceutical dosage forms, food portions, food products or agricultural products may be classified in similar ways and for similar purposes by the disclosed technologies herein.

In several aspects, FIG. 9's architecture provides a flexible blueprint that may be implemented across different technology stacks, from embedded microcontrollers to scalable cloud-based data centers. The local device might run a real-time operating system, while the central classification server might run containerized applications on a high-performance cluster. The classification engine 914 may incorporate framework libraries like TensorFlow, PyTorch, or scikit-learn, and the quality parameter repository 916 may be hosted in a SQL database or NoSQL store. Regardless of implementation details, the relationships remain: sensors feed data to the edge, which relays partial or raw signals to a remote classification pipeline that references stored thresholds and triggers inline corrective or rejection signals as needed. This approach provides assurance that each product's electromagnetic property, moisture content, or foreign particle presence is measured in real time, classified, and either accepted or ejected from the production line with minimal delay.

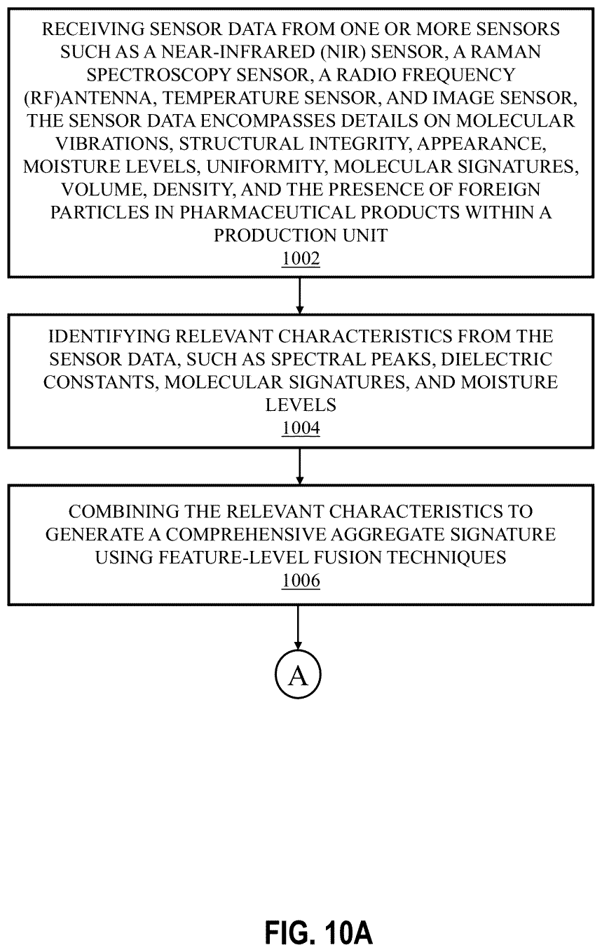

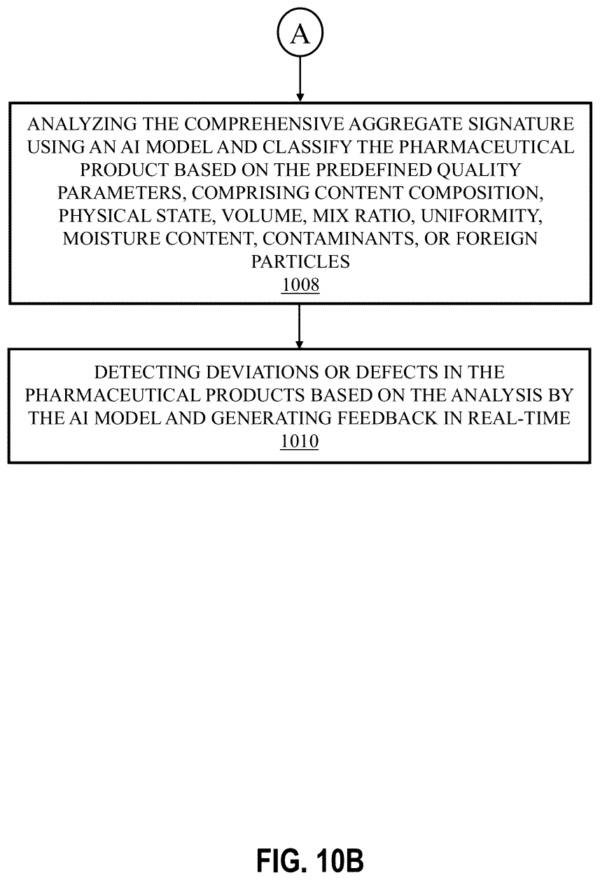

FIG. 10A-B are flow diagrams that illustrate a method for analyzing and classifying pharmaceutical products based on predefined quality parameters using artificial intelligence according to various embodiments.

The method includes, at step 1002, receiving sensor data from one or more sensors, such as a near-infrared (NIR) sensor, Raman spectroscopy sensor, radio frequency (RF) antenna, temperature sensor, and image sensor. This data encompasses details on molecular vibrations, structural integrity, appearance, moisture levels, uniformity, molecular signatures, volume, density, and the presence of foreign particles in pharmaceutical products within a production unit.

The method includes at step 1004, identifying relevant characteristics from the sensor data such as spectral peaks, dielectric constants, molecular signatures, and moisture levels.

The method includes at step 1006, combining the relevant characteristics to generate a comprehensive aggregate signature using feature-level fusion techniques.

The method includes at step 1008, analyzing the comprehensive aggregate signature using an AI model and classify the pharmaceutical product based on the predefined quality parameters, comprising content composition, physical state, volume, mix ratio, uniformity, moisture content, contaminants, or foreign particles.

The method includes at step 1010, detecting deviations or defects in the pharmaceutical products based on the analysis by the AI model and generating feedback in real-time.

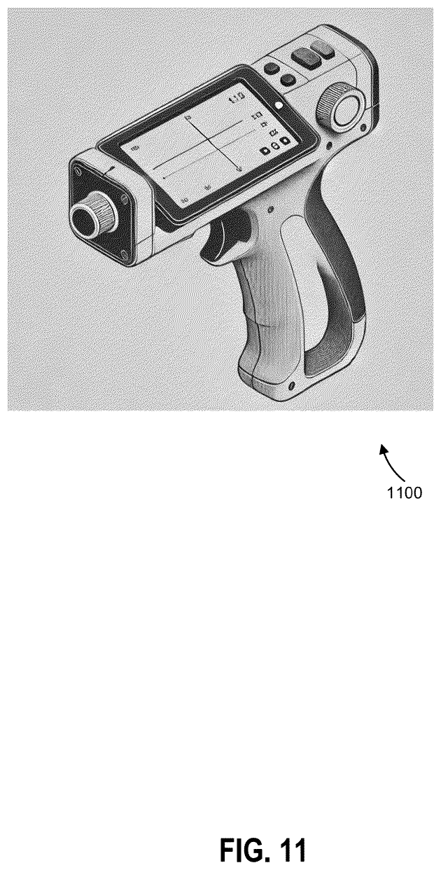

FIG. 11 illustrates a portable device for analyzing and classifying pharmaceutical products based on predefined quality parameters using artificial intelligence, as further supported by the system architecture shown in FIG. 5 according to various embodiments. The portable device 1100 allows manufacturers to conduct in-process quality checks in real time, even while products are being processed. The portable device enables direct analysis of products for deviations from predefined quality parameters, such as improper moisture content or the presence of foreign particles. With immediate feedback delivered to operators, the system empowers rapid corrective actions, supporting continuous quality control without interrupting the production process. This flexibility makes it ideal for dynamic production environments, allowing for convenient and efficient quality assessment across various stages of manufacturing.

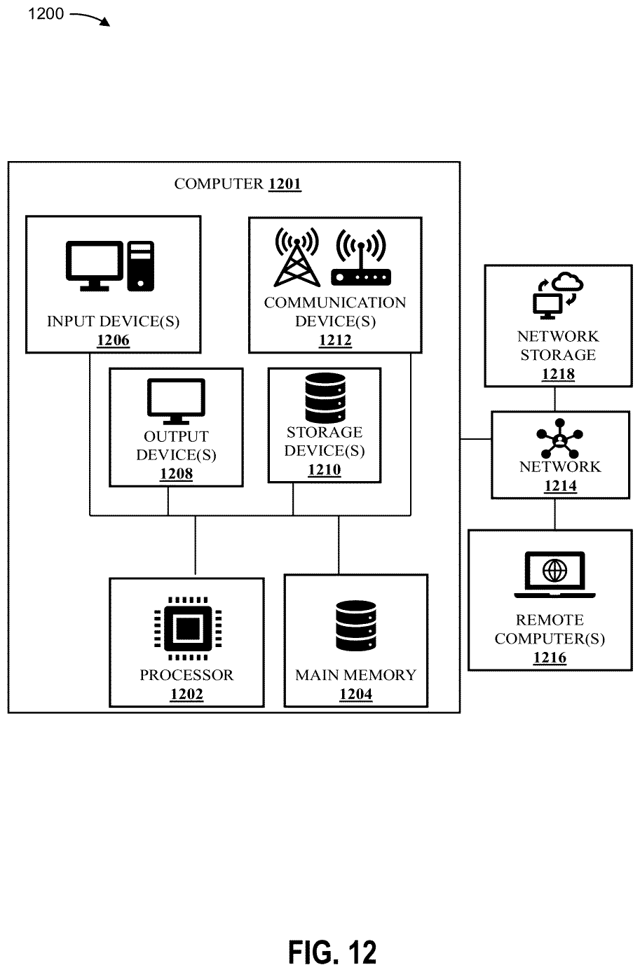

FIG. 12 illustrates a general computer architecture that may be appropriately configured to implement components disclosed in accordance with various embodiments.

The general computing architecture 1200 may include various common computing elements, such as a computer 1201, a network 1214, and one or more remote computers 1216. The computer 1201 may be a server, a desktop computer, a laptop computer, a tablet computer or a mobile computing device. The computer 1201 may include a processor 1202, a main memory 1204 and a system bus. The processor 1202 may feature one or more processing units that may operate independently of each other. The main memory 1204 may include volatile devices, non-volatile devices, or other random access memory devices. The computer 1201 may feature secondary storage devices 1210, consisting of one or more removable and/or non-removable storage units. These units house an operating system that manages various applications on the computer 1201. The secondary storage devices 1210 may also be used to store software configured to implement the components of the embodiments disclosed herein, which may be executed as one or more applications under the operating system. The computer 1201 may also include a communication device(s) 1212 through which the computer communicates with other devices, such as one or more remote computers 1216, over wired and/or wireless computer networks 1214. The communication device(s) 1212 may communicate over but not limited to Wi-Fi, Bluetooth, ultra-wide band technology, and mobile telephone networks. The computer 1201 may also access network storage 1218 through computer network 1214. The network storage 1218 may include a network-attached storage device or cloud-based storage. The operating system and/or software may be stored in network storage 1218. The computer 1201 may have various input device(s) 1206 for example, keyboard, mouse, touchscreen, camera, microphone, or a sensor, output device(s) 1208, for example, a display, speakers or a printer. Storage devices 1210, the communication device(s) 1212, input devices 1206 and output devices 1208 may be integrated within a computer system or connected through various computer input/output interface devices.

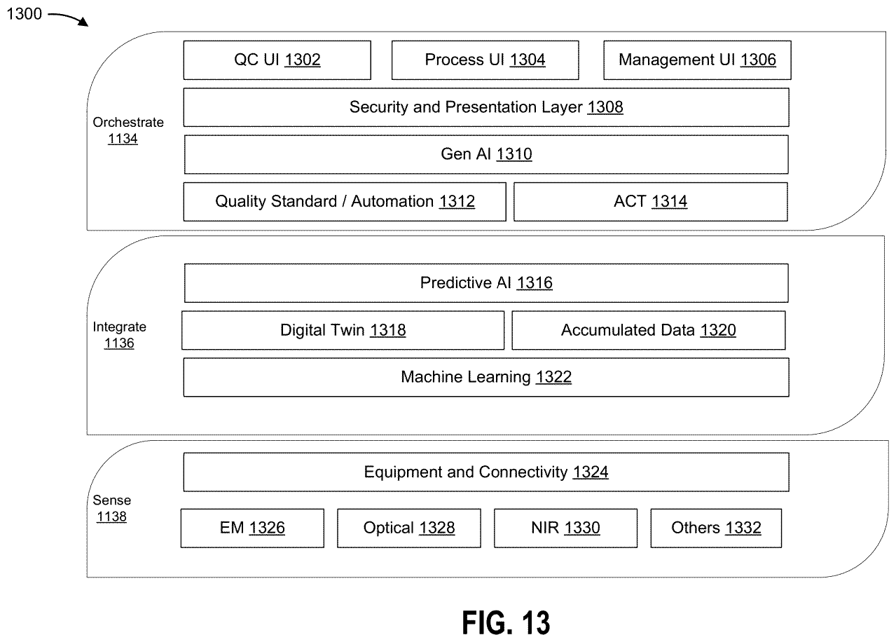

FIG. 13 illustrates a layered orchestration and presentation architecture for coordinating multi-sensor data, AI-based analysis, and user interfaces across one or more processing layers, according to various examples.

In some aspects, FIG. 13 may illustrate a portion of a system 1300 that may provide an architectural framework for inline analysis and classification of pharmaceutical products using artificial intelligence and predefined quality parameters. In various aspects, the system 1300 may include three conceptual layers—an Orchestrate layer 1134, an Integrate layer 1136, and a Sense layer 1138—each containing various components that interrelate to ensure that a plurality of sensors, a server, and one or more processors may collectively detect, classify, and, if appropriate, reject non-compliant pharmaceutical products in real time.

In many aspects, the Sense layer 1138 may include equipment and connectivity 1324, which may represent the physical infrastructure associated with an inline production environment. The equipment and connectivity 1324 may include one or more conveyor belts or product feeders, a local or remote input/output interface, and a communication backbone that may facilitate data exchanges with a server. In several aspects, the equipment and connectivity 1324 may be designed to interface with sensors collecting real-time data indicative of electromagnetic properties, molecular composition, moisture content, foreign particles, or structural integrity. For example, a radio frequency antenna situated along the production path may measure electromagnetic signals that reveal dielectric constants, while an image sensor may capture visual anomalies, and a temperature sensor might determine whether a product's surface temperature exceeds permissible ranges.

In some implementations, the Sense layer 1138 may further contain sensor modules labeled as EM 1326, Optical 1328, NIR 1330, and Others 1332. The EM 1326 component may refer to electromagnetic scans that capture radio frequency signals or microwaves, which might be used to spot foreign particles, measure moisture content, or check structural consistency. The optical 1328 sensor may represent image-based systems, whether standard cameras or advanced multi-spectral imagers that detect visible or near-visible phenomena. The NIR 1330 sensor may be specifically designed to capture near-infrared absorption spectrums that often correlate with molecular composition—helpful for verifying mix ratio or uniformity. The Others 1332 sensor category may accommodate additional devices such as Raman spectroscopy sensors or advanced acoustic sensors. In certain aspects, each sensor may include an auto-calibration routine triggered by a self-check prompt, consistent with the idea that the system may detect sensor drift and alert an operator if a sensor begins operating outside acceptable tolerances.

In various aspects, the Integrate layer 1136 may be responsible for collating or consolidating signals coming from the Sense layer 1138, then applying advanced analytics or AI-driven logic. Within the Integrate layer 1136, a predictive AI 1316 module may process sensor data streams to anticipate possible fluctuations in dielectric properties or moisture content before they manifest as product defects. The predictive AI 1316 module may rely on pattern recognition models that factor in historical classification outcomes, thereby refining classification accuracy as the system processes more items over time. In some aspects, if data indicates a discrepancy between expected and measured electromagnetic or near-infrared absorption properties, the predictive AI 1316 module may issue an advisory or direct an inline corrective action.

In other aspects, a digital twin 1318 may reside within the Integrate layer 1136, allowing the system 1300 to simulate ideal or nominal conditions for the pharmaceutical products. The digital twin 1318 may draw on known standard reference data for product shape, density, temperature tolerance, or chemical composition, enabling the system to compare real-time sensor readings against the simulated baseline. If the system detects a substantial deviation, a re-check process may be triggered or a potential rejection signal may be primed. For example, if the digital twin 1318 expects a certain NIR signature for a well-mixed dose form and the actual reading from NIR 1330 in the Sense layer reveals a mismatch, the system may consider that product suspect. In many aspects, the digital twin 1318 module may operate in tandem with the predictive AI 1316 module to forecast potential mechanical or environmental issues that might impact future batches.

In some implementations, an accumulated data 1320 repository within the Integrate layer 1136 may store raw and processed sensor outputs, logging temperature differentials, spectral peaks, or identified foreign particles. The accumulated data 1320 may be used to train or retrain machine learning models, providing dynamic updates to a computational model in response to historical classification outcomes. If repeated anomalies surface above a certain frequency, the system may revise relevant threshold parameters. For example, if an entire run of tablets consistently registers higher moisture content than anticipated, the system may tune baseline values so that these slightly moister products are still accepted if they remain within an expanded permissible range. In other aspects, the system may identify external drifts, such as a sensor baseline shifting due to environmental humidity, and incorporate that information before finalizing classification results.

In several aspects, the Integrate layer 1136 may further include a machine learning 1322 component, which may provide an ensemble-based approach to feature-level fusion. One sub-model may focus on electromagnetic reflectometry for detecting foreign particles, another might rely on near-infrared absorption data to confirm molecular composition, and yet another might use advanced image recognition for surface integrity checks. The machine learning 1322 component may unify these partial inferences into a single classification label indicating compliance or non-compliance. If the confidence score remains low, the system may trigger a secondary validation process. In many aspects, the machine learning 1322 module may be modular and persistent, storing partial states or training metrics in an external memory. This design encourages dynamic or continuous retraining on newly labeled data, enabling the system to adapt its classification logic to new conditions or product formulations.

In certain aspects, the Orchestrate layer 1134 may function as the top-level process manager, coordinating user interfaces, security protocols, generative AI modules, and automated regulatory checks. Within the Orchestrate layer 1134, a QC UI 1302 (Quality Control User Interface) may provide operators with real-time dashboards or historical scans, highlighting whether a product is passing or failing inline checks. A process UI 1304 may allow production floor personnel to adjust conveyor speeds, environment temperatures, or other parameters relevant to inline corrective actions. A management UI 1306 may offer an administrative overview, enabling higher-level audits, advanced reporting, or compliance checks with regulatory guidelines. In some aspects, these UIs may rely on standard markup languages or specialized industrial communication protocols, ensuring broad compatibility with factory automation software.

In many aspects, the Orchestrate layer 1134 may also have a security and presentation layer 1308, which may manage operator authentication, data encryption, or roles-based access to system features. This arrangement helps ensure that only authorized individuals may alter threshold settings or generation of product classification logs. If the system identifies repeated product failures above a certain frequency, the security and presentation layer 1308 may generate an automated ticket or an operator console alert, which provides an alert mechanism for repeated non-compliant classifications. In other aspects, the system may record these alerts in an immutable ledger for regulatory compliance, meeting potential future requirements for chain-of-custody or traceability.

In some aspects, a Gen AI 1310 module may reside in the Orchestrate layer 1134, which may employ large language models or generative models to analyze textual data logs, maintenance instructions, or even operator chat dialogues. The Gen AI 1310 module may interpret sensor anomalies in the context of historical maintenance records, suggesting likely root causes or preemptive corrective steps. In various uses, the Gen AI 1310 may parse operator feedback and automatically tune or merge new threshold data with the input from the digital twin 1318 in the Integrate layer. By bridging advanced text-based or knowledge-based analyses with real-time sensor data, the system may accelerate resolution of emergent quality issues.

In several aspects, the Orchestrate layer 1134 may also contain a quality standard/automation 1312 module, which may store or reference a library of permissible ranges for each relevant sensor parameter, along with automated routines for adjusting process variables. For example, if an inline classification reveals temperatures are trending high, the system may automatically lower the mixing temperature or reduce production line speed to prevent continued out-of-spec products. The quality standard/automation 1312 module may integrate seamlessly with external manufacturing execution systems (MES) or supervisory control and data acquisition (SCADA) software, ensuring consistent data flow from sensors to top-level enterprise management. Via inline corrective actions triggered by a measured moisture level or foreign particle detection, the system's orchestration logic may promptly respond in near real-time.

In many aspects, an ACT 1314 component may represent the system's actionable output module in the Orchestrate layer 1134. The ACT 1314 module may physically drive mechanical diverters, pneumatic ejectors, or environmental controllers. If the classification logic from the machine learning 1322 or the digital twin 1318 indicates a non-compliant product, the ACT 1314 module may issue a rejection signal so that the item is ejected from the conveyor path. Alternatively, if the system sees that slight moisture adjustments may restore the product to compliance, the ACT 1314 module may modify humidity or mixing ratio automatically. In some implementations, ACT 1314 may store logs or maintain a cyclical buffer of action triggers, ensuring traceability for each product flagged or corrected.

In other aspects, the arrangement of Orchestrate layer 1134, Integrate layer 1136, and Sense layer 1138 in FIG. 13 may be deployed on physically separate hardware devices communicating over industrial Ethernet or a secure wireless protocol. For example, the Sense layer 1138 might be located on the factory floor, the Integrate layer 1136 might be a local server or an edge computing station, and the Orchestrate layer 1134 might be a cloud-based or enterprise-level platform. Alternatively, a single server might house all three logical layers, leveraged by a virtualization environment or container-based microservices. By partitioning these layers, the system 1300 may scale horizontally as production ramps up, or it may isolate critical real-time tasks in the Sense layer if the network experiences latency.

In certain aspects, advanced predictive analytics at the Predictive AI 1316 module might incorporate a training dataset derived from the Accumulated Data 1320. This training dataset may detail a wide array of sensor logs, including electromagnetic reflection patterns, NIR absorption shifts, or temperature distribution anomalies. The system may recast these data points into labeled examples, specifying which products tested as non-compliant for certain physical states, volumes, or contaminants. Over time, the machine learning 1322 module may produce updated classification boundaries that the threshold references in quality standard/automation 1312 incorporate. If these adjustments require human oversight, the QC UI 1302 or the management UI 1306 may highlight recommended changes for an operator to confirm. This flexible yet integrated approach ensures minimal downtime and maximum throughput, even when product formulations or environmental conditions evolve.

In many aspects, the system 1300 may be coded or configured using frameworks that favor modularity and persistency. The Orchestrate layer 1134 and the Integrate layer 1136 may rely on containerized or microservice-based architectures that store artifacts in distributed databases. The Sense layer 1138 may be physically robust, including real-time OS capabilities or hardware-level fail-safes. Because each portion of the system provides for receiving sensor data, extracting features, generating an aggregate signature, and performing an inline corrective action, the software stack may be implemented in Python, Java, or compiled C++ code, as well as specialized real-time languages for the sensor logic. If, for example, the system identifies a discrepancy between expected and measured dielectric properties, the Predictive AI 1316 may interpret that discrepancy as an indicator of a foreign particle or a suboptimal moisture level, prompting the ACT 1314 module to remove or segregate the product.

In certain aspects, the system 1300 may accommodate a handheld extension that merges localized sensor data with the aggregated data captured by the Sense layer 1138. The operator might connect this handheld device to the Orchestrate layer 1134, via the security and presentation layer 1308, which ensures the data merges with the integrated pipeline for classification or further analysis. If localized scanning spots severe anomalies in a batch of tablets, the machine learning 1322 module may recalibrate thresholds or cross-verify with the digital twin 1318 before finalizing a classification. Meanwhile, the system may store these newly observed anomalies in the accumulated data 1320 for further improvements. If repeated anomalies occur in a short window, the Gen AI 1310 module might provide diagnostic suggestions—“Check brand B filler supply” or the management UI 1306 might dispatch a site-wide alert mechanism for repeated non-compliance.

In other aspects, the system 1300 may handle user role management or security audits in the security and presentation layer 1308, ensuring that only certain personnel may override classification outputs or manually calibrate sensor arrays. If the system notes a persistent mismatch in near-infrared absorption data, it may suspect that the sensor has drifted or the environment changed. The user might be prompted by the management UI 1306 to run a structured calibration cycle. This interacts with the Predictive AI 1316 module, which might confirm that calibration is required, or with the digital twin 1318, which might indicate a systematic offset.

In several aspects, the structure and logic shown in FIG. 13 may also be extended to new sensor types or novel corrective actions. The Others 1332 sensor block in the Sense layer 1138 might house advanced spectrometers, micrometer scanning, or machine vision modules. The system might incorporate new features into the predictive AI 1316, analyzing whether an atypical spectral peak is a genuine contaminant or a benign variant. The generative AI 1310 might find references in prior manufacturing runs, linking them to known anomalies in the quality standard/automation 1312 database. Once the system identifies a strong correlation, the ACT 1314 might direct an immediate mechanical or digital response that modifies a mixing ratio. All these steps may occur in real time, providing an inline classification that prevents defective items from proceeding further.

In many aspects, the system 1300 may maintain adaptability and modularity, ensuring continuous compliance with evolving product definitions, sensor additions, or process expansions. As for the herein disclosed technical functions of receiving sensor data, performing feature extraction, generating an aggregate signature, and initiating inline corrective actions, the layered architecture in FIG. 13 underscores how these tasks may be distributed or combined among hardware and software modules. The Orchestrate layer 1134 acts as the user-and process-facing layer, the Integrate layer 1136 executes the data and intelligence layer, and the Sense layer 1138 provides the physical real-time sensor environment. This tri-layer design may scale across factories of different sizes or complexities, always delivering near real-time feedback to operators, along with robust data logs for training or re-training the system's classification models.

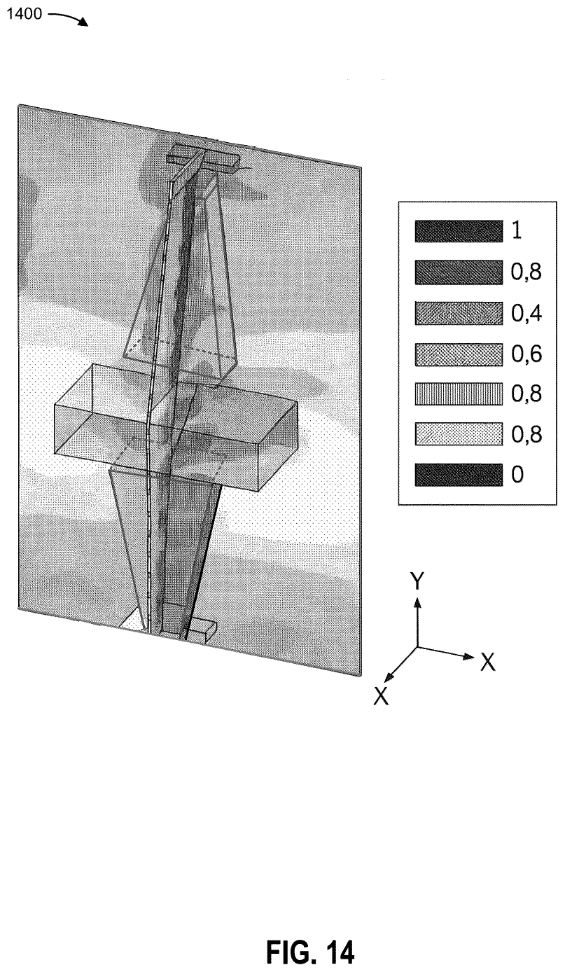

FIG. 14 illustrates an example of a model of organic or small-molecule material inspection, according to one or more examples.

In some aspects, FIG. 14 may illustrate a portion of a system 1400 that provides a three-dimensional view of how a pharmaceutical product, or a set of products, may exhibit varying electromagnetic or near-infrared absorption characteristics along different axes. This depiction may include a cross-like structure and multiple shaded regions, labeled in grayscale or numerical intensities (for example, 1, 0.8, 0.6, etc.), which may reflect parameter values such as moisture content, dimensional thickness, or dielectric constants in different subregions of the product. In many aspects, the system 1400 may draw upon data gathered from a plurality of sensors arranged along a production path, including at least a radio frequency antenna, a temperature sensor, and an image sensor, consistent with a mechanism for inline classification of pharmaceutical products using artificial intelligence and predefined quality parameters.

In certain aspects, the system 1400 may rely on at least one sensor that captures electromagnetic properties, for instance measuring reflections or transmissions at certain frequencies. This sensor data may characterize changes in the product's internal structure that manifest as variations in shading, as shown in the figure's region labeled “1, 0.8, 0.4, etc.” In one embodiment, each numeric label may represent an intensity level or amplitude of the captured signal. If the product has, for example, a higher moisture content in a particular region, the measured amplitude in that region may decrease or shift to a different numeric range. By contrast, if the product is uniform, or if the product exhibits consistent dielectric properties, the shading or numeric intensities may remain stable across the cross-section. In many aspects, the system 1400 may support immediate detection of anomalies, such as foreign objects or non-uniform compositions.

In several aspects, the system 1400 may incorporate a layered approach, in which a server having a memory storing computer-executable instructions receives sensor data from each region or subregion of the product as it traverses the production path. The system may perform feature extraction by identifying at least two or more of a dielectric property, an electromagnetic property, a temperature, or a spectral peak from near-infrared or Raman spectroscopy sensors. Each of these features may map onto a distinct numeric index or shading intensity, allowing an operator or automated algorithm to quickly see how interior or surface characteristics vary along the X, Y, and Z axes. If a region measured at the “1” level corresponds to an excessive temperature or unexpected molecular composition, the system might label that area as potentially non-compliant. Conversely, if regions at “0.8” show moisture fluctuations but remain within an acceptable tolerance, the system might pass those sections without triggering corrective measures.

In some implementations, the system 1400 may rely on an aggregate signature derived from these multi-sensor readings; the aggregated signature may unify electromagnetic amplitude, near-infrared absorption, or other signals from each subregion. For example, the cross-like structure might visually indicate how each sensor reading changes across different planes of the product. The system's one or more processors may execute instructions to generate a mapped dataset, correlating shading intensities with physical parameters such as volume, mix ratio, or uniformity. Once the system identifies that a certain region's numeric reading hovers outside permissible thresholds, it may consider that item non-compliant, initiating substantially real-time feedback to correct or reject the product. If certain subregions consistently deviate in resonance or moisture content, the system may further refine or update its classification thresholds, dynamically adjusting at least one parameter in response to historical classification outcomes.

In various aspects, the system 1400 may highlight how changes in composition or moisture may alter measured signals as the product is viewed from multiple angles—depicted here by the X, Y, and Z coordinate axes near the bottom right portion of the figure. The system may measure these axes via a scanning routine, collecting multi-dimensional data along the production path or using a rotational mechanism around the product. In many aspects, the system may incorporate top-down scanning for one dimension, a cross-axial sensor sweep for another dimension, and an optical or near-infrared sensor for a third dimension. The shading legend (e.g., 1, 0.8, 0.6, 0.4, etc.) may illustrate how each subregion's amplitude or reflectance is discretized or partitioned into bins, possibly reflecting thresholds stored in server memory. If the system suspects that a region labeled “0.0” indicates a total loss of signal, for example, it might interpret that region as indicating a foreign object or a severe mismatch in composition.

In several embodiments, the system 1400 may be integrated with a temperature sensor that flags subregions exceeding a certain reading. If the shading of a subregion is coded to reflect not amplitude but temperature differentials, the system may use color or grayscale values to delineate hotspots. For example, an area labeled “1” might correspond to 70° C., while “0.4” might correspond to 40° C. If the system's baseline thresholds define anything above 60° C. as non-compliant, the server's processors may trigger an inline corrective action. That inline corrective action might include adjusting an environmental temperature or time, or removing the product from the production line altogether if the item may no longer be salvaged. This approach provides an inline corrective action in response to sensor readings outside a predefined range.

In some aspects, the shading pattern in the midsection of system 1400 may correlate specifically with near-infrared or Raman absorption peaks. If the product's composition is partially mis-mixed, the system may see a distinct dip or shift in the shading value. By checking that shift against the server's memory-based reference profiles, the system's one or more processors may confirm whether the item aligns with known molecular compositions or if it reveals the presence of contaminants. Suppose the system identifies a pattern that consistently shows up in a certain batch of products. In that case, the system may suspect a supply chain or mixing ratio problem and may transmit an electronic alert to an operator console, providing alert mechanisms for repeated non-compliance.

In numerous aspects, the system 1400 may be employed to detect volume or thickness discrepancies that might appear along cross-sectional planes. For example, the cross-like geometry depicted in the figure might show narrower or broader shading outlines if the product's shape deviates from the standard. The system may detect such divergence by analyzing how the shading intensities shift from the top portion to the bottom portion of the cross. If the amplitude reads as “0.8” for most sections but dips to “0.0” in areas that should be filled, the system may infer that the product is underweight or physically damaged. The same scanning routine might also pick up foreign particles if the region's electromagnetic signature fails to match a typical uniform pattern.

In certain implementations, the system 1400 may run ensemble-based classification logic on these multi-axis measurements, combining outputs from a decision tree classifier that checks moisture levels, a neural network that identifies unusual shapes or cracks, and a support vector machine that detects anomalies in the near-infrared absorption curve. By fusing these results, the system might produce a single label, for instance “compliant” or “non-compliant.” If the system is uncertain, a fallback routine might require additional scans or a handheld extension to gather localized data. That handheld extension, for example, may be used to examine one suspicious subregion from an additional angle or with higher resolution. By merging localized sensor data with the broader volumetric view, the system may confirm a final classification result with increased confidence.

In other aspects, the shading in system 1400 may be dynamically generated in real time. A graphical user interface might present this three-dimensional structure to an operator or quality engineer. If the void or anomaly is small enough to be correctable—such as adding more moisture or adjusting a mixing ratio—the system may order an inline corrective action to fix the subsequent units in the production run. If the anomaly is large or indicative of foreign contamination, the system might automatically issue a rejection signal to a mechanical diverter, removing the item to a separate bin. Alternatively, if the system logs repeated anomalies across multiple items in short succession, it may broadcast a system-wide alert indicating that the production line needs immediate attention or that a sensor is drifting outside its calibration targets.

In many aspects, the system 1400 may maintain data logs or correlation plots that link each shading intensity to a meaningful physical property, for instance 1.0=perfect reflection, 0.8=mild attenuation, 0.4=moderate attenuation, 0.0=zero reflection. Over time, the system may calibrate these values as environmental conditions shift or new product types are introduced, providing dynamic parameter updates for classification. If the environment's temperature or humidity ramp significantly affects the signals recorded by the sensor, the system may revise the boundary values for “0.6” vs. “0.8” to retain consistent classification thresholds. By employing an auto-calibration routine, the sensor might re-check each shading band's meaning, ensuring that small environmental changes do not cause widespread misclassification.

In several aspects, an operator may define new permissible shading ranges in the server's memory if the final product specifications evolve or if the product is intentionally made with a revised composition. The system 1400 might incorporate a training module that retrains an artificial intelligence model using newly labeled datasets which link shading intensities with particular quality attributes. For example, if a pilot batch reveals that a shading reading of “0.4” in a certain subregion still meets the final product's quality parameters, that reading may be labeled as acceptable in future runs. Conversely, if an “0.0” reading correlates to a critical defect, the system will label that scenario as an immediate reject, automatically triggering a corrective action or a mechanical ejection of the product. Over time, these iterative refinements provide dynamic improvement of classification or threshold logic.

In some embodiments, the system 1400 may be deployed as a combination of hardware and software modules that sample each product as it passes along the production path, scanning horizontally or vertically to build the volumetric shading representation. The synergy among radio frequency antennas, near-infrared or Raman sensors, and imaging devices ensures coverage of physical state, volume, uniformity, contaminants, dielectric constants, or moisture content. Each subregion may thus be measured from multiple vantage points, with the aggregated results fed into an ensemble classifier. If the classifier's confidence score remains below a threshold, the system may prompt a second pass or operator intervention. If the confidence score is high but the item is recognized as non-compliant, a rejection signal may be issued in near real time.

In certain aspects, the depiction in system 1400 may represent a typical example where the product is analyzed across planes around an X, Y, or Z axis. In many scenarios, these axes may shift as the product moves, or the sensors may revolve around the stationary product, achieving the same net effect. The numeric shading scale may be extended to more granular levels (e.g., 0.75, 0.65) or to color-coded gradients for user clarity. The server's memory might store these color or grayscale keys so, when an operator references the data in a user interface, they may readily interpret which subregions correspond to higher or lower signals. By referencing cross-sections or orthogonal planes, the system may quickly identify localized pockets of air, lumps, or foreign debris that might compromise product quality.

In other aspects, the system 1400 may be integrated with an optional digital twin model or a simulation environment that replicates these shading intensities for an ideal product. Any deviation from the ideal shading distribution might indicate partial underfill, foreign contamination, or a temperature anomaly. If such a mismatch surpasses a tolerance threshold, the system may notify an operator or automatically adjust a process parameter or production process parameter. If small mismatches are discovered early, for instance at the blending or compounding stage, the system might correct the mix ratio before the final forming step, thereby preventing further out-of-spec items. This loop from detection (shading intensities) to correction (process parameter changes) to final classification aligns with the system's capability to deliver in-process quality control during a production cycle.

In many embodiments, the system 1400 depicted in FIG. 14 may be scaled to different product sizes or shapes, ranging from small tablets and capsules to larger containers or vials. The cross-like shape shown in the figure is merely one representation; the same sensor profiles may be applied to cylindrical or irregularly shaped pharmaceuticals. By capturing shading intensities in multiple planes, the system ensures no hidden region remains unscanned. If a sensor is drifting, the shading patterns might show a sudden shift across all subregions. The system may log that drift, referencing the memory-based calibration routines for the next batch. If the drift is persistent, an automated maintenance request may be triggered, prompting a sensor replacement or deeper calibration cycles, thus guaranteeing alignment with maintenance alerts for drifting sensors.

In several aspects, FIG. 14 also underscores how immediate classification is possible directly on a volumetric or cross-sectional basis. The system receives sensor data from the cross's top, midsection, and bottom, merges them into an aggregate signature, and decides compliance in real time. If non-compliance is detected, the product is removed from the line or a corrective step is invoked. Should new sensor technologies be introduced—such as advanced thermal imaging or updated near-infrared detectors—the foundation remains consistent: gather subregion data, map the results to a shading scale or numeric intensities, unify them into a single classification output, and respond accordingly. This wide adaptability benefits manufacturing lines that must handle frequent product variations or that demand instantaneous feedback loops.

Taken together, the system 1400 reveals an example environment wherein multi-sensor data are converted into a shading or graded scale for identifying local changes in composition, moisture, density, or foreign matter. By cross-referencing a library of acceptable shading patterns or intensity thresholds, the system may finalize a pass/fail verdict, sometimes augmented by manual interventions or secondary checks if the confidence is below a preset threshold. This thorough scanning across multiple planes ensures robust detection of product irregularities and the possibility of real-time corrective actions, consistent with the entire scope of an inline classification approach for pharmaceutical production.

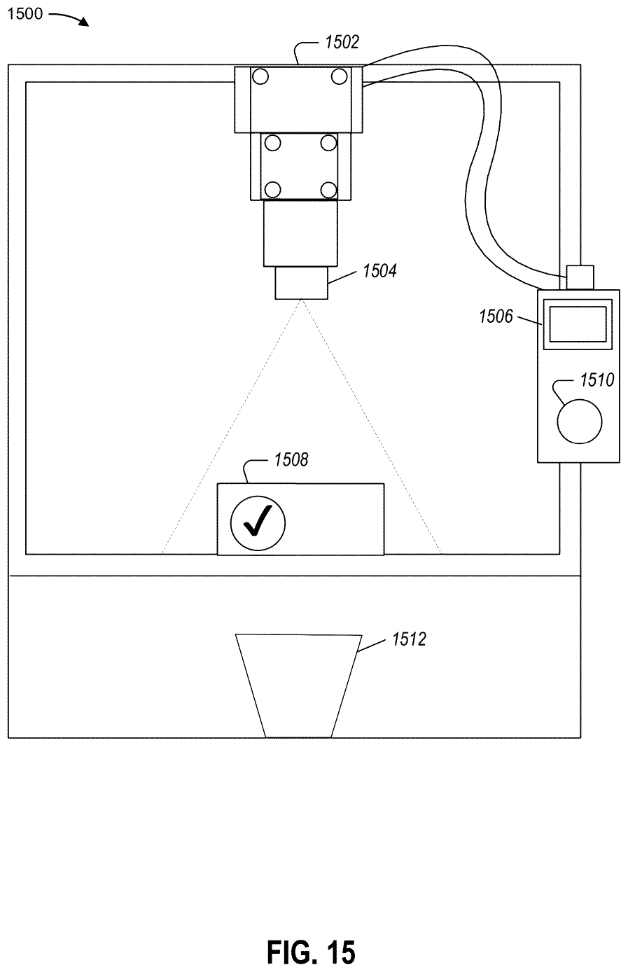

FIG. 15 illustrates a schematic representation of a pharmaceutical classification system detecting variations in pharmaceutical product quality.

In some aspects, FIG. 15 may depict a system 1500 configured to perform inline analysis and classification of pharmaceutical products using at least one radio frequency antenna, one temperature sensor, and one image sensor. The system 1500 may include a mounting assembly 1502, a sensor head 1504, a handheld controller 1506, a dial or selector 1510, and a product 1508 positioned within a scanning or inspection region. In various aspects, system 1500 may also include a bin 1512 arranged below the product 1508 to capture or store items that have been identified as non-compliant. The system 1500 may, in many implementations, be communicatively coupled to a server that has a memory storing computer-executable instructions and one or more processors for executing instructions. In some aspects, the plurality of sensors located within or coupled to the sensor head 1504 may obtain real-time electromagnetic data, temperature data, or image data from the product 1508 in response to the product 1508 traversing along a production path or entering a defined scanning region. The system 1500 may then perform feature extraction by identifying at least one or more of a dielectric property, a temperature deviation, a spectral peak, or a molecular signature for each item being inspected, thereby generating an aggregate signature used to compare data against predefined quality parameters.

In certain aspects, the mounting assembly 1502 may be fastened at the top interior region of an inspection chamber, facilitating stable placement of the sensor head 1504. The sensor head 1504 may include multiple sensor units so that it may capture electromagnetic properties, molecular composition indicators, moisture content measurements, or structural integrity clues of the product 1508. In various aspects, the sensor head 1504 may house a radio frequency antenna that examines dielectric properties, a temperature sensor that reads temperature values of the product 1508, and an image sensor that acquires visual or infrared representations of each pharmaceutical item. In many aspects, the system 1500 may incorporate a near-infrared spectroscopy capability or a Raman effect sensor for enhanced sensitivity if the user chooses to add optional sensors, thus reflecting incorporation of such specialized modules. The system 1500 may send all sensor readings to a server (not expressly shown in FIG. 15, but communicatively interfaced via network or wired connections) so that the one or more processors may perform feature-level fusion on the extracted data. In certain aspects, such fusion may combine the signal amplitude or phase shift from the radio frequency antenna, the real-time temperature data from the temperature sensor, and images or near-infrared data from the image sensor. The server may store computational models in memory and may update classification parameters if historical outcomes suggest changes are beneficial. The system 1500, upon detecting a discrepancy between measured and expected dielectric properties, or discovering a foreign particle in the data, may further initiate an inline corrective action, such as adjusting environmental humidity or process temperature, in substantially real time.

In other aspects, the handheld controller 1506 may function as a handheld extension configured to capture localized sensor data from specific points on the production path. The handheld controller 1506 may house a smaller sensor module or may be directly tethered by a cable to the sensor head 1504. In some aspects, the dial or selector 1510 on the handheld controller 1506 may let an operator modify one or more parameters, such as threshold settings for moisture levels, acceptable foreign particle sizes, or permissible temperature ranges. The operator may physically move the handheld controller 1506 to areas not easily accessed by the overhead-mounted sensor head 1504, thereby obtaining more fine-grained electromagnetic or optical measurements in localized zones of the product 1508. In certain aspects, these localized measurements may be transmitted back to the server, which integrates them with the system's inline data for dynamic classification. If the server's processing, performed by one or more processors, identifies a product that fails to conform to one or more of the predefined quality parameters, the system 1500 may activate a rejection signal routed to a mechanical diverter or pneumatic ejector that may direct the product 1508 into bin 1512. Alternatively, an inline corrective action may be triggered, such as changing conveyor speed or adjusting the ratio of ingredients in a mixing stage, as described in certain embodiments. In many aspects, the memory on the server may also hold a training module that allows the artificial intelligence model to be retrained on newly labeled data from prior production runs.

In several aspects, the product 1508 depicted in FIG. 15 may represent a tablet, capsule, or powder-based formulation that traverses a production path prior to final packaging. Once the product 1508 is placed under the sensor head 1504, the system 1500 may receive and process real-time data to classify the item as compliant or non-compliant. The classification may account for multiple physical attributes, such as external structural integrity (captured by the image sensor), internal dielectric constants (detected by the radio frequency antenna), and temperature readings (obtained by the temperature sensor). In some aspects, if the measured data deviate from the acceptable range stored in a quality parameter repository, the system 1500 may compute a confidence score for whether the product 1508 is truly non-compliant. If this confidence score is below a specified threshold, the one or more processors may initiate a secondary validation process that references the memory for more thorough statistical or AI-based checks, thereby ensuring that borderline measurements have a follow-up verification. Once the classification is finalized, the system 1500 may either present a pass indication on the handheld controller 1506 or automatically transmit an electronic notification to an operator console if repeated non-compliance occurs above a specified frequency.

In some aspects, the mounting assembly 1502 may be configured so that the sensor head 1504 may move along an X or Y axis for scanning multiple items in parallel. The product 1508 may be located on a movable platform or traveling conveyor belt beneath the sensor head 1504, and in certain implementations, the user may rotate or tilt the sensor head 1504 to optimize scanning angles for different shapes or compositions of pharmaceutical items. The inline classification carried out by system 1500 may thus evaluate physical state, volume, mix-ratio, uniformity, contaminants, or moisture content in a continuous flow environment, providing immediate feedback on every product that passes beneath it. In many aspects, the system 1500 may store all sensor readings in memory (hosted on the server) so that historical data may be mined to refine future classification operations. As the server's one or more processors aggregate a large volume of labeled data, an AI model may be updated to detect new anomalies, unusual spectral peaks, or emergent foreign contaminants that were not previously accounted for.

In various aspects, the handheld controller 1506 may be used periodically to perform an auto-calibration routine. Each sensor in the system 1500, including those embedded in the sensor head 1504, may respond to a self-check prompt that measures baseline electromagnetic outputs, ensuring that the measured signals do not drift beyond acceptable operational tolerance. If the system 1500 detects a sensor drift or increased noise levels, the memory storing the calibration values may be updated, or a maintenance alert may be triggered, prompting an operator to inspect the sensor head 1504. In some aspects, the handheld controller 1506 and the selector 1510 may allow the operator to run a local calibration check, capturing reference samples from known control products. The updated calibration data may be pushed back to the server, ensuring the entire set of classification thresholds remains consistent across both inline scanning and the localized handheld checks.

In many aspects, once the user designates the product 1508 as either acceptable or out-of-tolerance, the system 1500 may choose to generate a record of the event in an alert mechanism. If repeated anomalies occur within a constrained time window, the system 1500 may further transmit electronic notifications to an operator console or to a distributed control network that supervises multiple inspection lines. In certain aspects, a parameter such as “dielectric mismatch ratio” or “moisture level exceeding a threshold” may serve as a specific trigger for the inline corrective action. The inline corrective action may include modifying conveyor speed or adjusting an environmental temperature if persistent anomalies indicate that a process temperature is out of range. Alternatively, in some aspects, the system 1500 may cause a mechanical diverter or pneumatic ejector to discard repeated non-compliant items into bin 1512, aligning herein with technical developments for real-time removal of faulty items to maintain productivity.

In other aspects, the sensor head 1504 may incorporate or be retrofitted with a Raman spectroscopy sensor, allowing real-time capture of molecular signatures that indicate, for example, a particular compound's presence or an undesirable impurity. The memory storing the computational model for such a Raman sensor may integrate new data from the handheld controller 1506 if the user chooses to sample localized areas on the product 1508 for verifying suspicious signatures. In many aspects, the system 1500 may dynamically update at least one parameter in the classification model based on prior classification outcomes, refining detection of contaminants or foreign particles across subsequent production cycles. This approach may allow immediate adjustments as soon as certain anomalies become frequent. For example, if the system 1500 repeatedly finds that moisture content is drifting to the upper boundary of acceptability in newly manufactured batches, the one or more processors might instruct a humidity adjustment module to reduce moisture infiltration or warn the operator in real time.

In certain aspects, the dial or selector 1510 on the handheld controller 1506 may be configured to cycle through different scanning profiles, each corresponding to a unique set of product configurations or critical quality attributes. By selecting a new scanning profile, an operator may instruct the sensor head 1504 to activate or deactivate specific sensor elements. In many aspects, the system 1500 may rely on an ensemble of machine learning algorithms, including a decision tree classifier, a support vector machine, or a neural network, to produce classification results based on the aggregated data. The memory may store separate model weights or configurations for each algorithm, and the one or more processors may combine each algorithm's output to form an ensemble-based classification. If the final ensemble confidence is under a defined threshold, the system 1500 may prompt a secondary validation process that references alternate sensor measurements or historical data logs to avoid false positives or negatives.

In some aspects, the bin 1512 visible below the product 1508 may be placed to collect physically rejected or ejected items if a rejection signal is activated by the system 1500. This rejection signal may be triggered by a servo motor or actuator that physically diverts the product 1508 from the production path. In other implementations, the system 1500 may skip physically removing the product and may simply flag the product for operator review. Conditions that cause the system 1500 to initiate such diversion may include measured moisture levels exceeding a threshold, detection of foreign objects within the sensed electromagnetic data, or a mismatch between the actual dielectric signatures and the expected baseline. In certain aspects, shifting the selector 1510 on the handheld controller 1506 may override or refine these thresholds temporarily, enabling a user to test borderline samples during a quality control investigation.

In many aspects, the entire system 1500 may function as one instance of a comprehensive inline classification network, including multiple sensor heads, distributed controllers, and a centralized server or cluster. Each local controller may gather sensor data from the sensor head 1504 for immediate feedback. The handheld controller 1506 may simply add an extra dimension, allowing localized analysis on specific subregions of the production path or product surface. The product 1508 may represent either a single dosage form or multiple items grouped together. The memory storing all classification results may also track which item, at which time, failed to meet certain metrics for uniformity or volume, thus building a historical dataset for refining the next iteration of the machine learning models.

In certain aspects, the system 1500 may reduce production errors by providing real-time insight into essential parameters of the product 1508. The user may apply the handheld controller 1506 to track the temperature of the item or confirm the presence or absence of molecular signatures. If anomalies are repeatedly identified above a specified frequency, the system 1500 may automatically dispatch an electronic alert to relevant operator consoles, supporting current technical developments to provide an alert mechanism that handles repeated non-compliant classifications. Because the sensor head 1504 may scan the product 1508 from multiple angles or vantage points, the classification result may factor in surface analysis, volumetric analysis, and electromagnetic property checks, ensuring robust coverage of possible deviations.

In other aspects, the inline corrective action or the real-time rejection signal may be supplemented by a mechanical dial or knob accessible on the handheld controller 1506, allowing the user to confirm overrides. In many implementations, the system 1500 may incorporate hardware modularity, so an operator may add new sensor attachments (e.g., a second near-infrared sensor or an additional optical camera), each recognized by the server through a plug-and-play interface that updates the memory's calibration references. The system 1500 may also rely on a user interface integrated into the handheld controller 1506, or a separate console, for displaying classification logs and confidence scores. Operators may set multiple injection windows for the server's training module, so that if a certain mix-ratio in the product changes, the system automatically updates relevant classification thresholds.

In some aspects, the system 1500 may also allow a reduced hardware mode if only a subset of sensors is used. For example, the sensor head 1504 may operate only the radio frequency antenna and temperature sensor, disabling the image sensor if an operator is primarily concerned with dielectric properties and thermal profiles. In many aspects, the system 1500 may accept a reconfiguration input from the selector 1510 for that purpose. Because the memory in the server's training module may incorporate newly labeled data from prior production batches, the system 1500 may self-optimize for different forms of pharmaceutical products, including tablets, capsules, or powders with critical quality attributes. If needed, the system 1500 may further incorporate real-time calibration checks and store references of accepted values for each sensor. Maintenance alerts may be triggered if calibration values diverge beyond a permitted margin.

In various aspects, the bin 1512 that appears in FIG. 15 may be an optional module, replaced by another container or a conveyor bypass, depending on the specific implementation. The inline classification described here may rely on real-time sensor data and a set of predefined quality parameters that define permissible ranges for moisture, electromagnetic property, or presence of foreign particles. The user may expand these definitions within the memory to track new critical quality attributes as the system 1500 evolves. By employing a combination of a radio frequency antenna, a temperature sensor, and an optional near-infrared sensor, the server's one or more processors may deliver immediate feedback in the production cycle, meeting needs for providing in-process quality control.

In some aspects, the system 1500 shown in FIG. 15 may be scaled for smaller manufacturing lines or large industrial setups, depending on how the mounting assembly 1502 is positioned and whether the handheld controller 1506 is used frequently. Regardless of the setup, the sensor head 1504 may gather data at high throughput, analyzing properties such as physical state, mix-ratio, or uniformity, then compute a classification result. If that result indicates a severe deviation, the system 1500 may initiate an inline corrective action or, in many aspects, automatically cause the product 1508 to be directed into bin 1512 for removal. Consequently, the system 1500 may facilitate strict compliance with labeled thresholds, fostering accurate classification from the first stage to final packaging.

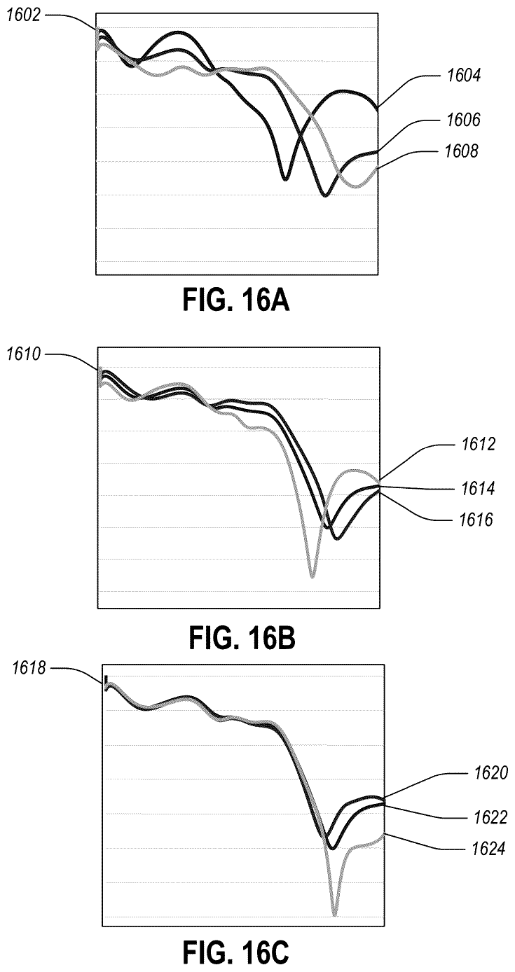

FIGS. 16A-C illustrate examples of electromagnetic signatures shifting from a baseline reference in response to changes in product dimensions, mix ratios, and moisture levels.

In some aspects, FIG. 16A may illustrate a system that measures electromagnetic responses of pharmaceutical products as they vary in dimensions, composition, or moisture content. The system is divided into three sub-figures, labeled 16A, 16B, and 16C. In various aspects, these sub-figures may represent different phases of measurement or different parameters being analyzed, each providing insight into how a system for inline analysis and classification of pharmaceutical products using artificial intelligence and predefined quality parameters may respond to product changes. In many implementations, a plurality of sensors arranged along a production path may be used to capture the electromagnetic signals depicted in FIG. 16A, including a radio frequency antenna that detects subtle shifts in dielectric properties, a temperature sensor that identifies heat signatures or deviations, and an image sensor that captures structural indicators. A server communicatively coupled to these sensors may gather real-time data and store computer-executable instructions in a memory, enabling one or more processors to perform feature extraction and generate an aggregate signature for classification.

In other aspects, FIG. 16A may show a signal measurement 1602 and additional signal measurements 1604, 1606, 1608. The signal measurement 1602 may represent a reference electromagnetic profile collected when a pharmaceutical product is in a nominal condition or when the system is calibrated to a standard sample. The system may store this baseline in the server's memory, thereby giving the one or more processors the necessary reference to compare with subsequent signals. In certain aspects, additional signal measurement 1604, 1606, and 1608 may indicate the effect of dimensional variations of a product's size or shape. For example, the signal measurement 1604 may align with an item that is slightly thicker, the signal measurement 1606 may show a product that is tapered or narrower, and the signal measurement 1608 may indicate a further alternative geometry. In many aspects, the system may detect these geometric differences through changes in the electromagnetic signal amplitude, phase shift, or frequency domain features. If the system detects that a variation, mapped as either signal measurement 1604, 1606, or 1608, exceeds a predefined limit, the one or more processors may initiate a rejection signal or an inline corrective action, such as adjusting a production parameter or removing the non-compliant item from the production path in substantially real time. In some implementations, a confidence score may be computed to indicate whether a particular curve deviates significantly enough to classify that item as non-compliant, or if a secondary validation process is triggered.

In certain aspects, the signal differences between the signal measurement 1602 and each of signal measurements 1604, 1606, 1608 may arise partially from the sensor readings of a radio frequency antenna focusing on dielectric constants, or from an image sensor detecting subtle dimensional changes. The server, housing a memory with computer-executable instructions, may execute code that examines the raw signals, removing drift or noise, and identifies at least two or more features such as a dielectric property, an electromagnetic property, or a molecular signature. The system may employ a near-infrared (NIR) absorption spectrum sensor or optionally integrate a Raman spectroscopy sensor to capture molecular-level data, aligning with certain developments adding advanced spectroscopic modalities to refine classification accuracy. In many aspects, an ensemble of machine learning algorithms may fuse the extracted features into an aggregate signature, thereby allowing the system to classify the item in a matter of milliseconds or seconds.

In some aspects, FIG. 16B may depict a signal measurement 1610 and signal measurements 1604, 1614, 1616. Here, the system may illustrate how changes in chemical composition or mix-ratio alter the electromagnetic response. The signal measurement 1610 may represent the expected signature of a pharmaceutical product containing the correct ratios of active and inactive ingredients. By contrast, the signal measurements 1604, 1614, and 1616 may demonstrate how a mismatch in ratio or a partial contaminant presence modifies the recorded signal. For example, the signal measurement 1612 may indicate that the pharmaceutical item has too high a concentration of a certain compound, while the signal measurement 1614 might reflect partial contamination by a foreign substance. Meanwhile, the signal measurement 1616 may represent a decreased ratio of an active pharmaceutical ingredient, leading to shifts at specific points in the frequency or wavelength domain. In many aspects, these changes may be captured by the same main sensor assembly used in FIG. 16A, but the system's computing modules interpret the signal differently to isolate composition-based anomalies. If a measured signal from a product aligns closer to signal measurement 1612 or 1614 than to signal measurement 1610, the one or more processors may detect a discrepancy between expected and measured dielectric or spectral properties, prompting the system to classify the item as non-compliant. In some aspects, the inline classification evaluates physical state, volume, mix-ratio, uniformity, contaminants, or moisture content, and triggers corrective steps if any variable is out of tolerance.

In various aspects, the server may dynamically update classification parameters or threshold ranges when historical classification outcomes repeatedly flag certain composition anomalies. A training module stored in the memory may receive newly labeled data, such as repeated curves resembling signal measurements 1612 or 1614, and refine the computational model to better handle borderline cases. In some implementations, an alert mechanism may notify an operator if repeated occurrences of a composition mismatch surpass a frequency threshold, for instance if multiple items show a foreign particle presence. The system may also enable a handheld extension that captures localized sensor data from points on the production path where composition irregularities are more prevalent, with that handheld data integrated back into the aggregator for subsequent classification cycles. In other aspects, if the item in question remains borderline, the system may generate a confidence score and compare it to a predefined threshold. If insufficient confidence is achieved, a secondary validation process may be invoked to confirm whether the product is safe to proceed.

In many aspects, FIG. 16C may show a signal measurement 1618 and signal measurements 1620, 1622, 1624 focusing on differing moisture levels in the product. The signal measurement 1618 may represent an acceptable moisture reading, derived from a standard or calibration sample. By contrast, signal measurement 1620 may indicate a product that exhibits increased moisture content, signal measurement 1622 might reflect a moderately higher moisture content, and signal measurement 1624 may reveal a significantly excessive moisture level. In several aspects, increased moisture may shift the dielectric properties enough to alter amplitude, phase, or absorption peaks in the electromagnetic spectrum, which is a crucial parameter for many pharmaceutical compounds that degrade in overly humid conditions. The system may capture these phenomena via the same radio frequency antenna, or via a near-infrared sensor specifically designed to measure water absorption characteristics. In certain embodiments, a temperature sensor may also detect correlated temperature fluctuations if the product retains extra moisture that takes longer to cool or heat.

In some aspects, the server that processes signal measurement 1620, 1622, or 1624 may store an auto-calibration routine in memory to detect sensor drift when high-humidity conditions arise. Each sensor, including the radio frequency antenna and image sensor, may respond to a self-check prompt that ensures measured amplitude or spectral peaks remain within acceptable bounds. If the system detects that repeated items produce signal measurements 1620, 1622, or 1624, the one or more processors may respond by initiating an inline corrective action such as adjusting an environmental humidity level, conveyor speed, or process temperature. In many implementations, when the measured moisture level is found to exceed a certain threshold, the system may trigger a mechanical diverter or pneumatic ejector to remove the non-compliant product from the production path, thus ensuring that improperly hydrated products do not pass further down the line.

In several aspects, the approach to analyzing signals in FIGS. 16A-C may illustrate a broader methodology of feature extraction and classification. The signals shown in sub-figures 16A, 16B, and 16C may feed into a machine learning pipeline running on the one or more processors, which identifies relevant spectral peaks, dielectric transitions, or other critical quality attributes (CQAs). The system may fuse data from multiple sensors to compile an aggregate signature, factoring in dimension changes, composition anomalies, and moisture fluctuations. The combined signature may then be compared to one or more predefined quality parameters, leading to a classification result. In some aspects, these steps may be performed in real time, allowing the system to provide instant feedback to an operator console or to reconfigure a mixing ratio if a mismatch is consistently detected. Certain developments are employing a Raman spectroscopy sensor for detecting molecular vibrations, which may appear as subtle changes in the signals. If included, real-time Raman spectral data may be appended to or integrated within the signal measurements 1604, 1606, 1608, 1612, 1614, 1616, 1620, 1622, and 1624, expanding the system's feature extraction capabilities to incorporate advanced spectroscopic readings.

In other aspects, the system may dynamically update at least one parameter of its computational model in response to real-time classification outcomes. If multiple scans reveal repeated anomalies at a specific frequency, the server may adjust thresholds or weighting values used in the classification ensemble. For example, if signal measurements similar to 1624 begin occurring for a sequence of products, the server might lower the tolerance for moisture content or adjust a monitored dielectric boundary to ensure more sensitive detection. In many implementations, a user interface, either handheld or integrated, may present these signals in a dashboard, possibly labeling each new curve with an overlay that indicates how far it diverges from one or more instances of a signal measurement 1602, 1610, or 1618.

In some aspects, a method for inline analysis consistent with the data in FIGS. 16A-C may involve receiving sensor data from a radio frequency antenna, a temperature sensor, and an image sensor as each pharmaceutical product traverses the production path. The system may identify at least a dielectric property or electromagnetic property from these sensor signals, generating an aggregate signature for classification. If the signature significantly departs from standard shapes associated with lines represented in signal measurements 1602, 1610, or 1618, the system may label the item as non-compliant and initiate a real-time rejection signal. In certain embodiments, if the system is tied to an automated logging mechanism, each classification result is stored, and an alert may be dispatched if non-compliant classifications pass a certain threshold frequency.

In several aspects, each sensor used to generate signals in FIGS. 16A-C may incorporate an auto-calibration feature that checks whether baseline references drift over time or if external environmental conditions fluctuate. For example, if signal measurement 1602 is expected to remain stable but shifts noticeably, the system may issue a maintenance alert requesting an operator to re-calibrate. The memory storing calibration data may also track the time interval since the last self-check prompt, ensuring that the system remains accurate for extended production runs. Subsequent figures or modules may detail how the ensemble of machine learning algorithms references the data from these sub-figures, using decision trees, support vector machines, or neural networks to parse which portion of the signal is relevant for classifying structural or compositional deviations.

In certain aspects, the signal measurements 1604, 1606, 1608 in FIG. 16A might also align with the temperature sensor's readings. If a product is slightly warmer, it may produce a variant signal due to changes in dielectric constants. The signal measurements 1604, 1614, 1616 in FIG. 16B might overlay near-infrared absorption data onto an existing electromagnetic trace, highlighting how mix-ratio changes produce new absorption peaks or valleys. Signal measurements 1620, 1622, 1624 in FIG. 16C might incorporate the output of a real-time Raman spectral reading if the user chooses to enable a Raman spectroscopy sensor, offering improved detection of distinct molecular vibrations. By layering these different sensor outputs, the system may achieve robust classification even if one sensor alone is insufficient to detect anomalies.

In several aspects, an operator console or user interface may display these sets of signals for each product or batch, allowing a human operator to confirm the system's classification decisions. If repeated anomalies or unexpected lines appear, the system may request retraining of the AI model with newly labeled data, consistent with the concept of a training module that incorporates updates on critical quality attributes. If the product being evaluated is powder-based or a semi-finished form, the system may emphasize certain signal segments that correlate strongly with moisture or uniformity. All of these possibilities reflect the broad and flexible nature of the disclosed technology, enabling multiple sensor types and spectral analysis methods to converge on an inline classification decision.

In some aspects, if the signals in FIGS. 16A-C suggest minor deviations from the baseline, the system may compute a confidence score and automatically attempt an inline corrective action, for example adjusting environmental temperature. Should the signals indicate a major discrepancy or a foreign particle presence, an immediate rejection signal may be fired, causing a mechanical diverter to remove the product from the production path. If the user chooses to do so, the system may also log that event and transmit an electronic notification in real time, ensuring an operator or control server is updated about possible production issues. The memory storing the code for these routine tasks may implement a modular approach, for example using a Python-based or C++ environment with libraries that handle real-time data acquisition and machine learning inference.

In many implementations, the difference between signal measurements such as 1602, 1610, 1618 and each group of new lines in FIGS. 16A-C may represent how the system automatically adapts to new forms of anomalies. A smaller mismatch may result in a lower degree of classification confidence required to pass. A larger mismatch, such as that graphed in signal measurements 1608, 1614, or 1624, may cross a threshold that triggers immediate removal from the line. The system may store these thresholds in a memory-based table, referencing them each time new sensor data is captured. If a user toggles a handheld extension to capture localized data, that input may be integrated to refine the lines displayed, effectively merging local high-resolution scans with the general inline sensor data.

In other aspects, the sub-figures 16A, 16B, and 16C may be depicted in an interface that specifically color-codes each curve, highlighting the severity of the deviation from the baseline. The server's one or more processors may either interpret each curve as a dimension-based anomaly, a composition-based anomaly, or a moisture-based anomaly, as the figure suggests. The system may seamlessly shift between analyzing dimension-related signals, composition signals, or moisture signals, or it may combine them if multiple anomalies occur simultaneously in production. That combination might appear as multiple lines overlaying one another, capturing multiple sensor modalities in parallel.

In several aspects, the system may proceed to a next figure or method step that further details how the classification engine decides which portion of the signal is most indicative of a foreign particle or an undesired moisture absorption. The discussion of signal measurements 1604 through 1608, 1612 through 1616, and 1620 through 1624 may continue in an advanced method flow, referencing a placeholder for future figures that specify conditional logic or sub-steps in greater detail. Regardless of how the system is ultimately deployed, FIGS. 16A-C may serve as a visual tool for illustrating how incremental changes in dimension, composition, or moisture produce corresponding shifts in electromagnetic or spectral signals that the system may analyze in real time, ensuring immediate feedback for in-process quality control.

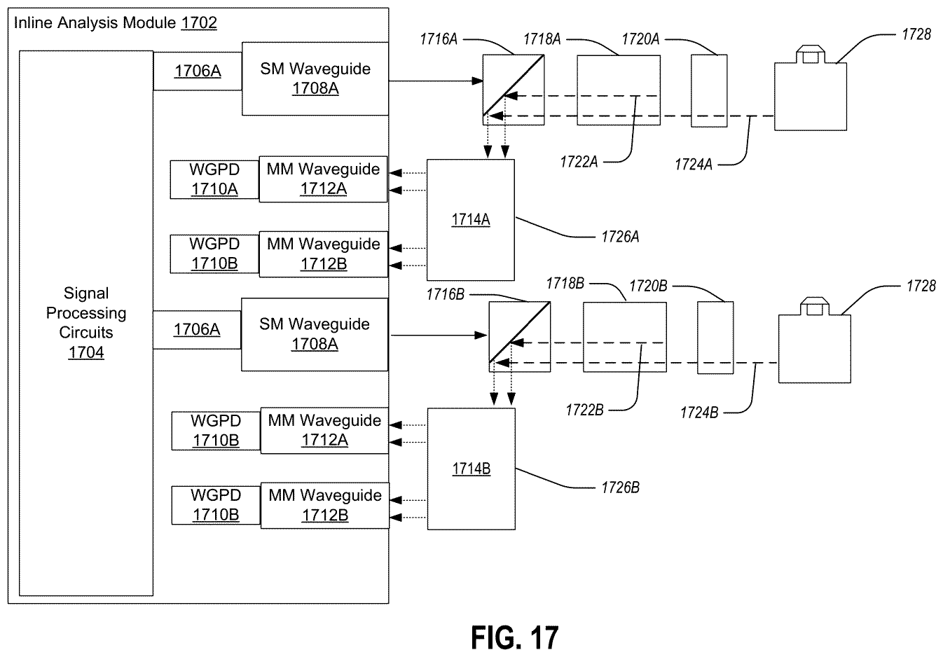

FIG. 17 illustrates an inline analysis module that merges and separates multiple sensor signals for real-time product inspection and classification, according to various examples.

In some aspects, FIG. 17 may depict an inline analysis module 1702 configured to perform real-time inspections on pharmaceutical products, including moisture content evaluation, identification of dielectric properties, or detection of foreign particles. This inline analysis module 1702 may incorporate both hardware and software elements capable of receiving data from a plurality of sensors arranged along a production path. In several aspects, these sensors may include a radio frequency antenna, a temperature sensor, and an image sensor, each of which may obtain real-time data indicative of electromagnetic properties, molecular composition, or structural integrity of the pharmaceutical products. The inline analysis module 1702 may be in communication with a server that stores computer-executable instructions in a memory, enabling one or more processors to process streamed sensor data and classify each product based on predefined quality parameters. The module 1702 may also interface with waveguides and waveguide photodetectors, ensuring that various optical or electromagnetic signals are captured, multiplexed, or demultiplexed for advanced signal analysis and feature extraction.

In certain aspects, the inline analysis module 1702 may include signal processing circuits 1704 that refine or condition sensor data in real time, such that multiple input types are scaled or synchronized for subsequent evaluations. The signal processing circuits 1704 may apply filtering algorithms or time-domain alignment techniques that minimize noise and improve the accuracy of any computed dielectric property, temperature reading, or molecular signature derived from the sensors. The module 1702 may also store calibration data for sensor signals, permitting the system to compare measured waveforms against baseline references. If repeated discrepancies are detected, an alert mechanism may transmit notifications to an operator console or trigger an inline corrective action. In many aspects, these corrections may include adjusting process temperature, speed of a conveyor, or a mixing ratio, thereby aligning with scenarios where the one or more processors detect an anomaly, such as a measured moisture level exceeding a threshold or the presence of a foreign particle.

In many aspects, the sensor combiner 1706A may be implemented as a multiplexer (MUX) supplying data to a single mode waveguide 1708A, which may handle tightly confined optical or electromagnetic signals. A second sensor combiner 1706B may similarly channel signals into a different waveguide path, potentially a multimode waveguide if needed for multiple frequency bands. The inline analysis module 1702 may further incorporate waveguide photodetectors (WGPDs), such as waveguide photodetector 1710A and waveguide photodetector 1710B, each capable of converting optical or radio-frequency signals into electrical data that may be digitized by the signal processing circuits 1704. In several aspects, the waveguide photodetectors 1710A and 1710B may detect subtle changes in amplitude, phase, or absorption profiles, thereby enabling the system to identify spectral peaks, NIR absorption effects, or foreign particle signatures within the measured signals. By capturing these variations in real time, the system may build a feature-rich dataset that the server's one or more processors may fuse into an aggregate signature, consistent with methods for inline classification of pharmaceutical products.

In some aspects, signal separator 1714A may receive multiplexed signals emerging from the single mode waveguide 1708A or the multimode waveguide 1712A, while signal separator 1714B may process additional signals from waveguide 1712B or other channels. The signal separator 1714A or 1714B may split combined signals into distinct channels for specialized feature extraction routines. In various aspects, each channel may carry electromagnetic data correlated with dielectric properties or moisture content of the passing pharmaceutical product. A temperature sensor's output may also be combined into these signals if the system toggles a mode that includes thermal data among the multiplexed channels. The signal separator 1714A or 1714B may also incorporate algorithms that isolate components of a near-infrared absorption spectrum or a Raman effect, which may be relevant if the system includes a Raman spectroscopy sensor. That sensor may be communicatively coupled to the server, allowing the system to detect molecular vibrations indicative of product composition. In many implementations, the server may dynamically update at least one parameter of its computational model when repeated classification outcomes suggest that thresholds for certain waveguide channels should be refined.

In other aspects, aperture 1716A and aperture 1716B may be configured to engage transceiver 1718A or transceiver 1718B, respectively. The transceivers 1718A and 1718B may emit or receive signals across various waveguide paths, which may be physically aligned with the apertures 1716A and 1716B to ensure minimal signal loss. The waveguide paths may include single mode channels, such as the single mode waveguide 1708A, or multimode channels, such as the multimode waveguide 1712A or the multimode waveguide 1712B. By transmitting signals through these paths, the system may detect changes in electromagnetic properties caused by contaminants, composition variations, or moisture differences in each pharmaceutical product. The transceiver 1718A or 1718B may also be tuned to specific frequency bands, depending on whether the system is monitoring dielectric constants or analyzing molecular vibrations. In certain aspects, a dynamic tuning mechanism may be used for real-time switching of waveguide frequencies, allowing the system to adapt to different batch formulations or changes in the production line environment.

In several aspects, each path may contain additional components, such as intermediate nodes 1720A, 1720B, 1722A, 1722B, 1724A, or 1724B, which may measure partial reflections or transmissions that give insight into product uniformity or the presence of foreign matter. For example, if a pharmaceutical product exhibits an unexpected reflection peak at a certain waveguide node, that data may be captured by waveguide photodetector 1710A or 1710B, then passed to the signal processing circuits 1704. The system may interpret these anomalies as triggers for a non-compliant classification, prompting an inline corrective action or a rejection signal. In many implementations, the user may configure how each intermediate node is leveraged: additional nodes may be enabled for high-sensitivity scanning or disabled if the process demands higher throughput with fewer data points. The memory hosting the computational model might store a lookup table describing sensor signal thresholds for various product types, ensuring that the same hardware may be reused for multiple product lines by altering the stored reference parameters.

In some aspects, the suitcase icon component 1728 is a pharmaceutical product that traverses the waveguide paths or scanning region. The system may direct signals through single mode or multimode channels to detect anomalies relating to dielectric constants, chemical composition, or moisture content. If the server's one or more processors identify a relevant deviation from expected properties, an inline corrective action may be initiated in real time. In many implementations, that corrective action may take the form of adjusting conveyor speed, modifying environmental humidity, or conveying a rejection signal that prompts a mechanical diverter or pneumatic ejector to remove the flagged product from further production steps. If repeated anomalies occur beyond a certain frequency, the memory storing the classification routines may trigger an alert mechanism to inform an operator console of potential upstream process issues. Additionally, in some aspects, the system may incorporate a handheld extension, separate from the waveguide-based scanning, to capture localized sensor data in areas that prove challenging for waveguide access.

In various aspects, the inline analysis module 1702 may achieve feature-level fusion by combining data from radio frequency antennas, temperature sensors, and waveguide photodetectors, thereby generating an aggregate signature that accounts for multiple physical or chemical properties. For example, the server software may assign weighting factors to signals related to moisture content, or it may rely more heavily on electromagnetic property data if prior historical classification outcomes indicate repeated anomalies in that domain. The server's one or more processors may use an ensemble of machine learning algorithms that combine the outputs of decision tree classifiers, support vector machines, or neural networks. By analyzing the aggregated data, the system may decide whether the product meets one or more predefined quality parameters. If at any point a measured parameter, such as a spectral peak or a dielectric mismatch, exceeds allowable limits, the system may generate the rejection signal. In other aspects, if a discrepancy is borderline, the system may compute a confidence score and initiate a secondary validation process if that score is below a threshold set by the user or by the training module in the memory.

In some aspects, each sensor in the inline analysis module 1702 may include an auto-calibration routine. The waveguide photodetectors 1710A and 1710B may run self-check prompts that compare signal measurements, for instance from a reference or known standard, against real-time scanning data to detect sensor drift. If the calibration indicates that waveguide photodetector 1710B has shifted in sensitivity or that sensor combiner 1706A is no longer accurately multiplexing signals, the system may store an updated calibration factor in memory and trigger a maintenance alert. This mechanism ensures consistent measurement fidelity, which is crucial when analyzing small changes in foreign particle presence or micro-variations in product composition. The server may also incorporate historical calibration logs to refine future calibration steps or automatically adjust scanning profiles. In other aspects, operator overrides may be applied via a user interface or a handheld device, allowing calibration intervals to be manually extended or advanced if production demands require it.

In many aspects, the waveguide paths described as single mode waveguide 1708A or multimode waveguide 1712A and 1712B may be physically realized using optical fibers, planar lightwave circuits, or even specialized waveguide materials suitable for microwave frequencies. The signal processing circuits 1704 might be implemented in hardware as field-programmable gate arrays (FPGAs) or as specialized system-on-chip components that handle high-throughput digitization. The inline analysis module 1702 might be controlled by software routines in Python, C++, or other languages that facilitate modular expansions. If a user elects to add a Raman spectroscopy sensor, an additional waveguide path may be allocated to capturing Raman scattering signals from the product/component 1728. The memory storing the training module may incorporate newly labeled data reflecting changes in product composition, thereby continuously refining the system's classification performance over multiple production batches.

In certain aspects, once a product reaches the waveguide region, the signals passing through the waveguides may be separated or combined by the sensor combiner 1706B or the signal separator 1714B, creating multiple channels that highlight specific physical or chemical attributes of the product. The presence of a foreign particle might create an unexpected reflection at node 1722B, while a moisture spike may alter absorption at node 1724B. The waveguide photodetector 1710B may record these unusual events, convert them into an electrical signal for the signal processing circuits 1704, and then the system's one or more processors may compare values to stored thresholds in memory. If the item is beyond acceptable tolerances, the module 1702 may generate an inline corrective action or a real-time rejection signal to remove the item. If the deviation is mild but repetitive, an operator may receive an electronic notification via the alert mechanism.

In other aspects, the intermediate nodes 1720A, 1722A, 1724A (and similarly 1720B, 1722B, 1724B) may be configured to measure partial transmissions or reflections at different frequencies, enabling advanced test procedures if the system is scanning complex pharmaceutical products involving layered tablets or capsules. This approach may be vital for verifying uniformity in multi-layer tablets or in verifying that no foreign objects are embedded between layers. The data gleaned from these nodes may also feed into a training module stored in the memory. That module may combine newly labeled data with older sets to refine the ensemble of classification algorithms, improving the system's ability to detect subtle changes over time. If the server is configured to dynamically update parameters, each node's threshold might be tweaked in response to historical classification outcomes, ensuring that real-time scanning remains accurate despite changing product recipes or slight sensor drift.

In many aspects, the waveguide arrangement described in FIG. 17 may be modular, allowing the system to scale from a single waveguide path with minimal nodes to multiple waveguide paths each with numerous nodes for high-resolution scanning. The inline analysis module 1702 may communicate with a remote or on-site server that contains the memory and the one or more processors. The server may store and run the computer-executable instructions for reading sensor data, extracting features (including NIR absorption or Raman effects), generating aggregate signatures, and issuing classification decisions. The server may also output triggers to a mechanical diverter or a pneumatic ejector if a product's measured signals diverge significantly from the baseline references, ensuring that non-compliant items are separated in substantially real time. If repeated non-compliance is registered beyond a certain frequency, the system may auto-generate an operator-facing alert or schedule an immediate maintenance inspection.

In certain aspects, the illustrated suitcase icon component 1728 may represent how a product might move along a conveyor or production path through the waveguide scanning zone. The system may implement multiple scanning angles or waveguide alignments so that the product's entire surface or internal structure is effectively tested for contaminants, moisture, or incomplete mixing ratios. Upon completion of the scanning, the one or more processors may finalize a classification, referencing any training module expansions or updated thresholds to ensure an accurate result. This classification process may incorporate a confidence score, which if below a preset threshold, leads to secondary validation steps involving an operator or an alternate sensor channel. Unlike conventional scanning solutions, this approach may unify signals from the waveguides, the radio frequency antenna, the temperature sensor, or even an optional image sensor to build a comprehensive detection profile.

In various aspects, if some sensors are configured with an auto-calibration routine, they may run self-check prompts at intervals determined by the server or triggered by an operator. If the system detects that the waveguide photodetectors 1710A or 1710B are drifting or that either sensor combiner 1706A or 1706B is not accurately scaling signals, the memory may log an error, generating a maintenance alert. Additionally, if the environment's humidity drifts outside an acceptable range, the server may instruct the production line to activate an inline corrective action, such as adjusting a climate control device or changing the time spent at a drying station. These expansions illustrate how the waveguide-based scanning architecture may integrate with broader system parameters, such as temperature or humidity, thereby providing an interconnected approach to pharmaceutical product classification. Each hardware node, from the waveguide photodetectors 1710A, 1710B to the sensor combiners 1706A, 1706B, contributes data that may reveal unseen anomalies in product composition before final packaging.

In many aspects, the entire arrangement in FIG. 17 may be used in conjunction with other figures that depict complementary aspects of the system, such as a handheld extension or a specialized sensor array for Raman spectroscopy. The waveguide approach may be optional or may integrate seamlessly with standard radio frequency or image-based scanning. The memory in the server may accommodate multiple sensor types, using an ensemble-based machine learning method that fuses data from the waveguides, the radio frequency antenna, and the temperature sensor. If a scanned item is discovered to contain foreign matter or a mismatch in dielectric constants, the system may promptly remove it from circulation, thus meeting the real-time classification objective. By layering waveguide-based scanning with temperature or imaging data, the system may achieve a robust classification framework that addresses a wide range of critical quality attributes.

In certain aspects, if the waveguide ratio of single mode to multimode channels is insufficient for a particular advanced use case, the user may reconfigure sensor combiner 1706A or 1706B to accommodate additional waveguide photodetectors or incorporate alternative frequency ranges. The waveguide approach may be further enhanced by time-division multiplexing or frequency-division multiplexing depending on the system's desired throughput. The memory storing the classification model may hold parallel expansions for each waveguide channel, ensuring that even if a single waveguide path fails or experiences drift, the system may rely on alternate channels for continuous scanning. Ultimately, the arrangement shown in FIG. 17 may represent a flexible platform that includes hardware modules, waveguide photodetectors, and advanced signal processing circuits, all integrated to provide near-instant feedback on product compliance. By applying inline corrective actions or issuing rejection signals in real time, the system may maintain high levels of quality control across diverse pharmaceutical production scenarios.

In several aspects, the disclosed system may include an ultrasonic sensor used alongside the sensors described in the brief figure overviews, thus supporting an inline analysis that may detect density, porosity, or layered structures within each pharmaceutical product. In many embodiments, this ultrasonic sensor may be placed on or near a conveyor path to send and receive acoustic signals, which may then be digitized and forwarded to a data processing module. By merging the resultant ultrasonic data with electromagnetic, temperature, or optical sensor outputs, the system may enhance its aggregate signature generation. For instance, referring to FIG. 3's sense layer (including a radio frequency antenna or a temperature sensor), an ultrasonic emitter-receiver pair may be added as described in some aspects, enabling the system to fuse internal density measurements with near-infrared or dielectric properties. This approach may uncover hidden inconsistencies, such as voids or partial separations within tablets, supporting calls for advanced sensor-fusion beyond just electromagnetic or optical signals.

In several aspects, the system may further include an ultrasonic sensor (not shown) to measure properties such as density, porosity, or layered structure of each tangible product. In some aspects, this ultrasonic sensor may deliver raw waveform data to the same sensor data input/output unit 302, after which the normalization unit 304 may compensate for amplitude differences or material-specific speed-of-sound variations. In other aspects, the ultrasonic sensor may be arranged upstream or downstream of the radio frequency antenna, thereby sampling a different region of the production path. The system may combine ultrasonic measurements with electromagnetic or image-based features in either the feature extraction engine 308 or an equivalent module, ensuring that the fused information feeds into the aggregate signature generation module 310 for classification.

In many aspects, a 3D tomographic module may also be part of the overall sensor arrangement, allowing volumetric scans of each tangible product to detect internal voids or cracks. The 3D tomographic module may be connected to local or remote processors, potentially funneling data into the same feature extraction engine 308. In certain implementations, the tomographic data may be large-scale volumetric images that highlight material defects in three dimensions. Such 3D data may be stored in the data repository 316 or data repository 316 for subsequent correlation against known defect patterns or for training a predictive modeling routine.

In some aspects, an extended digital twin module may be integrated into or placed alongside the digital twin module 314. This extended digital twin may simulate production-line flow, sensor readings, or product states in a more comprehensive virtual environment by referencing real-time sensor data alongside historical classification logs. The extended digital twin may thus forecast potential quality deviations or emergent anomalies; if the forecasted results stray outside normal boundaries, the system may auto-update thresholds or prompt an operator to intervene. Such extended digital twin functionalities may be tied to the existing corrective action module 312, thereby allowing rapid adjustments in mixing ratio, conveyor speed, or environment temperature if repeated deviations appear probable.

In several aspects, a generative AI submodule may be attached to the artificial intelligence routines that produce classification outputs or reconfiguration suggestions. In some embodiments, this generative AI submodule may be a specialized software layer built on top of an ensemble of machine learning algorithms, referencing an existing approach such as the feature-level fusion described earlier. If the system detects repeated non-compliant detections, the generative AI submodule may propose new production parameters—perhaps adjusting drying times or temperature setpoints—and may optionally compute predicted outcomes on subsequent batches. This approach may build upon the data repository 316 to store scenario-based reconfiguration sets, enabling near real-time updates if an operator consents or if the system's threshold logic triggers direct reconfiguration.

In certain aspects, the disclosed technology may also include an automated robotic assembly subsystem to handle tasks such as labeling, packaging, or grouping the tangible products. Such a subsystem may be controlled by or communicate with the one or more processors described in the specification, thereby enabling physical removal or rework of non-compliant products without pausing the entire production run. The robotic assembly may be integrated with the communication interface 306 or with an edge controller to receive classification signals and automatically eject items flagged by the corrective action module 312, aligning with expansions referencing automated removal of out-of-specification units.

In some implementations, methods may include simulating sensor readings within an extended digital twin model. This approach may be integrated with the previously mentioned digital twin module 314 or with an external environment. If these simulated readings indicate process anomalies (for example, moisture spikes or density drops), the real-world production system may adjust at least one parameter—such as conveyor movement intervals or waveguide power settings—to avoid the anticipated defects.

In many aspects, the method architecture may incorporate an ultrasonic sensor as part of the plurality of sensors measuring each product's density or internal structure. The signals from the ultrasonic sensor may be combined with dielectric or spectral data upstream of the aggregate signature generation module 310. This fused signature may reflect both internal and external product characteristics, broadening the classification routine's coverage to detect subtle mechanical flaws. If anomalies are found, the corrective action module 312 may initiate a real-time response.

In some implementations stored in a non-transitory computer-readable medium, instructions may facilitate coordination with a robotic assembly subsystem to tweak packaging or processing logic if a threshold deviation is detected. These instructions may incorporate generative AI that signals repeated moisture-related out-of-bounds measurements, proposing new humidity setpoints or adjusting a dehumidification schedule in near real time. If the system sees repeated non-compliance for the same attribute—such as excessive substrate porosity—the generative AI submodule may auto-suggest different process parameters or pre-blends for the impacted products.

In certain aspects, a predictive analytics routine may also be included to track how many items have been flagged by the classification logic over a specific time window. This routine may identify creeping trends that forecast more widespread issues, such as inadequate dryness or incomplete mixing. In some configurations, the system may store these results in quality logs for further analysis. If a projected curve indicates a high likelihood of near-future mass deviations, the system may prompt a partial line stoppage or a parameter optimization cycle to minimize waste.

In some examples, a 3D tomographic module may combine seamlessly with the extended digital twin to feed multi-dimensional scan data into a virtual environment for rapid detection of likely product failures. As volumetric images are generated, the combined environment may uncover micro-cracks or voids that typically remain invisible to simpler scanning. This synergy may accelerate the classification step, because the simulated environment can evaluate which sub-layers of a product are prone to cracks. In some aspects, if ultrasonic data reveals internal density anomalies while the generative AI submodule sees a downward trend in uniformity, the system may propose a tweak to the mixing ratio or compaction force.

Similarly, if the system includes an ultrasonic sensor that frequently detects low density conditions, a generative AI submodule could further refine time or temperature parameters for curing or drying. The synergy among wave-based scanning (e.g., ultrasonic or electromagnetic) and advanced AI-based reconfiguration suggestions may keep the production line within acceptable quality margins. If handling, labeling, or final packaging is performed by the automated robotic assembly subsystem, data from that subsystem may be streamed back into the extended digital twin. This feedback loop may help the environment learn how newly adjusted packaging steps correlate with real-time quality scores, perhaps ensuring that any shift in packaging tension or speed does not degrade sensitive product layers.

In some aspects, the entire system may also house a parameter-optimization engine that systematically tests small adjustments to temperature, humidity, or mixing ratio, always evaluating the resulting classification outcomes with real-time sensor data. This engine may rely on forecasts from a digital twin or from predictive analytics that draw on historically observed patterns. Each iteration may be validated in real time to confirm that no new issues arise, and if successful, these new parameter sets may be stored for future reference.

In some embodiments, an artificial intelligence model that supports multi-task learning may handle the classification of multiple attributes—such as moisture content, foreign particles, active ingredient composition—within a single pass. This approach may reduce overall scanning or inference time, because the model can weigh each sensor input collectively. If the system sees repeated or correlated anomalies (for instance, foreign particles that also correlate with certain temperature fluctuations), the multi-task model may more effectively pinpoint root causes and prompt timely corrective actions.

In certain aspects, a 3D tomographic module may supplement or replace the standard imaging equipment so that volumetric images of pharmaceutical products are generated. In line with the methodology in FIG. 4 or FIG. 6, signal processing circuits may integrate tomography-based data, splitting or combining it with other sensor outputs. These 3D scans may be captured, for example, via advanced optics or X-ray-based tomography (if permissible) that create volumetric reconstructions of a product's interior. The system may feed those reconstructions to a feature extraction engine, such as the engine described in FIG. 3 or the pattern recognition engine in FIG. 4, to detect cracks, internal voids, or incomplete layering. The volumetric data may fuse with electromagnetic or near-infrared signals already shown in the figures. Incorporating tomography-based findings into the classification pipeline may permit near real-time detection of anomalies while the product remains on a continuous production line.

In many aspects, the digital twin module (introduced in FIG. 3 and elaborated in various figures where simulated environments are used) may be extended to form an even more comprehensive simulation that accounts for real-time production data. This extended digital twin could track every sensor reading, from optical streams to ultrasonic echoes, and feed them into a virtual environment that forecasts potential product failures. For example, as shown in some aspects referencing the digital twin module 314 in FIG. 3, the system may adapt production parameters—like mixing ratio or moisture content—if the simulated environment anticipates an undesired trend. That adaptation may occur before the anomaly physically manifests, allowing for a predictive correction. This extended digital twin scenario may integrate seamlessly with the notion of an inline corrective action or generating confidence scores, thus refining classification accuracy.

In other aspects, a generative AI submodule may operate in tandem with the central classification logic. While the existing overviews (such as FIG. 8 or FIG. 13) demonstrate how advanced AI or machine learning can orchestrate or integrate sensor data, a generative AI component may process repeated deviations and propose reconfiguration suggestions, for instance adjusting process temperature or conveyor speed. In some implementations, the generative AI might run within or alongside the AI/ML processor (like the one in FIG. 7 at AI/ML processor 726), offering operators a series of predicted outcomes. This approach may reduce trial-and-error by calculating how each suggested parameter change is likely to affect final product compliance. The same generative module may rely on historical patterns stored in data repositories (FIG. 3 or FIG. 12 references) and combine them with newly collected sensor streams to produce context-sensitive improvements.

In certain aspects, an automated robotic assembly subsystem may be included downstream of the classification modules referenced in earlier figures. This subsystem might physically move, package, or label the pharmaceutical products once they have been deemed compliant by the classification engine that draws on sensor fusion. If a product is flagged for non-compliance—due to moisture threshold exceedance, foreign particle presence, or incorrect dielectric constant—the robotic subsystem may remove it from the main flow without pausing production. Interfacing with a corrective action module, such as that described in FIG. 3 or FIG. 9, robotic arms can be directed to re-label or rework items if feasible, or diverge them into a “reject” lane. The synergy between robotics and real-time classification may reduce operator workload and sustain throughput.

In many aspects, the methods referencing a digital twin may incorporate placeholders for additional figures that highlight how sensor readings can be simulated. Depending on production needs, the extended digital twin may synchronize local controllers (FIG. 7) with remote analytics layers. If the digital twin detects that future sensor readings could show an anomaly—like internal density changes or a shift in moisture profile—the system may proactively adjust environmental temperature or humidity to avert product failures. Likewise, a method variant referencing ultrasonic measurements may embed the new sensor signals within the existing calibration or normalization sequence described in FIG. 6 or FIG. 10A. Once the aggregated data points reveal potential internal defects, the method may calibrate the digital twin accordingly, ensuring subsequent product runs incorporate these insights into threshold expansions or reconfiguration instructions.

In some implementations, instructions stored on a non-transitory computer-readable medium may enable real-time coordination between a robotic assembly subsystem and the classification logic. Shared data from AI modules akin to those described in FIG. 3 or FIG. 8 may trigger an ejection routine if a product's classification data surpasses certain deviation thresholds. Additionally, these instructions may contain a generative AI submodule specialized in remedying issues like repeated moisture-level discrepancies. By analyzing high-level production constraints—such as maximum conveyor speeds or permissible temperature ranges—the generative AI may propose parameter changes to rectify the root cause of consistent errors, bridging the classification stage with operational reconfigurations. Meanwhile, the system's memory or extended digital twin may record how these changes affect actual results, feeding the data into a predictive analytics engine that refines future suggestions.

In various aspects, the system may store all classification outcomes in a historical database, referencing FIG. 3 or the “accumulated data” concept from FIG. 13. By applying predictive analytics to this cumulative record, the system may identify trends indicating a likely drift in certain parameters—e.g., an upcoming pattern of excessive moisture in a new batch. Since the digital twin or generative AI can simulate alternative interventions, the user interfaces (see e.g. FIG. 8 or FIG. 13 with QC UI 1302, Process UI 1304, or Management UI 1306) may highlight a recommended approach before the actual non-compliance arises en masse. Additionally, a 3D tomographic module integrated with the extended digital twin may accelerate detection of cracks or internal anomalies, while the ultrasonic sensor may help confirm internal density. Once these data streams unify, the classification engine in the “Sense” or “Integrate” layer (FIG. 13 references) may produce a multi-task output labeling moisture content, foreign particle presence, layer thickness, and uniformity in one pass, consistent with multi-task learning. This can speed up throughput by reducing the time each product spends under separate specialized sensors.

Furthermore, the synergy between an ultrasonic sensor and a generative AI submodule may be exemplified if the ultrasonic readings repeatedly show sub-target density. The generative AI might respond by recommending a new kneading time or a shift in mixing ratio to increase overall uniformity. Meanwhile, the extended digital twin can simulate the effect of that shift on predicted product composition, further refining the system's solution. A robotic assembly may concurrently gather data from labeling or packaging steps, feeding that information back into the digital twin so that each cycle of production becomes more optimized. If the robotic assembly experiences frequent rejections, the digital twin can highlight a mismatch between labeling positions and product dimensions, prompting updated alignment or a different gripping technique. In this manner, each technology expansion—ultrasonic scanning, 3D tomography, digital twin expansions, generative AI suggestions, robotic assembly integration, parameter optimization, and multi-task classification—becomes an integral extension of the sensor fusion and classification approaches introduced in the existing figure overviews.

All of these technologies and expansions on the base technologies disclosed herein demonstrate how the system might incorporate new sensor modalities and advanced computational modules while aligning with the fundamental structure shown across FIGS. 3, 4, 6, 7, 8, 9, 10A, 10B, 11, 12, 13, 14, 15, 16A-C, and 17. Consequently, each new prospective, associated element which may be necessary and/or adjacent to the implementation of these expansions finds direct or analogous support in how the original inline classification system processes data, applies machine learning or artificial intelligence, executes real-time correction, and logs outcomes for continued improvement.

In some aspects, a system for inline analysis and classification of pharmaceutical products using artificial intelligence and predefined quality parameters may include hardware and software components configured to operate in real time, processing large amounts of sensor data that could not be practically performed in a human mind. The system may incorporate a production path lined with multiple sensors, such as a radio frequency antenna, a temperature sensor, and an image sensor, each generating unique data streams reflecting electromagnetic properties, molecular composition, moisture levels, foreign particle presence, or structural integrity of pharmaceutical items. In certain implementations, the raw data collected from these sensors may flow into a local or remote server, where computer-executable instructions run on one or more processors to parse and interpret each sensor's output in substantially real time. Because the sensor data arrive at high frequencies and in parallel channels, no human operator could feasibly combine and analyze the incoming signals in sufficient detail or speed to classify each product without specialized hardware and software.

In many aspects, the server may host a database environment that stores and retrieves relevant sensor information, reference thresholds, and historical batch data. This storage may be a distributed environment or rely on a dedicated relational or NoSQL database. In some embodiments, each time a pharmaceutical product traverses the production path, the server receives streams of sensor data and performs feature extraction by isolating at least two or more of a dielectric property, an electromagnetic property, a temperature reading, a near-infrared (NIR) absorption spectrum, a Raman effect, a spectral peak, or a molecular signature. The system may apply software routines for frequency-domain filtering, signal conditioning, and temperature compensation, all executed automatically by the one or more processors. These computational steps address a technical problem of fusing heterogeneous signals—radio frequency waveforms, optical images, thermal readings—into a robust indication of product quality, which would be unmanageable via mental calculations alone.

In several aspects, the server may execute machine-learning or rules-based modules that undertake feature-level fusion, wherein vectors derived from each sensor are combined into an aggregate signature. The process of feature-level fusion may rely on neural networks, decision trees, or other classifiers that factor in the multiple input channels, enabling the system to detect subtle anomalies, such as a slight deviation in dielectric constant correlated with an elevated moisture reading. This synergy solves a technical challenge: conventional single-sensor solutions often miss multi-faceted defects. By contrast, fusing multiple sensor outputs may yield immediate insight into product uniformity, volume, contaminants, or structural deficiencies. The result is a classification decision that the processors may finalize in less than a second, providing instant feedback for in-process quality control.

In certain aspects, upon generating an aggregate signature, the one or more processors may compare it against stored predefined quality parameters. If the system detects a non-compliance, an inline corrective action or a rejection signal may be triggered. For example, a measured moisture level exceeding a threshold, a discrepancy in dielectric properties, or a temperature reading that strays outside a valid range may each serve as triggers. The system may then modify conveyor speed, environment humidity, or mixing ratio, or automatically actuate a mechanical diverter to remove faulty products from the line. This functionality addresses a distinctly technical obstacle: responding quickly to sensor inputs in real time ensures that defective items do not continue through production, reducing waste and improving safety. Because these steps occur automatically and at operational speeds unachievable by human reasoning, the system presents a practical application of hardware-software integration that surpasses traditional human-inspection methods.

In various implementations, the server's computational model may be dynamically updated in response to historical classification outcomes. Such updates may refine cutoff thresholds for sensor-based features, incorporate newly discovered molecular signatures, or adjust machine-learning model hyperparameters. The system thereby mitigates another technical issue: static thresholds might cause excessive false positives when production variations naturally arise. By capturing newly labeled data and revising classification parameters, the system may reduce downtime while improving accuracy. This approach highlights a further advantage over manual classification, where re-tuning decision criteria would be laborious or error-prone.

In some aspects, a Raman spectroscopy sensor may be communicatively coupled to the server, allowing direct feed of real-time Raman spectral data into the aggregate signature. The system's processors may detect specific molecular vibrations, distinguishing among compounds that appear similar in a simple image or radio frequency phase result. The synergy of temperature, radio frequency, and Raman readings may provide deeper visibility into product composition and uniformity, solving a specialized technical problem of identifying subtle changes in chemical bonds that standard optical or electromagnetic sensors may not isolate. The integrated hardware and specialized software routines, configured to handle the required high data throughput and multi-channel synchronization, would exceed the capacity of mental steps, thereby illustrating how the procedure cannot feasibly be carried out by human thought alone.

The following, non-limiting examples, detail certain aspects of the present subject matter to solve the challenges and provide the benefits discussed herein, among others.

Example 1 is a system for inline analysis and classification of pharmaceutical products using artificial intelligence and predefined quality parameters, the system comprising: a plurality of sensors arranged along a production path, each of the plurality of sensors configured to obtain real-time data indicative of at least an electromagnetic property, molecular composition, moisture content, presence of foreign particles, or structural integrity of the pharmaceutical products; a server communicatively coupled to the plurality of sensors, the server having a memory storing computer-executable instructions; and one or more processors configured to execute the computer-executable instructions to cause the system to: receive sensor data from the plurality of sensors in response to a pharmaceutical product traversing the production path; perform feature extraction by identifying at least two or more of: a dielectric property, an electromagnetic property, a temperature, a NIR absorption spectrum or Raman effect, a spectral peak or molecular signature within the sensor data; generate an aggregate signature via feature-level fusion of the extracted features; and initiate, upon detecting a non-compliant product, an inline corrective action or a rejection signal in substantially real time to prevent the non-compliant product from proceeding further in production; wherein the inline classification evaluates at least one or more of physical state, volume, mix-ratio, uniformity, contaminants, dielectric constants, or moisture content, thereby providing instant feedback for in-process quality control during a production cycle.

In Example 2, the subject matter of Example 1 includes, wherein the one or more processors are further configured to initiate the inline corrective action in response to detecting at least one trigger selected from the group consisting of a measured moisture level exceeding a threshold, a detected foreign particle, a discrepancy between expected and measured dielectric properties or NIR absorption spectrum, and a temperature reading outside a predefined range.

In Example 3, the subject matter of Examples 1-2 includes, wherein the server is configured to dynamically update at least one parameter of its computational model in response to historical classification outcomes, thereby refining classification accuracy.

In Example 4, the subject matter of Examples 1-3 includes, a Raman spectroscopy sensor communicatively coupled to the server, wherein the one or more processors are configured to incorporate real-time Raman spectral data into the aggregate signature to detect molecular vibrations indicative of product composition.

In Example 5, the subject matter of Examples 1-4 includes, wherein the feature-level fusion is performed by an ensemble of machine learning algorithms that combine outputs of at least a decision tree classifier, a support vector machine, and a neural network to produce a classification result.

In Example 6, the subject matter of Examples 1-5 includes, a handheld extension configured to capture localized sensor data from specific points on the production path, wherein the server is configured to integrate the handheld data with inline data for enhanced troubleshooting and localized corrective actions.

In Example 7, the subject matter of Examples 1-6 includes, wherein the one or more processors are configured to compute a confidence score for each classification, and if the confidence score is below a predefined threshold, the system triggers a secondary validation process before finalizing the classification.

In Example 8, the subject matter of Examples 1-7 includes, wherein the memory further stores a training module that retrains an artificial intelligence model using newly labeled data from prior production batches, said training module being configured to incorporate updates on critical quality attributes (CQAs) to improve classification, wherein the system is trained using labeled data from pharmaceutical products with critical quality attributes (CQAs), and wherein the critical quality attributes (CQAs) include dielectric properties, moisture content, uniformity, and product composition for powder-based or semi-finished pharmaceutical materials.

In Example 9, the subject matter of Examples 1-8 includes, wherein each sensor in the plurality of sensors is configured with an auto-calibration routine in response to a self-check prompt, and the system triggers a maintenance alert if a sensor drifts beyond an acceptable operational tolerance range.

In Example 10, the subject matter of Examples 1-9 includes, an alert mechanism configured to transmit electronic notifications to an operator console in response to repeated non-compliant classifications above a predetermined frequency.

In Example 11, the subject matter of Examples 1-10 includes, wherein the inline corrective action comprises modifying at least one production parameter selected from the group consisting of a conveyor speed, an environmental temperature or humidity, a process temperature or time, and a mixing ratio, in order to restore compliance within subsequent products.

In Example 12, the subject matter of Examples 1 -11 includes, wherein the rejection signal causes a mechanical diverter or pneumatic ejector to remove non-compliant products from the production path, in response to a classification output indicating deviations from the predefined quality parameters.

Example 13 is a method for inline analysis and classification of pharmaceutical products, the method comprising: receiving, in response to each pharmaceutical product traversing a production path, sensor data from a plurality of sensors; performing feature extraction on the sensor data by identifying at least two or more of: a dielectric property, an electromagnetic property, a near-infrared absorption spectrum, a Raman effect, a spectral peak, a temperature deviation, or a molecular signature; generating an aggregate signature by fusing the extracted features; classifying each pharmaceutical product as compliant or non-compliant by comparing the aggregate signature to one or more predefined quality parameters; and initiating, upon detecting a non-compliant product, an inline corrective action or a rejection signal in real time to prevent the non-compliant product from proceeding further in production; wherein classifying the product includes, analyzing physical state, volume, mix-ratio, uniformity, contaminants, and moisture content for in-process quality control.

In Example 14, the subject matter of Example 13 includes, updating at least one threshold in the one or more predefined quality parameters in response to historical production data, and in response to detecting a measurement outside of the updated threshold, triggering the inline corrective action.

In Example 15, the subject matter of Examples 13-14 includes, wherein performing feature extraction includes incorporating real-time Raman spectral data into the aggregate signature, and wherein classifying each pharmaceutical product further includes computing a confidence score for a classification result, and providing instant feedback for in-process quality control during a production cycle.

In Example 16, the subject matter of Examples 13-15 includes, transmitting an electronic notification to an operator console if a non-compliant classification occurs above a specified frequency within a defined time window, and providing instant feedback for in-process quality control during a production cycle.

Example 17 is a non-transitory computer-readable medium storing instructions that, when executed by at least one processor, cause the processor to: receive, from a plurality of sensors arranged along a production path, sensor data indicative of dielectric properties, molecular composition, moisture content, presence of foreign particles, or structural integrity of pharmaceutical products; perform feature extraction by identifying at least one dielectric property, spectral peak, temperature deviation, or molecular signature; generate an aggregate signature by fusing the extracted features; classify each pharmaceutical product as compliant or non-compliant based on comparison of the aggregate signature to one or more predefined quality parameters; and initiate a rejection signal in response to detecting a non-compliant product, thereby removing the non-compliant product from the production path in real time, wherein a classification accounts for physical state, volume, mix-ratio, uniformity, contaminants, and moisture content.

In Example 18, the subject matter of Example 17 includes, storing instructions that cause the processor to update the one or more predefined quality parameters in response to repeated deviations in the sensor data beyond a threshold frequency.

In Example 19, the subject matter of Examples 17-18 includes, wherein the instructions further cause the processor to incorporate real-time Raman spectroscopy data into the aggregate signature, and to compute a confidence score for classifying the pharmaceutical product.

In Example 20, the subject matter of Examples 17-19 includes, wherein the instructions further cause the processor to transmit an electronic alert to a control interface in response to detecting the non-compliant classification, the electronic alert identifying at least one measured parameter exceeding a permissible limit, thereby facilitating in-process quality control during a production cycle.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A system for analysis and classification of tangible products along a production path, the system comprising:
a plurality of sensors arranged along the production path, wherein the plurality of sensors further comprises at least a radio-frequency (RF) sensing module having at least one RF antenna;
a server communicatively coupled to the plurality of sensors, the server having a memory storing computer-executable instructions; and
one or more processors configured to execute the computer-executable instructions to cause the system to:
receive dielectric property data from the RF sensing module for each tangible product in real time;
perform feature extraction by identifying at least one dielectric constant, electromagnetic property, or temperature deviation, within the sensor data;
generate an aggregate quality signature via data-level or feature-level fusion of the extracted features;
classify each tangible product as compliant or non-compliant based on comparison of the aggregate signature against one or more predefined quality parameters; and
automatically initiate, when a non-compliant classification is produced, at least one real-time corrective action further comprising logging and wirelessly transmitting an operator alert;
wherein the classification evaluates at least one or more of physical state, volume, mix-ratio, uniformity, contaminants, dielectric constants, or moisture content, thereby providing instant feedback for in-process quality control during a production cycle.

2. The system of claim 1, wherein the plurality of sensors further comprises a temperature sensing module and the one or more processors are further configured to initiate the inline corrective action in response to detecting at least one trigger selected from the group consisting of:
(a) a measured moisture level exceeding a threshold;
(b) a detected foreign particle in RF-derived data;
(c) a discrepancy between expected and measured dielectric; and
(d) a temperature reading outside a predefined range.

3. The system of claim 1, wherein the server is configured to dynamically update at least one parameter of its computational model in response to historical classification outcomes, thereby refining classification accuracy.

4. The system of claim 1, further comprising a Raman spectroscopy sensor communicatively coupled to the server, wherein the one or more processors are configured to incorporate real-time Raman spectral data into the aggregate signature to detect molecular vibrations indicative of product composition.

5. The system of claim 1, wherein the feature-level fusion is performed by an ensemble of machine learning algorithms that combine outputs of at least a decision tree classifier, a support vector machine, and a neural network to produce a classification result.

6. The system of claim 1, further comprising a handheld RF-and-temperature probe configured to capture localized sensor data from specific points on the production path, wherein the server is configured to integrate the handheld data with inline data for enhanced troubleshooting and localized corrective actions.

7. The system of claim 1, wherein the one or more processors are configured to compute a confidence score for each classification, and if the confidence score is below a predefined threshold, the system triggers a secondary validation process before finalizing the classification.

8. The system of claim 1, wherein the memory further stores a training module that retrains an artificial intelligence model using newly labeled data from prior production batches, said training module being configured to incorporate updates on critical quality attributes (CQAs) to improve classification, wherein the system is trained using labeled data from tangible products with critical quality attributes (CQAs), and wherein the critical quality attributes (CQAs) comprise dielectric properties, moisture content, uniformity, and product composition for powder-based or semi-finished tangible materials.

9. The system of claim 1, wherein each sensor in the plurality of sensors is configured with an auto-calibration routine in response to a self-check prompt, and the system triggers a maintenance alert if a sensor drifts beyond an acceptable operational tolerance range.

10. The system of claim 1, further comprising an alert mechanism configured to transmit electronic notifications to an operator console in response to repeated non-compliant classifications above a predetermined frequency.

11. The system of claim 1, wherein the inline corrective action of element (v) (B) comprises modifying at least one production parameter selected from the group consisting of:
(a) conveyor speed;
(b) environmental temperature;
(c) drying or curing time; and
(d) mixing ratio.

12. The system of claim 1, wherein the at least one real-time corrective action of element also causes:
a mechanical diverter or pneumatic ejector to remove non-compliant products from the production path; or
adjusting at least one production process parameter.

13. The system of claim 1, wherein the tangible products are selected from the group consisting of food portions, pharmaceutical dosage forms, chemical pellets, and mineral ore fragments.

14. The system of claim 1, wherein the RF sensing module is configured to sequentially emit a plurality of frequencies and the aggregate quality signature comprises frequency-dependent dielectric responses across at least two discrete RF bands.

15. A method for analysis and classification of tangible products, the method comprising:
receiving, for each tangible product traversing a production path, dielectric property data from an RF antenna and temperature data from a temperature sensor;
fusing the dielectric property data and the temperature data to generate a combined quality signature;
classifying the tangible product as compliant or non-compliant by comparing the combined quality signature with at least one predefined quality parameter; and
executing, in response to the non-compliant classification, at least logging and transmitting an operator alert, thereby preventing the non-compliant tangible product from advancing in the production cycle.

16. The method of claim 15, further comprising updating at least one threshold of the predefined quality parameters in response to historical production data and, when a future combined quality signature deviates beyond the updated threshold, repeating step (d).

17. The method of claim 15, further comprising capturing supplemental dielectric property data and temperature data using a handheld probe and combining the supplemental data with the inline data to localize a source of non-compliance.

18. The method of claim 15, further comprising retraining an artificial intelligence model with labelled data obtained from tangible products classified by the method, the retrained model being deployed to improve subsequent classifications.

19. A non-transitory computer-readable medium storing instructions that, when executed by at least one processor, cause the processor to perform the steps of the method of claim 15.

20. The method of claim 15, wherein adjusting the manufacturing process parameter comprises automatically modifying at least one control signal to upstream processing equipment to compensate for a detected production drift.
